(19) United States
(12) Patent Application Publication
(10) Pub. No.: US 2007/0104896 A1
(43) Pub. Date: May 10, 2007

(54) Optical film, polarizing plate and image display device

(75) Inventors: Naohiro Matsunaga, Minami-Ashigara-shi (JP); Tadashi Ito, Minami-Ashigara-shi (JP); Rikio Inoue, Minami-Ashigara-shi (JP); Yuuichi Fukushige, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/586,715

(22) Filed: Oct. 26, 2006

(30) Foreign Application Priority Data
Nov. 4, 2005 (JP) 2005-320992
Jan. 20, 2006 (JP) 2006-012979

(51) Int. Cl. C09K 19/00

(52) U.S. Cl. 428/1.3; 428/143

(57) ABSTRACT

An optical film comprising: a transparent support; and at least one hard coat layer containing a translucent resin and a coagulating metal oxide particle, and having a surface haze value of from 0 to 12%, an internal haze value of from 0 to 35% and an Sm value of from 50 to 200 μm.

### FIELD OF THE INVENTION

In general, an optical film of the invention is disposed in an outermost surface of a display device for the purpose of improving display performance of a display device (for example, CRT, PDP, ELD, SED, and LCD) and improving protective performance.

### BACKGROUND OF THE INVENTION

In a display device such as a liquid crystal display device (LCD), an optical film having a function for improving display performance or a function for improving protective performance is disposed. For example, an optical film having a surface scattering layer (antiglare layer) or a light interference layer (antireflection layer) is disposed.

In recent years, in a liquid crystal television set and the like, an enlargement in the screen size and an enhancement in the performance (for example, high contrast and high definition) are making remarkable progress. Following this, requirements for an optical film (surface film) have abruptly been raised.

Concretely, examples of the requirements for the surface film include [1] realization of high contrast in a bright room or dark room; [2] compatibility of both reduction of a whitish feeling and antiglare properties due to surface scattering of external light with each other; [3] realization of scar resistance against loose handling, in particular, realization of high scar resistance of an optical film having a low refractive index layer; [4] realization of antifouling properties and dustproof properties; and [5] uniformity of surface properties of appearance.

An optical film which meets these high requirements has not been realized yet. In conventionally known technologies as in, for example, JP-A-11-326608, an optical film which is optimum to the foregoing problems was not obtained.

In order to realize this stably and cheaply, the present inventors made extensive and intensive investigations.

### SUMMARY OF THE INVENTION

An object of the invention is to provide an optical film which is able to aim at [1] realization of high contrast in a bright room due to high grade of black display in the bright room and [2] reduction of a rough feeling (roughness and fineness feeling of projections) on the film surface and to realize [3] scar resistance against loose handling, in particular, high scar resistance of an optical film having a low refractive index layer, [4] antifouling properties and dustproof properties and [5] uniformity of surface properties of appearance. Also, another object of the invention is to provide a polarizing plate and a display device provided with the foregoing optical film.

The present inventors made extensive and intensive investigations. As a result, it has been found that the foregoing objects of the invention can be achieved by optical films having the following configurations.

(1) An optical film comprising a transparent support and at least one hard coat layer containing a translucent resin and a coagulating metal oxide particle, and having a surface haze value of from 0 to 12%, an internal haze value of from 0 to 35% and an Sm value of from 50 to 200 μm.

(2) The optical film as set forth above in (1), wherein the coagulating metal oxide particle is a coagulating silica particle.

(3) The optical film as set forth above in (1) or (2), wherein the at least one hard coat layer contains at least one resin particle having a compression strength of from 2.0 to 10.0 kgf/mm² and an average size of from 0.5 to 10 μm.

(4) The optical film as set forth above in any one of (1) to (3), wherein the at least one hard coat layer contains at least one fluorine based leveling agent and/or at least one silicone based leveling agent.

(5) The optical film as set forth above in any one of (1) to (4), wherein an outermost layer thereof in a side at which the hard coat layer is provided is a low refractive index layer having a refractive index lower than that of an adjacent layer thereto.

(6) The optical film as set forth above in (5), wherein when an average value of a 5° regular reflectance and an average value of an integrated reflectance in a wavelength region of from 450 nm and 650 nm are defined as A and B, respectively, B is not more than 3%, and (B−A) is not more than 1.5%.

(7) The optical film as set forth above in any one of (5) to (6), wherein the low refractive index layer contains at least one fine particle having an average particle size of 15% or more and not more than 150% of a thickness of the low refractive index layer.

(8) The optical film as set forth above in (7), wherein the at least fine particle contained in the low refractive index layer is a hollow fine particle.

(9) The optical film as set forth above in any one of (5) to (8), wherein the low refractive index layer is formed by coating, and a coating solution for forming the low refractive index layer contains at least one translucent resin containing a functional group capable of undergoing hardening by ultraviolet rays (UV) and/or thermal hardening.

(10) The optical film as set forth above in any one of (5) to (9), wherein the low refractive index layer is formed by coating; a coating solution for forming the low refractive index layer contains at least two translucent resins; at least one translucent resin thereof contains a functional group capable of undergoing hardening by ultraviolet rays (UV); and at least one translucent resin which is different from the former contains a functional group capable of undergoing thermal hardening.

(11) The optical film as set forth above in (10), wherein the coating solution for forming the low refractive index layer further contains at least one polymerization initiator and at least one crosslinking agent capable of undergoing thermal hardening.

(12) The optical film as set forth above in (11), wherein the coating solution for forming the low refractive index layer further contains at least one hardening catalyst capable of promoting thermal hardening.

(13) The optical film as set forth above in any one of (11) to (12), wherein in the coating solution for forming the low refractive index layer, a value obtained by dividing a total sum of a weight of the at least one translucent resin containing a functional capable of undergoing hardening by ultraviolet rays (UV) and a weight of the at least one polymerization initiator by a total sum of a weight of the at least one translucent resin capable of undergoing thermal hardening and a weight of the at least one crosslinking agent capable of undergoing thermal hardening is from 0.05 to 0.19.

(14) The optical film as set forth above in any one of (5) to (13), wherein the low refractive index layer contains at least one fluorine based leveling agent and/or at least one silicone based leveling agent.

(15) The optical film as set forth above in any one of (5) to (14), wherein among solvents to be contained in the coating solution for forming the low refractive index layer, a solvent having a boiling point of not higher than 120° C. accounts for from 50% by weight to 100% by weight of the total weight of the solvents in the coating solution.

(16) The optical film as set forth above in any one of (1) to (15), wherein all of the layers contain a metal oxide particle.

(17) The optical film as set forth above in any one of (1) to (16), wherein a contact angle of a surface of the optical film against pure water as measured under an environment at 25° C. and 60% RH is 90° or more.

(18) The optical film as set forth above in any one of (1) to (17), wherein a dynamic friction coefficient of the surface of the optical film as measured under an environment at 25° C. and 60% RH is not more than 0.3.

(19) The optical film as set forth above in any one of (1) to (18), wherein the quantity of electric charges due to vertical detachment against polyethylene terephthalate as measured under an environment at 25° C. and 60% RH is from −500 pc (picocoulomb)/cm² to +500 pc (picocoulomb)/cm².

(20) The optical film as set forth above in any one of (1) to (19), wherein a surface resistivity value as measured under an environment at 25° C. and 60% RH is less than 1×10¹¹ Ω/□).

(21) A polarizing plate comprising a polarizer interposed between two protective films, wherein one of the protective films of the polarizing plate is the optical film as set forth above in any one of (1) to (20).

(22) An image display device comprising the optical film as set forth above in any one of (1) to (20) or the polarizing plate as set forth above in (21).

(23) The image display device as set forth above in (22), wherein the image display device is a TFT liquid crystal display device of an in-plane-switching system.

The optical film of the invention has made it possible [1] to design to realize high contrast in a bright room or dark room; [2] to make both reduction of a whitish feeling and antiglare properties due to surface scattering of external light compatible with each other; [3] to realize scar resistance against loose handling, in particular, to realize high scar resistance of an optical film having a low refractive index layer; [4] to impart antifouling properties and dustproof properties; and [5] to realize uniformity of surface properties of appearance in an image display device. An image display device provided with the optical film of the invention is less in reflection of external light or reflection of the background and extremely high in visibility.

### BRIEF DESCRIPTION OF THE DRAWINGS

FIGS. 1A and 1B are each an outline sectional view to schematically show a preferred embodiment of the film of the invention.

FIG. 2 is a cross-sectional view of a coater 10 using a slot die 13 for carrying out the invention.

FIG. 3A shows a cross-sectional shape of a slot die 13 of the invention; and FIG. 3B is a cross-sectional shape of a conventional slot die 30.

FIG. 4 is an oblique view to show a slot die 13 in a coating step for carrying out the invention and its surroundings.

FIG. 5 is a cross-sectional view to show a vacuum chamber 40 and a web W adjacent to each other (a back plate 40a is integrated with a main body of the vacuum chamber 40).

### DESCRIPTION OF REFERENCE NUMERALS AND SIGNS

1: Support

2: Hard coat layer

3: Particle

4: Low refractive index layer

5: Second layer of hard coat layer

6: First layer of hard coat layer

10: Coater

11: Backup roll

W: Web

13: Slot die

14: Coating solution

14a: Bead

14b: Coating film

15: Pocket

16: Slot

16a: Slot opening

17: Tip lip

18: Land

18a: Upstream side lip land

18b: Downstream side lip land

I_{UP}: Land length of upstream side lip land 18a

I_{LO}: Land length of downstream side lip land 18b

LO: Overbite length (difference in distance between downstream side lip land

18b and upstream side lip land 18b from web W)

G_{L}: Gap between tip lip 17 and web W (gap between downstream side lip land 18b and web W)

30: Conventional slot die

31a: Upstream side lip land

31b: Downstream side lip land

32: Pocket

33: Slot

40: Vacuum chamber

40a: Back plate

40b: Side plate

40c: Screw

G_{B}: Gap between back plate 40a and web W

G_{S}: Gap between side plate 40b and web W

### DETAILED DESCRIPTION OF THE INVENTION

The invention will be hereunder described in more detail. Incidentally, in this specification, in the case where a numerical value exhibits a physical property value, a characteristic value or the like, the terms “from (numerical value 1) to (numerical value 2)” means “(numerical value 1) or more and not more than (numerical value 2)”. Also, in this specification, the term “(meth)acrylate” means “at least one of acrylate and methacrylate”. The same is also applicable to “(meth)acrylic acid” and so on.

[Configuration of Optical Film]

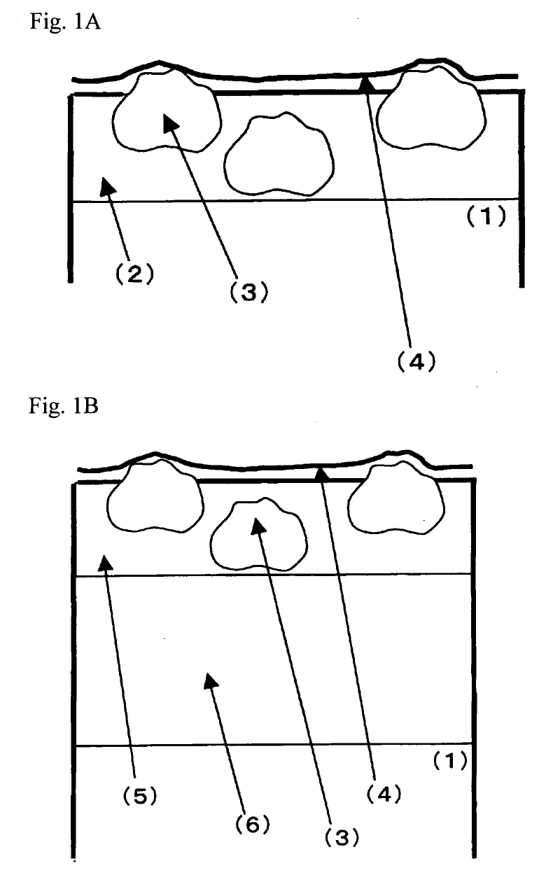

The optical film of the invention includes at least one hard coat layer containing a translucent resin and a transparent support. The optical film of the invention will be hereunder described with reference to FIGS. 1A and 1B.

FIGS. 1A and 1B are each an outline sectional view to schematically show a preferred embodiment of the optical film of the invention.

An optical film of FIG. 1A has one hard coat layer (2) on a transparent support (1) and a low refractive index layer (4) having a refractive index lower than that of the adjacent hard coat layer (2) in an outermost layer. The hard coat layer (2) contains a metal oxide particle (3).

The hard coat layer may be formed of plural layers; and an optical film of FIG. 1B has two hard coat layers on the transparent support (1) (a hard coat layer (6) and a hard coat layer (5) from the side of the transparent support) and has the low refractive index layer (4) stacked in the outermost layer. It is preferable that the metal oxide particle is contained in the hard coat layer (5) in the side of the low refractive index layer which is the outermost layer.

(Haze)

First of all, the surface haze and the internal haze of the invention will be hereunder described in detail.

[1] A total haze (H) of the obtained optical film is measured according to JIS-K7136. [2] A few drops of silicone oil were added on a front surface and a back surface of the optical film; the optical film was sandwiched from the both sides thereof by using two glass plates having a thickness of 1 mm (micro slide glass Product No. S9111, manufactured by Matsunami Glass Ind., Ltd.); the two glass plates and the resulting optical film were brought into completely intimate contact with each other; a haze was measured in a state that the surface haze was eliminated; and a value obtained by subtracting a haze as separately measured by putting only silicone oil between two glass plates was calculated as an internal haze (Hi). [3] A value obtained by subtracting the internal haze (Hi) as calculated in the foregoing [2] from the total haze [H] as measured in the foregoing [1] is calculated as a surface haze (Hs) of the film.

A haze caused due to the surface scattering of the optical film of the invention (hereinafter referred to as “surface haze”) is preferably from 0% to 12%, more preferably from 0% to 8%, and most preferably from 0% to 5%. When the surface haze exceeds 12%, lowering in contrast in a bright room and deterioration in firmness of black color at the time of black display are remarkable, and therefore, such is not suitable for an image display device.

Furthermore, a haze caused due to the internal scattering of the optical film of the invention (hereinafter referred to as “internal haze”) is suitably from 0% to 35%, preferably from 0% to 25%, more preferably from 0% to 12%, and most preferably from 0% to 5%.

The presence of the internal haze is effective such that a viewing angle characteristic of an image display device can be improved (equalized) to some extent. On the other hand, in an image display device attaching importance to firmness of black color or contrast in a dark room, it is preferable that this internal haze is low. When the internal haze exceeds 35%, lowering in contrast in a dark room is not tolerable.

As described previously, the surface haze and the internal haze of the optical film may be independently selected adaptive with the design concept of quality of the image display device. As the ranges of the surface haze and the internal haze, the ranges of the invention are suitable.

(Surface Roughness)

In the optical film of the invention, in order to make both reduction of a whitish feeling and antiglare properties (prevention of image reflection) compatible with each other, with respect to the shape of surface irregularities of the optical film, its center line average roughness Ra is preferably in the range of from 0.03 to 0.30 μm, and more preferably 0.05 to 0.25 μm. Furthermore, in view of the firmness of black color in a bright room, an average value Sm of a gap of the mountain and valley cycle as determined from a point of intersection at which a roughness curve and a center line intersect each other is preferably in the range of from 50 to 200 μm, more preferably from 70 to 160 μm, and further preferably from 90 to 130 μm. When the average value Sm is less than 50 μm, the frequency of projections which cause surface scattering is high so that the whitish feelings tends to increase. On the other hand, when it exceeds 200 μm, a roughness and fineness feeling becomes conspicuous (visual impression is poor) and therefore, such is not preferable.

[Hard Coat Layer]

The hard coat layer is formed for the purpose of imparting hard coat properties for improving the scar resistance (especially indentation hardness) of the optical film and is formed of an ionizing radiation hardenable translucent resin, and preferably an ultraviolet ray (UV) hardenable resin. At least one hard coat layer and optionally two or more hard coat layers are applied onto a transparent support. A total sum of thickness of the hard coat layers is preferably in the range of from 1.5 to 40 μm. When the total sum of thickness of the hard coat layers is less than 1 μm, the required scar resistance is liable to become insufficient, and therefore, such is not preferable. On the other hand, the total sum of thickness of the hard coat layers exceeds 40 μm, problems in brittleness and film curl start to appear, and therefore, such is not preferable.

(Binder)

The hard coat layer according to the invention is formed by a crosslinking reaction or polymerization reaction of an ionizing radiation hardenable compound. That is, the hard coat layer is formed by coating a coating composition containing an ionizing radiation hardenable polyfunctional monomer or polyfunctional oligomer on a transparent support and subjecting the polyfunctional monomer or polyfunctional oligomer to a crosslinking reaction or a polymerization reaction. As a functional group of the ionizing radiation hardenable polyfunctional monomer or polyfunctional oligomer, photopolymerizable (ultraviolet polymerizable) functional groups, electron beam polymerizable functional groups, and radiation polymerizable functional groups are preferable, with the photopolymerizable functional being especially preferable. Examples of the photopolymerizable functional group include unsaturated polymerizable functional groups such as a (meth)acryloyl group, a vinyl group, a styryl group, and an allyl group, with the (meth)acryloyl group being preferable.

Specific examples of the photopolymerizable polyfunctional monomer containing a photopolymerizable functional group which can be used include (meth)acrylic diesters of an alkylene glycol such as neopentyl glycol acrylate, 1,6-hexanediol (meth)acrylate, and propylene glycol di(meth)acrylate; (meth)acrylic diesters of a polyoxyalkylene glycol such as triethylene glycol di(meth)acrylate, dipropylene glycol di(meth)arylate, polyethylene glycol di(meth)acrylate, and polypropylene glycol di(meth)acrylate; (meth)acrylic diesters of a polyhydric alcohol such as pentaerythritol di(meth)acrylate; and (meth)acrylic diesters of an ethylene oxide or propylene oxide adduct such as 2,2-bis{4-(acryloxy-diethoxy)phenyl}propane and 2,2-bis{4-(acryloxy-polypropoxy)phenyl}propane.

In addition, epoxy (meth)acrylates, urethane (meth)acrylates, and polyester (meth)acrylates are also preferably used as the photopolymerizable polyfunctional monomer. Above all, esters of a polyhydric alcohol and (meth)acrylic acid are preferable; and polyfunctional monomers containing three or more (meth)acryloyl groups in one molecule thereof are more preferable. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaertythritol triacrylate, (di)pentaerythritol pentaacrylate, (di)pentaerythritol tera(meth)acrylate, (di)pentaerythritol hexa(meth)acrylate, tripentaerythritol triacrylate, and tripentaerythritol hexatriacrylate. In this specification, the terms “(meth)acrylate”, “(meth)acrylic acid” and “(meth)acryloyl” mean “acrylate or methacrylate”, “acrylic acid or methacrylic acid” and “acryloyl or methacryloyl”, respectively.

For the purpose of controlling the refractive index of each of the layers, monomers having a different refractive index can be used as the polyfunctional monomer binder. In particular, examples of a high refractive index monomer include bis(4-methacryloylthiophenyl)sulfide, vinylnaphthalene, vinylphenyl sulfide, and 4-methacryloxyphenyl-4′-methoxyphenyl thioether. Furthermore, dendrimers as described in, for example, JP-A-2005-76005 and JP-A-2005-36105 and norbornene ring-containing monomers as described in, for example, JP-2005-60425 can also be used.

The polyfunctional monomer or polyfunctional oligomer binder may be used in combination of two or more kinds thereof. The polymerization of such an ethylenically unsaturated group-containing monomer can be carried out upon irradiation with ionizing radiations or heating in the presence of a photo radical initiator or a heat radical initiator.

For the polymerization reaction of the photopolymerizable polyfunctional monomer or polyfunctional oligomer, it is preferred to use a photopolymerization initiator. As the photopolymerization initiator, photo radical polymerization initiators and photo cationic polymerization initiators are preferable, with the photo radical polymerization initiators being especially preferable.

In the invention, a polymer or a crosslinked polymer can be used jointly as the binder. It is preferable that the crosslinked polymer contains an anionic group. The crosslinked anionic group-containing polymer has a structure in which the principal chain of an anionic group-containing polymer is crosslinked.

Examples of the principal chain of the polymer include polyolefins (saturated hydrocarbons), polyethers, polyureas, polyurethanes, polyesters, polyamines, polyamides, and melamine resins. Above all, a polyolefin principal chain, a polyether principal chain and a polyurea principal chain are preferable; a polyolefin principal chain and a polyether principal chain are more preferable; and a polyolefin principal chain is the most preferable.

The polyolefin principal chain is composed of a saturated hydrocarbon. The polyolefin principal chain is obtained by, for example, an addition polymerization reaction of an unsaturated polymerizable group. In the polyether principal chain, a repeating unit thereof is bound via an ether bond (—O—). The polyether principal chain is obtained by, for example, a ring opening polymerization reaction of an epoxy group. In the polyurea principal chain, a repeating unit thereof is bound via a urea bond (—NH—CO—NH—). The polyurea principal chain is obtained by, for example, a condensation polymerization reaction between an isocyanate group and an amino group. In the polyurethane principal chain, a repeating unit thereof is bound via a urethane bond (—NH—CO—O—). The polyurethane principal chain is obtained by, for example, a condensation polymerization reaction between an isocyanate group and a hydroxyl group (including an N-methylol group). In the polyester principal chain, a repeating unit thereof is bound via an ester bond (—CO—O—). The polyester principal chain is obtained by, for example, a condensation polymerization reaction between a carboxyl group (including an acid halide group) and a hydroxyl group (including an N-methylol group). In the polyamine principal chain, a repeating unit thereof is bound via an imino bond (—NH—). The polyamine principal chain is obtained by, for example, a ring opening polymerization reaction of an ethyleneimine group. In the polyamide principal chain, a repeating unit thereof is bound via an amide bond (—NH—CO—). The polyamide principal chain is obtained by, for example, a reaction between an isocyanate group and a carboxyl group (including an acid halide group). The melamine resin principal chain is obtained by, for example, a condensation polymerization reaction between a triazine group (for example, melamine) and an aldehyde (for example, formaldehyde). Incidentally, in the melamine resin, the principal chain itself has a crosslinking structure.

The anionic group is bound directly to the polymer principal chain or bound to the principal chain via a connecting group. It is preferable that the anionic group is bound as a side chain to the principal chain via a connecting group.

Examples of the anionic group include a carboxylic acid group (carboxyl), a sulfonic acid group (sulfo), and a phosphoric acid group (phosphono), with the sulfonic acid group and the phosphoric acid group being preferable.

The anionic group may be in a salt state. A cation which forms a salt together with the anionic group is preferably an alkali metal ion. Furthermore, a proton of the anionic group may be dissociated.

It is preferable that the connecting group which binds the anionic group to the polymer principal chain is a divalent group selected from —CO—, —O—, an alkylene group, an arylene group, and combinations thereof.

The crosslinking structure undergoes chemical binding (preferably covalent binding) of two or more principal chains and preferably undergoes covalent binding of three or more principal chains. It is preferable that the crosslinking structure is composed of divalent or polyvalent groups selected from —CO—, —O—, —S—, a nitrogen atom, a phosphorus atom, an aliphatic residue, an aromatic residue, and combinations thereof.

It is preferable that the crosslinked anionic group-containing polymer is a copolymer containing an anionic group-containing repeating unit and a repeating unit having a crosslinking structure. A proportion of the anionic group-containing repeating unit in the copolymer is preferably from 2 to 96% by weight, more preferably from 4 to 94% by weight, and most preferably from 6 to 92% by weight. The repeating unit may contain two or more anionic groups. A proportion of the repeating unit having a crosslinking structure in the copolymer is preferably from 4 to 98% by weight, more preferably from 6 to 96% by weight, and most preferably from 8 to 94% by weight.

The repeating unit of the crosslinked anionic group-containing polymer may have both an anionic group and a crosslinking structure. Furthermore, other repeating unit (repeating unit having neither an anionic group nor a crosslinking structure) may be contained.

As other repeating unit, a repeating unit containing an amino group or a quaternary ammonium group and a repeating unit containing a benzene ring are preferable. The amino group or quaternary ammonium group has a function to hold a dispersed state of an inorganic particle similar to the anionic group. Incidentally, even when the amino group, the quaternary ammonium group or the benzene ring is contained in the anionic group-containing repeating unit or the repeating unit having a crosslinking structure, the same effect is obtainable.

In the repeating unit containing an amino group or a quaternary ammonium group, the amino group or the quaternary ammonium group is bound directly to the polymer principal chain or bound to the principal chain via a connecting group. It is preferable that the amino group or the quaternary ammonium group is bound as a side chain to the principal chain via a connecting group. The amino group or the quaternary ammonium group is preferably a secondary amino group, a tertiary amino group, or a quaternary ammonium group, and more preferably a tertiary amino group or a quaternary ammonium group. In the secondary amino group, tertiary amino group or quaternary ammonium group, a group which is bound to the nitrogen atom is preferably an alkyl group, more preferably an alkyl group having from 1 to 12 carbon atoms, and most preferably an alkyl group having from 1 to 6 carbon atoms. It is preferable that a counter ion of the quaternary ammonium group is a halide ion. It is preferable that the connecting group which binds the amino group or quaternary ammonium group to the polymer principal chain is a divalent group selected from —CO—, —NH—, —O—, an alkylene group, an arylene group, and combinations thereof. In the case where the crosslinked anionic group-containing polymer contains a repeating unit containing an amino group or a quaternary ammonium group, a proportion of the repeating unit is preferably from 0.06 to 32% by weight, more preferably from 0.08 to 30% by weight, and most preferably from 0.1 to 28% by weight.

(Translucent Fine Particle)

In the invention, at least one hard coat layer contains at least one coagulating metal oxide particle as a metal oxide particle. The coagulating metal oxide particle may be used in plural hard coat layers or all hard coat layers. The metal oxide particle is used for the purposes of [1] adjustment of refractive index, [2] increase of hardness, [3] improvement of brittleness or curl, [4] impartation of surface haze, and so on in the hard coat layer. In the invention, for the purpose of impartation of surface haze, a coagulating silica particle and a coagulating alumina particle are suitable in view of the transparency and cheapness. Above all, coagulating silica in which particles having a primary particle size of several tens nm form a coagulate is preferable in view of the matter that a suitable surface haze can be stably imparted. The coagulating silica can be, for example, obtained by a so-called wet method through synthesis by a neutralization reaction between sodium silicate and sulfuric acid, but it should not be construed that the invention is limited thereto. Though the wet method is roughly classified into a sedimentation method and a gelation method, any of these methods can be employed in the invention. Though a secondary particle size of the coagulating silica is preferably in the range of from 0.1 to 10.0 μm, it is selected by a combination with the thickness of the hard coat layer containing the particle. The adjustment of the secondary particle size is carried out by a degree of dispersion of the particle (it is controlled by mechanical dispersion using a sand mill, etc. or chemical dispersion using a dispersant, etc.). In particular, a value obtained by dividing the secondary particle size of the coagulating silica particle by the thickness of the hard coat layer containing it is preferably from 0.1 to 2.0, and more preferably from 0.3 to 1.0.

The secondary particle size of the coagulating silica particle is measured by a Coulter counter method.

The coagulating silica particle is preferably contained in an amount of from 0.1% by weight to 50% by weight, more preferably from 1% by weight to 50% by weight, and further preferably from 1% by weight to 30% by weight in the hard coat layer.

A translucent resin particle which can be used as the translucent fine particle jointly with the foregoing coagulating metal oxide particle, and preferably the coagulating silica particle will be hereunder described. The translucent resin particle is contained in the hard coat layer and used for the purposes of [1] adjustment of surface haze or internal haze, [2] increase of surface hardness, [3] improvement of brittleness or curl, and so on. At least one translucent resin particle is used in at least one hard coat layer. The translucent resin particle may be used in plural hard coat layers or all hard coat layers. Furthermore, the translucent resin particle may be used in a hard coat layer the same as or different from the hard coat layer containing the foregoing coagulating metal oxide particle.

Specific examples of the translucent resin part which can be preferably used jointly include resin particles such as a poly((meth)acrylate) particle, a crosslinked ((meth)acrylate) particle, a polystyrene particle, a crosslinked polystyrene particle, a crosslinked (acryl-styrene) particle, a melamine resin particle, and benzoguanamine resin particle. Above all, a crosslinked polystyrene particle, a crosslinked poly((meth)acrylate) particle, and a crosslinked poly(acryl-styrene) particle are preferable; and a crosslinked poly((meth)acrylate) particle and a crosslinked poly(acryl-styrene) particle are the most preferable. By adjusting the refractive index and addition amount of the translucent resin adaptive with the refractive index of each translucent fine particle selected among these particles, it is possible to make the internal haze fall within a desired range. An average particle size of the translucent resin particle which can be used jointly is preferable from 0.5 to 10 μm, and more preferably from 1 to 8 μm.

The average particle size of the translucent resin particle which can be used jointly is measured by a Coulter counter method.

The translucent resin particle is preferably contained in an amount of from 0.1% by weight to 50% by weight, more preferably from 1% by weight to 50% by weight, and further preferably from 1% by weight to 30% by weight in the hard coat layer.

For the purpose of improving the surface hardness (indentation hardness), the translucent resin particle which can be used jointly preferably has a compression strength of from 2.0 to 10.0 kgf/mm², more preferably from 2.5 to 10.0 kgf/mm², and further preferably from 3.0 to 10.0 kgf/mm². In order to increase the compression strength of the resin particle, it is effective to select a crosslinking agent or to increase a degree of crosslinking. What the compression strength is higher than 10.0 kgf/mm² is more preferable from the standpoint of imparting the surface hardness of the film. However, since the particle itself becomes brittle, in view of a possibility of breakage of the particle at the time of dispersion or the like, it is preferable that an upper limit of the compression strength is 10.0 kgf/mm².

In the invention, the compression strength refers to a compression strength when the particle size is deformed by 10%. The compression strength when the particle size is deformed by 10% refers to a compression strength of particle (S10 strength) and is a value as obtained by carrying out a compression test of a single resin particle until a load becomes 1 gf at 25° C. and 65% RH by using a micro compression testing machine, MCTW 201 as manufactured by Shimadzu Corporation and introducing a load when the particle size is deformed by 10% and a particle size before the compression into the following expression.
[S10 strength (kgf/mm²)]=2.8×[Load (kgf)]/{[π×(Particle size (mm))×(Particle size (mm))]}

Incidentally, the compression strength was determined according to the foregoing expression from a test force at a displacement of 10% when the compression test of the single resin particle under conditions of test indentator: FLAT 20, test load: 19.6 (mN), load rate: 0.710982 (mN/sec) and displacement full scale: 5 (μm).

[Low Refractive Index Layer]

A fluorine-containing copolymer compound can be suitably used in the low refractive index layer of the invention. Examples of a fluorine-containing vinyl monomer include fluoroolefins (for example, fluoroethylene, vinylidene fluoride, tetrafluoroethylene, and hexafluoropropylene), partially or completely fluorinated alkyl ester derivatives of (meth)acrylic acid (for example, VISCOAT 6FM (a trade name, manufactured by Osaka Organic Chemical Industry Ltd.) and R-2020 (a trade name, manufactured by Daikin Industries, Ltd.), and completely or partially fluorinated vinyl ethers. Of these, perfluoroolefins are preferable; and hexafluoropropylene is especially preferable from the viewpoints of refractive index, solubility, transparency, easiness of availability, and so on. By increasing a composition ratio of such a fluorine-containing vinyl monomer, the refractive index can be decreased, whereas the film strength is lowered. In the invention, it is preferred to introduce the fluorine-containing vinyl monomer such that the fluorine content of the copolymer is from 20 to 60% by weight. The fluorine content of the copolymer is more preferably from 25 to 55% by weight, and especially preferably from 30 to 50% by weight.

As the constitutional unit for imparting crosslinking reactivity, the following units (A), (B) and (C) are mainly enumerated.

That is, examples thereof include:

(A) a constitutional unit obtainable by polymerization of a monomer which contains a self-crosslinking functional group in the molecule thereof (for example, glycidyl (meth)acrylate and glycidyl vinyl ether) in advance;

(B) a constitutional unit obtainable by polymerization of a monomer containing a carboxyl group, a hydroxyl group, an amino group, a sulfo group, etc. [for example, (meth)acrylic acid, methylol (meth)acrylate, hydroxyalkyl (meth)acrylates, allyl acrylate, hydroxyethyl vinyl ether, hydroxybutyl vinyl ether, maleic acid, and crotonic acid]; and

(C) a constitutional unit obtainable by reaction of a compound containing a group which is reactive with the foregoing functional group (A) or (B) and another crosslinking functional group in the molecule thereof with the foregoing constitutional unit (A) or (B) (for example, a constitutional unit capable of being synthesized by a measure, for example, to make acrylic acid chloride act to a hydroxyl group).

In the invention, in the foregoing constitutional unit (C), it is especially preferable that the crosslinking functional group is a photopolymerizable group. Examples of the photopolymerizable group include a (meth)acryloyl group, an alkenyl group, a cinnamoyl group, a cinnamylideneacetyl group, a benzalacetophenone group, a stylylpyridine group, an α-phenylmaleimide group, a phenylazide group, a sulfonylazide group, a carbonylazide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group, and an azadioxabicyclo group. Such a group may be used singly or in combination of two or more kinds thereof. Of these groups, a (meth)acryloyl group and a cinnamoyl group are preferable, with a (meth)acryloyl group being especially preferable.

As a specific example of a method of preparing a photopolymerizable group-containing copolymer, the following methods can be enumerated. However, it should not be construed that the invention is limited thereto.

(a) A method of reacting a crosslinking functional group-containing copolymer containing a hydroxyl group with (meth)acrylic acid chloride to form an ester.

(b) A method of reacting a crosslinking functional group-containing copolymer containing a hydroxyl group with an isocyanate group-containing (meth)acrylic ester to form a urethane.

(c) A method of reacting a crosslinking functional group-containing copolymer containing an epoxy group with (meth)acrylic acid to form an ester.

(d) A method of reacting a crosslinking functional group-containing copolymer containing a carboxyl group with an epoxy group-containing (meth)acrylic ester to form an ester.

Incidentally, the amount of introduction of the photopolymerizable group can be arbitrarily adjusted. In view of stability of surface properties of coating film and lowering in defective surface properties at the time of the copresence of an inorganic fine particle and improvement in film strength, it is also preferable that a certain amount of a carboxyl group, a hydroxyl group, etc. remains.

In the copolymer which is useful in the invention, besides the repeating unit to be introduced from the foregoing fluorine-containing vinyl monomer and the repeating unit containing a (meth)acryloyl group in a side chain thereof, other vinyl monomer may be properly copolymerized from a variety of viewpoints such as adhesion to a substrate, Tg of a polymer (contributing to the film hardness), solubility in a solvent, transparency, slipperiness, and dustproof or antifouling properties. A plural number of such a vinyl monomer may be combined depending upon the purpose, and these vinyl monomers are preferably introduced in an amount in the range of from 0 to 65% by mole, more preferably in the range of from 0 to 40% by mole, and especially preferably in the range of from 0 to 30% by weight in total in the copolymer.

The vinyl monomer unit which can be used jointly is not particularly limited, and examples thereof include olefins (for example, ethylene, propylene, isoprene, vinyl chloride, and vinylidene chloride), acrylic esters (for example, methyl acrylate, methyl acrylate, ethyl acrylate, 2-ethylhexyl acrylate, and 2-hydroxyethyl acrylate), methacrylic esters (for example, methyl methacrylate, ethyl methacrylate, butyl methacrylate, and 2-hydroxyethyl methacrylate), styrene derivatives (for example, styrene, p-hydroxymethylstyrene, and p-methoxystyrene), vinyl ethers (for example, methyl vinyl ether, ethyl vinyl ether, cyclohexyl vinyl ether, hydroxyethyl vinyl ether, and hydroxybutyl vinyl ether), vinyl esters (for example, vinyl acetate, vinyl propionate, and vinyl cinnamate), unsaturated carboxylic acids (for example, acrylic acid, methacrylic acid, crotonic acid, maleic acid, and itaconic acid), acrylamides (for example, N,N-dimethyl acrylamide, N-tert-butyl acrylamide, and N-cyclohexyl acrylamide), methacrylamides (for example, N,N-dimethyl methacrylamide), and acrylonitrile.

In the invention, an especially useful fluorine-containing polymer is a random copolymer of a perfluoroolefin and a vinyl ether or a vinyl ester. It is especially preferable that the fluorine-containing polymer contains a group which is able to undergo a crosslinking reaction singly (for example, a radical reactive group such as a (meth)acryloyl group and a ring-opening polymerizable group such as an epoxy group and an oxetanyl group). Such a crosslinking reactive group-containing polymerization unit preferably accounts for from 5 to 70% by mole, and especially preferably from 30 to 60% by mole of the whole of polymerization units of the polymer. As a preferred polymer, polymers as described in JP-A-2002-243907, JP-A-2002-372601, JP-A-2003-26732, JP-A-2003-222702, JP-A-2003-294911, JP-A-2003-329804, JP-A-2004-4444, and JP-A-2004-45462 can be enumerated.

Furthermore, for the purpose of imparting antifouling properties to the fluorine-containing polymer of the invention, it is preferable that a polysiloxane structure is introduced. Though a method of introducing a polysiloxane structure is not limited, for example, a method of introducing a polysiloxane block copolymerization component by using a silicone macro azo initiator as described in JP-A-6-93100, JP-A-11-189621, JP-A-11-228631 and JP-A-2000-313709; and a method of introducing a polysiloxane graft copolymerization component by using a silicone macromer as described in JP-A-2-251555 and JP-A-2-308806 are preferable. Examples of especially preferred compounds include polymers of Examples 1, 2 and 3 of JP-A-11-189621 and copolymers A-2 and A-3 of JP-A-2-251555. Such a polysiloxane component is preferably contained in an amount of from 0.5 to 10% by weight, and especially preferably from 1 to 5% by weight in the polymer.

A molecular weight of the polymer which can be preferably used in the invention is 5,000 or more, preferably from 10,000 to 500,000, and most preferably from 15,000 to 200,000 in terms of a weight average molecular weight. By jointly using polymers having a different average molecular weight from each other, the surface properties and scar resistance of a coating film can be improved.

The foregoing fluorine-containing polymer may be properly used together with a hardening agent containing a polymerizable unsaturated group as described in JP-A-10-25388 and JP-A-2000-17028. It is also preferable that the fluorine-containing polymer is used together with a fluorine-containing polyfunctional polymerizable unsaturated group-containing compound as described in JP-A-2002-145952. Examples of the polyfunctional polymerizable unsaturated group-containing compound include the foregoing polyfunctional monomers as described in the hard coat layer. In particular, the case where a compound containing a polymerizable unsaturated group in the polymer main body is used is preferable because its effect due to the joint use against the improvement in scar resistance is large.

A refractive index of the low refractive index layer is preferably from 1.20 to 1.46, more preferably from 1.25 to 1.42, and especially preferably from 1.30 to 1.38.

A thickness of the low refractive index layer is preferably from 50 to 150 nm, and more preferably from 70 to 120 nm.

The fine particle which can be preferably used in the low refractive index layer of the invention will be hereunder described.

The coating amount of the fine particle is preferably from 1 mg/m² to 100 mg/m², more preferably from 5 mg/m² to 80 mg/m², and further preferably from 10 mg/m² to 70 mg/m². When the coating amount of the fine particle is too low, an effect for improving the scar resistance becomes low, whereas when it is too high, fine irregularities are formed on the surface of the low refractive index layer and the appearance and integrated reflectance are deteriorated. It is desired that the fine particle has a low refractive index from the standpoint that it is contained in the low refractive index layer.

Concretely, it is preferable that the fine particle is a metal oxide fine particle, a hollow metal oxide fine particle or a hollow organic resin fine particle and has a low refractive index. Examples thereof include silica or follow silica fine particles. An average particle size of the fine particle which is used in the low refractive index layer is preferably 15% or more and not more than 150%, more preferably 25% or more and not more than 100%, and further preferably 35% or more and not more than 70% of the thickness of the low refractive index layer. That is, when the thickness of the low refractive index layer is 100 nm, the particle size of the fine particle is preferably 15 nm or more and not more than 150 nm, more preferably 25 nm or more and not more than 100 nm, and further preferably 35 nm or more and not more than 60 nm. In order to design to strengthen the scar resistance, it is preferable that a metal oxide particle is contained in all layers of the optical film; and it is the most preferable that a silica particle is contained in all layers of the optical film.

As described previously, when the particle size of the (hollow) silica fine particle is too small, an effect for improving the scar resistance becomes low, whereas when it is too large, fine irregularities are formed on the surface of the low refractive index layer and the appearance and integrated reflectance are deteriorated. The (hollow) silica fine particle may be either crystalline or amorphous and may be either a monodispersed particle or a coagulated particle (in this case, a secondary particle size is preferably from 15% to 150% of the thickness of the low refractive index layer). Furthermore, two or more kinds of plural particles (different in the kind or particle size) may be used. Though the shape of the particle is mostly preferably spherical, it may be amorphous.

For the purpose of lowering the refractive index of the low refractive index layer, it is most preferred to use a hollow silica fine particle. The hollow silica fine particle preferably has a refractive index of from 1.17 to 1.40, more preferably from 1.17 to 1.35, and further preferably from 1.17 to 1.30. The refractive index as referred to herein expresses a refractive index as the whole of the particle but does not express a refractive index of only silica in an outer shell which forms the hollow silica fine particle. At this time, when a radius of a void within the particle is defined as “a” and a radius of the outer shell of the particle is defined as “b”, a porosity x is calculated according to the following numerical expression (I).
x=(4πa³/3)/(4πb³/3)×100 Numerical Expression (I)

The porosity x is preferably from 10 to 60%, more preferably from 20 to 60%, and most preferably from 30 to 60%. When it is intended to make the hollow silica particle have a lower refractive index and a larger porosity, the thickness of the outer shell becomes thin so that the strength as the particle is weakened. Accordingly, a particle having a low refractive index of less than 1.17 is not applicable from the viewpoint of scar resistance. Incidentally, the refractive index of the hollow silica particle was measured by an Abbe's refractometer (manufactured by Atago Co., Ltd.).

In the invention, from the viewpoint of improving the antifouling properties, it is preferred to reduce surface free energy of the surface of the low refractive index layer. Concretely, it is preferred to use a fluorine-containing compound or a compound having a polysiloxane structure in the low refractive index layer. It is preferred to add, as an additive having a polysiloxane structure, a reactive group-containing polysiloxane (for example, KF-100T, X-22-169AS, KF-102, X-22-37011E, X-22-164B, X-22-5002, X-22-173B, X-22-174D, X-22-167B and X-22-161AS (trade names, manufactured by Shin-Etsu Chemical Co., Ltd.); AK-5, AK-30 and AK-32 (trade names, manufactured by Toagosei Co., Ltd.); and SILAPLANE FM0725 and SILAPLANE FM0721 (trade names, manufactured by Chisso Corporation)). Furthermore, silicone based compounds as described in Tables 2 and 3 of JP-A-2003-112383 can be preferably used. Such a polysiloxane is preferably added in an amount in the range of from 0.1 to 10% by weight, and especially preferably in the range of from 1 to 5% by weight based on the whole of solids of the low refractive index layer.

[Components to be Contained in Hard Coat Layer and/or Low Refractive Index Layer]

(Organosilane Compound)

In view of the scar resistance, it is preferable that at least one of the layers configuring the optical film of the invention contains at least one component of a hydrolyzate of an organosilane compound and/or its partial condensate, a so-called sol component (hereinafter sometimes referred to like this). In the optical film having a low refractive index layer, in order to make both antireflection performance and scar resistance compatible with each other, it is especially preferable that the sol component is contained in the low refractive index layer. After coating, this sol component is condensed in drying and heating steps to form a hardened material, whereby it becomes a part of the binder of the low refractive index layer. Furthermore, in the case where the hardened material contains a polymerizable unsaturated bond, a binder having a three-dimensional structure is formed upon irradiation with active rays.

The organosilane compound is preferably one represented by the following formula (1).
(R1)ₘ-Si(X)₄₋m Formula (1)

In the foregoing formula (1), R1 represents a substituted or unsubstituted alkyl group or a substituted or unsubstituted aryl group. The alkyl group preferably has from 1 to 30 carbon atoms, more preferably from 1 to 16 carbon atoms, and especially preferably from 1 to 6 carbon atoms. Examples of the alkyl group include methyl, ethyl, propyl, isopropyl, hexyl, decyl, and hexadecyl. Examples of the aryl group include phenyl and naphthyl. Of these, a phenyl group is preferable.

X represents a hydroxyl group or a hydrolyzable group. Examples of the hydrolyzable group include an alkoxy group (preferably an alkoxy group having from 1 to 5 carbon atoms, for example, a methoxy group and an ethoxy group), a halogen atom (for example, Cl, Br, and I), and R2COO (wherein R2 is preferably a hydrogen atom or an alkyl group having from 1 to 6 carbon atoms; and examples thereof include CH₃COO and C₂H₅COO). Of these, an alkoxy group is preferable; and a methoxy group and an ethoxy group are especially preferable.

m represents an integer of from 1 to 3, and preferably from 1 to 2.

When plural Xs or Xs are present, the plural Xs may be the same or different. The substituent which is contained in R1 is not particularly limited, and examples thereof include a halogen atom (for example, fluorine, chlorine, and bromine), a hydroxyl group, a mercapto group, a carboxyl group, an epoxy group, an alkyl group (for example, methyl, ethyl, isopropyl, propyl, and t-butyl), an aryl group (for example, phenyl and naphthyl), an aromatic heterocyclic group (for example, furyl, pyrazolyl, and pyridyl), an alkoxy group (for example, methoxy, ethoxy, isopropoxy, and hexyloxy), an aryloxy group (for example, phenoxy), an alkylthio group (for example, methylthio and ethylthio), an arylthio group (for example, phenylthio), an alkenyl group (for example, vinyl and 1-propenyl), an acyloxy group (for example, acetoxy, acryloyloxy, and methacryloyloxy), an alkoxycarbonyl group (for example, methoxycarbonyl and ethoxycarbonyl), an aryloxycarbonyl group (for example, phenoxycarbonyl), a carbamoyl group (for example, carbamoyl, N-methylcarbamoyl, N,N-dimethylcarbamoyl, and N-methyl-N-octylcarbamoyl), and an acylamino group (for example, acetylamino, benzoylamino, acrylamino, and methacrylamino). Such a substituent may be further substituted.

R1 is preferably a substituted alkyl group or a substituted aryl group.

Furthermore, a vinyl polymerizable substituent-containing organosilane compound represented by the following formula (2) is preferable.

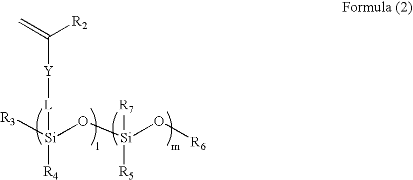

In the foregoing formula (2), R₂ represents a hydrogen atom, a methyl group, a methoxy group, an alkoxycarbonyl group, a cyano group, a fluorine atom, or a chlorine atom. Examples of the alkoxycarbonyl group include a methoxycarbonyl group and an ethoxycarbonyl group. Above all, a hydrogen atom, a methyl group, a methoxy group, a methoxycarbonyl group, a cyano group, a fluorine atom, and a chlorine atom are preferable; a hydrogen atom, a methyl group, a methoxycarbonyl group, a fluorine atom, and a chlorine atom are more preferable; and a hydrogen atom and a methyl group are especially preferable.

Y represents a single bond, *—COO—**, *—CONH—**, or *—O—**. Of these, a single bond, *—COO—**, and *—CONH—** are preferable; a single bond and *—COO—** are more preferable; and *—COO—** is especially preferable. * represents the binding position to ═C(R₂); and ** represents the binding position to L.

L represents a divalent connecting chain. Specific examples thereof include a substituted or unsubstituted alkylene group, a substituted or unsubstituted arylene group, a substituted or unsubstituted alkylene group containing a connecting group (for example, ethers, esters, and amides) therein, and a substituted or unsubstituted arylene group containing a connecting group therein. Of these, a substituted or unsubstituted alkylene group, a substituted or unsubstituted arylene group, and an alkylene group containing a connecting group therein are preferable; an unsubstituted alkylene group, an unsubstituted arylene group, and an alkylene group containing an ether or ester connecting group therein are more preferable; and an unsubstituted alkylene group and an alkylene group containing an ether or ester connecting group therein are especially preferable. Examples of the substituent include a halogen, a hydroxyl group, a mercapto group, a carboxyl group, an epoxy group, an alkyl group, and an aryl group. Such a substituent may be further substituted.

l and m each represents a molar ratio which is satisfied with a numerical expression: [l=(100−m)]; and m represents a number of from 0 to 50. m is more preferably a number of from 0 to 40, and more preferably a number of from 0 to 30.

R₃ to R₅ are each preferably a halogen atom, a hydroxyl group, an unsubstituted alkoxy group, or an unsubstituted alkyl group. R₃ to R₅ are each more preferably a chlorine atom, a hydroxyl group, or an alkoxy group having from 1 to 6 carbon atoms; further preferably a hydroxyl group or an alkoxy group having from 1 to 3 carbon atoms; and especially preferably a hydroxyl group or a methoxy group.

R₆ represents a hydrogen atom, an alkyl group, an alkoxy group, an alkoxycarbonyl group, a cyano group, a fluorine atom, or a chlorine atom. Examples of the alkyl group include a methyl group and an ethyl group; examples of the alkoxy group include a methoxy group and an ethoxy group; and examples of the alkoxycarbonyl group include a methoxycarbonyl group and an ethoxycarbonyl group. Above all, a hydrogen atom, a methyl group, a methoxy group, a methoxycarbonyl group, a cyano group, a fluorine atom, and a chlorine atom are preferable; a hydrogen atom, a methyl group, a methoxycarbonyl group, a fluorine atom, and a chlorine atom are more preferable; and a hydrogen atom and a methyl group are especially preferable. R₇ represents a hydroxyl group, a substituted or unsubstituted alkyl group, or a substituted or unsubstituted aryl group; more preferably a hydroxyl group or an unsubstituted alkyl group; further preferably a hydroxyl group or an alkyl group having from 1 to 3 carbon atoms; and especially preferably a hydroxyl group or a methyl group.

With respect to the compound of the formula (1), two or more kinds thereof may be used jointly. In particular, the compound of the formula (2) is synthesized by using at least one kind of the compound of the formula (1) as a starting material. Specific examples of the compound represented by the formula (1) and the starting material of the compound represented by the formula (2) will be given below, but it should not be construed that the invention is limited thereto.

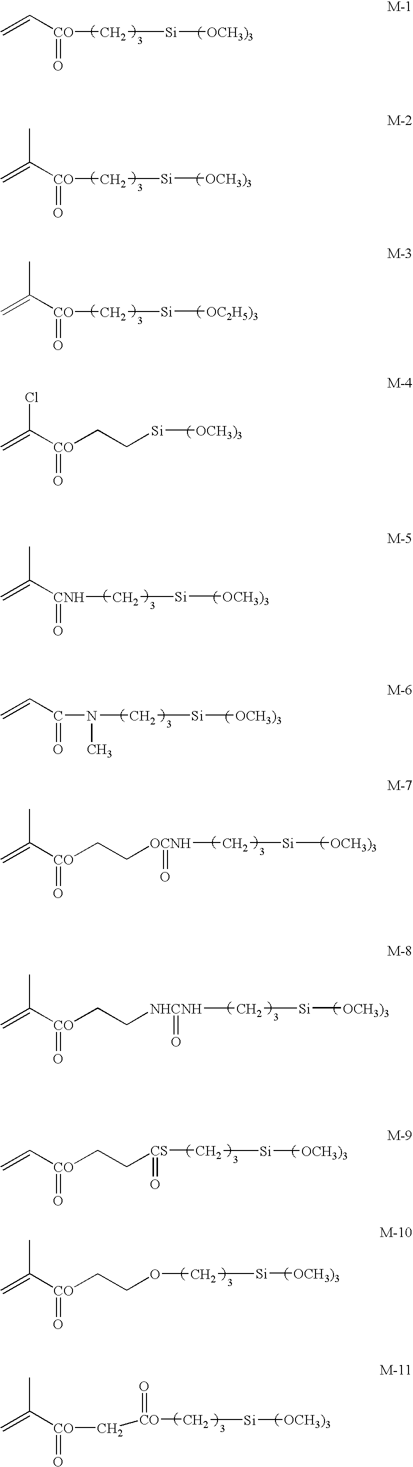

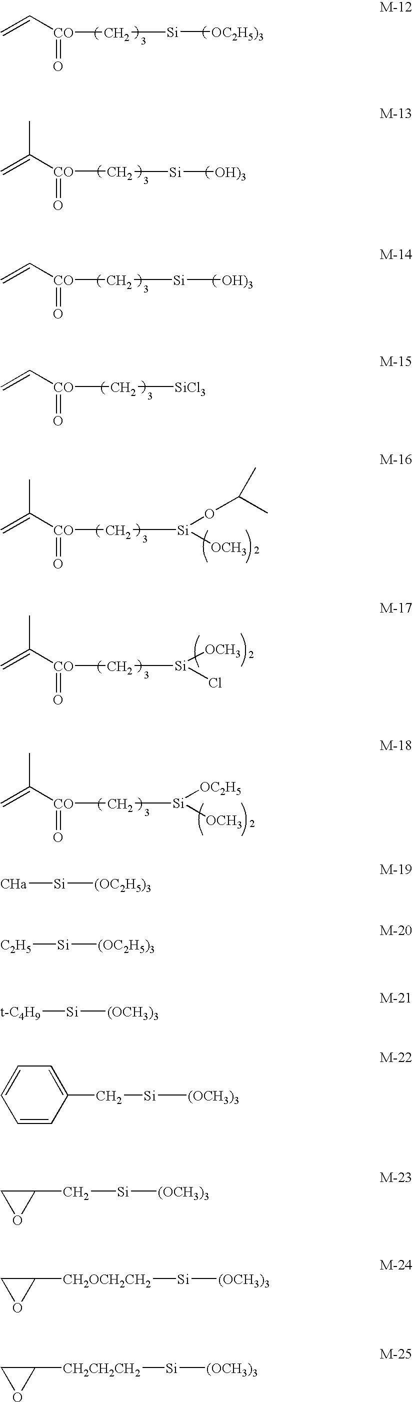

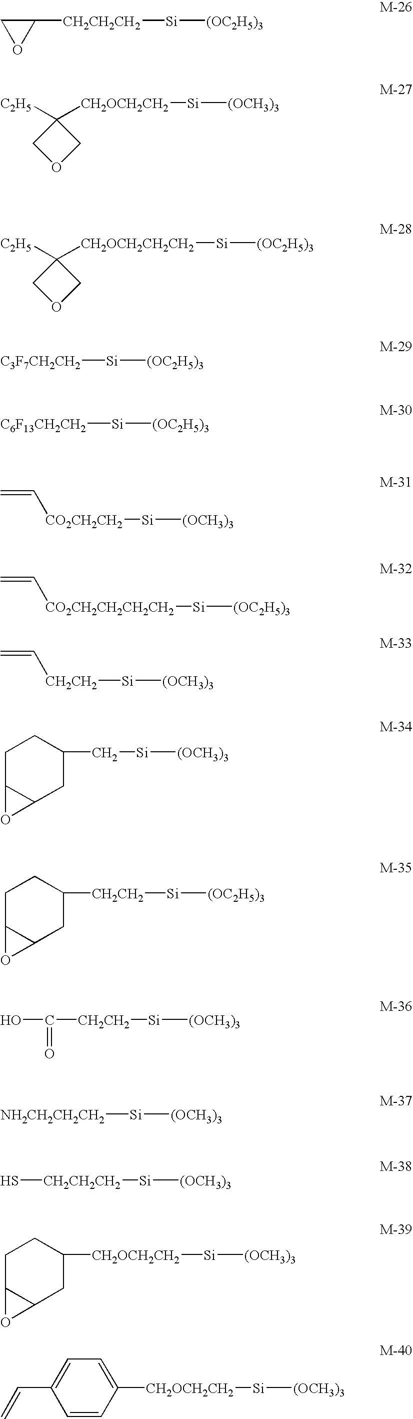

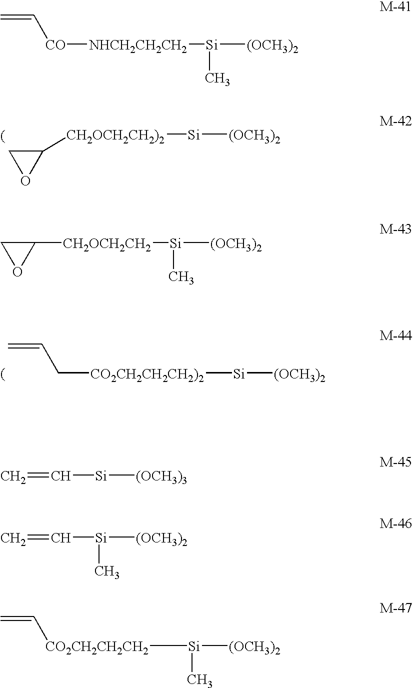

M-48: Methyltrimethoxysilane

Of these, (M-1), (M-2), (M-2) and (M-25) are especially preferable as the polymerizable group-containing organosilane.

In order to obtain the effects of the invention, the content of the vinyl polymerizable group-containing organosilane in the hydrolyzate of an organosilane and/or its partial condensate is preferably from 30% by weight to 100% by weight, more preferably from 50% by weight to 100% by weight, and especially preferably from 70% by weight to 95% by weight. When the content of the vinyl polymerizable group-containing organosilane is less than 30% by weight, a solid is generated; the liquid becomes cloudy; a pot life is deteriorated; the control of the molecular weight becomes difficult (the molecular weight increases); and when a polymerization treatment is carried out, an improvement of a performance (for example, scar resistance of the antireflection film) is hardly obtained because of a low content of the polymerizable group. Therefore, such is not preferable. In the case of synthesizing the compound represented by the formula (2), it is preferred to use a combination of (M-1) or (M-2) as the vinyl polymerizable group-containing organosilane and one member selected from (M-19) to (M-21) and (M-48) as a vinyl polymerizable group-free organosilane.

For the purpose of stabilizing the performance of a coated article, it is preferable that the volatility of at least one of the hydrolyzate of an organosilane and its partial condensate according to the invention is suppressed. Concretely, the amount of volatilization per hour at 105° C. is preferably not more than 5% by weight, more preferably not more than 3% by weight, and especially preferably not more than 1% by weight.

The sol component which is used in the invention is prepared by hydrolyzing and/or partially condensing the foregoing organosilane.

The hydrolysis condensation reaction is carried out by adding water in an amount of from 0.05 to 2.0 moles, and preferably from 0.1 to 1.0 mole per mole of the hydrolyzable group (X) and stirring at from 25 to 100° C. in the presence of the catalyst which is used in the invention.

In at least one of the hydrolyzate of an organosilane and its partial condensate according to the invention, a weight average molecular weight of either one of the hydrolyzate of the vinyl polymerizable group-containing organosilane or its partial condensate from which, however, components having a molecular weight of less than 300 are excluded is preferably from 450 to 20,000, more preferably from 500 to 10,000, further preferably from 550 to 5,000, and still further preferably from 600 to 3,000.

Among the components having a molecular weight of 300 or more in the hydrolyzate of an organosilane and/or its partial condensate, the content of a component having a molecular weight exceeding 20,000 is preferably not more than 10% by weight, more preferably not more than 5% by weight, and further preferably 3% by weight. When the content of a component having a molecular weight exceeding 20,000 is more than 10% by weight, there is a possibility that a hardened film as obtained by hardening a hardenable composition containing such a hydrolyzate of an organosilane and/or its partial condensate is deteriorated in transparency or adhesion to a substrate.

Here, the weight average molecular weight and the number average molecular weight are a molecular weight as reduced into polystyrene, which is detected in THF as a solvent by a differential refractometer by using a GPC analyzer with a column of “TSKgel GMHxL”, “TSKgel G4000HxL” or “TSKgel G2000HxL” (all of which are a trade name as manufactured by Tosoh Corporation). In the case where a peak area of components having a molecular weight of 300 or more is defined as 100%, the content means an area % of peaks of the foregoing molecular weight range.

A degree of dispersion [(weight average molecular weight)/(number average molecular weight)] is preferably from 3.0 to 1.1, more preferably from 2.5 to 1.1, further preferably from 2.0 to 1.1, and especially preferably from 1.5 to 1.1.

By the ²⁹Si-NMR analysis of the hydrolyzate of an organosilane and its partial condensate according to the invention, a state that X of the formula (1) is condensed in an —OSi form can be confirmed.

At this time, when the case where three bonds of Si are condensed in an —OSi form is defined as T3, the case where two bonds of Si are condensed in an —OSi form is defined as T2, the case where one bond of Si is condensed in an —OSi form is defined as T1, and the case where Si is not condensed at all is defined as T0, a condensation rate a which is expressed by the following expression (II):
α=(T3×3+T2×2+T1×1)/3/(T3+T2+T1+T0) Numerical Expression (II)
is preferably from 0.2 to 0.95, more preferably from 0.3 to 0.93, and especially preferably from 0.4 to 0.9.

When the condensation rate a is less than 0.2, the hydrolysis or condensation is not sufficient and the amount of the monomer components increases so that the hardening does not proceed sufficiently. On the other hand, when the condensation rate a is larger than 0.95, the hydrolysis or condensation excessively proceeds and the hydrolyzable group is consumed so that a mutual action among the binder polymer, the resin substrate, the inorganic fine particles, and so on is lowered. As a result, even by using these materials, the desired effects are hardly obtained.

The hydrolyzate of an organosilane compound and its partial condensate which are used in the invention will be hereunder described in detail.

The hydrolysis reaction of the organosilane and the subsequent condensation reaction are generally carried out in the presence of a catalyst. Examples of the catalyst include inorganic acids such as hydrochloric acid, sulfuric acid, and nitric acid; organic acids such as oxalic acid, acetic acid, butyric acid, maleic acid, citric acid, formic acid, methanesulfonic acid, and toluenesulfonic acid; inorganic bases such as sodium hydroxide, potassium hydroxide, and ammonia; organic bases such as triethylamine and pyridine; metal alkoxides such as triisopropoxy aluminum, tetrabutoxy zirconium, tetrabutyl titanate, and dibutyltin dilaurate; metal chelate compounds containing, as a central metal, a metal (for example, Zr, Ti, and Al); and fluorine-containing compound such as KF and NH₄F.

The foregoing catalyst may be used singly or in combination of plural kinds thereof.

Though the hydrolysis reaction of the organosilane and the condensation reaction may be carried out in the absence of a solvent or in a solvent, for the purpose of uniformly mixing the components, it is preferred to use an organic solvent. Examples of the solvent include alcohols, aromatic hydrocarbons, ethers, ketones, and esters.

The solvent is preferably a solvent capable of dissolving the organosilane and the catalyst therein. From the process standpoint, it is preferred to use an organic solvent as a coating solution or a part of a coating solution. The solvent is preferably a solvent which in the case of mixing with other raw materials such as the fluorine-containing polymer, does not impair solubility or dispersibility.

Of these, examples of the alcohol include monovalent alcohols and divalent alcohols. As the monovalent alcohol, saturated aliphatic alcohols having from 1 to 8 carbon atoms are preferable.

Specific examples of such an alcohol include methanol, ethanol, n-propyl alcohol, isopropyl alcohol, n-butyl alcohol, sec-butyl alcohol, tert-butyl alcohol, ethylene glycol, diethylene glycol, triethylene glycol, ethylene glycol monobutyl ether, and acetic acid ethylene glycol monoethyl ether.

Furthermore, specific examples of the aromatic hydrocarbon include benzene, toluene and xylene; specific example of the ether include tetrahydrofuran and dioxane; specific examples of the ketone include acetone, methyl ethyl ketone, methyl isobutyl ketone, diisobutyl ketone, and cyclohexanone; and specific examples of the ester include ethyl acetate, propyl acetate, butyl acetate, and propylene carbonate.

Such an organic solvent may be used singly or in admixture of two or more kinds thereof. Though the concentration of the solid in the reaction is not particularly limited, it is usually in the range of from 1% to 100%.

The reaction is carried out by adding water in an amount of from 0.05 to 2 moles, and preferably from 0.1 to 1 mole per mole of the hydrolyzable group of the organosilane and stirring the mixture in the presence or absence of the foregoing solvent and in the presence of the catalyst at from 25 to 100° C.

In the invention, it is preferable that the hydrolysis is carried out by stirring the mixture in the presence of at least one metal chelate compound containing, as ligands, an alcohol represented by the formula: R3OH (wherein R3 represents an alkyl group having from 1 to 10 carbon atoms) and a compound represented by the formula: R4COCH₂COR5 (wherein R4 represents an alkyl group having from 1 to 10 carbon atoms; and R5 represents an alkyl group having from 1 to 10 carbon atoms or an alkoxy group having from 1 to 10 carbon atoms) and containing, as a central metal, a metal selected from Zr, Ti and Al at from 25 to 100° C.

Alternatively, in the case of using a fluorine-containing compound as the catalyst, since the fluorine-containing compound has an ability to advance the hydrolysis and condensation, by selecting the amount of water to be added, a polymerization degree can be determined so that it becomes possible to set up an arbitrary molecular weight. Therefore, such is preferable. That is, in order to prepare an organosilane hydrolyzate/partial condensate having an average polymerization degree M, (M-1) moles of water may be used against M moles of a hydrolyzable organosilane.

So far as the metal chelate compound is a metal chelate compound containing, as ligands, an alcohol represented by the formula: R3OH (wherein R3 represents an alkyl group having from 1 to 10 carbon atoms) and a compound represented by the formula: R4COCH₂COR5 (wherein R4 represents an alkyl group having from 1 to 10 carbon atoms; and R5 represents an alkyl group having from 1 to 10 carbon atoms or an alkoxy group having from 1 to 10 carbon atoms) and containing, as a central metal, a metal selected from Zr, Ti and Al, it can be suitably used without particular limitations. Two or more kinds of the metal chelate compound may be used jointly within the foregoing scope. The metal chelate compound which is used in the invention is preferably selected from a group of compounds represented by the formulae: Zr(OR3)ₚ₁(R4COCHCOR5)ₚ₂, Ti(OR3)_{q1}(R4COCHCOR5)_{q2}, and Al(OR3)ᵣ₁(R4COCHCOR5)ᵣ₂ and has an action to promote the condensation reaction of the hydrolyzate of an organosilane compound and its partial condensation.

In the metal chelate compound, R3 and R4 may be the same or different and each represents an alkyl group having from 1 to 10 carbon atoms (for example, an ethyl group, an n-propyl group, an isopropyl group, an n-butyl group, a sec-butyl group, a t-butyl group, an n-pentyl group, and a phenyl group). Furthermore, R5 represents an alkyl group having from 1 to 10 carbon atoms (the same as the foregoing alkyl group) or an alkoxy group having from 1 to 10 carbon atoms (for example, a methoxy group, an ethoxy group, an n-propoxy group, an isopropoxy group, an n-butoxy group, a sec-butoxy group, and a t-butoxy group). Furthermore, in the metal chelate compound, p1, p2, q1, q2, r1 and r2 each represents an integer as determined such that (p1+p2) is 4, (q1+q2) is 4, and (r1+r2) is 3.

Specific examples of such a metal chelate compound include zirconium chelate compounds such as tri-n-butoxyethyl acetoacetate zirconium, di-n-butoxy bis(ethyl acetoacetate) zirconium, n-butoxy tris(ethyl acetoacetate) zirconium, tetrakis(n-propyl acetoacetate) zirconium, tetrakis(acetyl acetoacetate) zirconium, and tetrakis(ethyl acetoacetate) zirconium; titanium chelate compounds such as diisopropoxy-bis(ethyl acetoacetate) titanium, diisopropoxy-bis(acetyl acetate) titanium, and diisopropoxy-bis(acetytlacetone) titanium; and aluminum chelate compounds such as diisopropoxyethyl acetoacetate aluminum, diisopropoxyacetyl acetonate aluminum, isopropxy bis(ethyl acetoacetate) aluminum, isopropoxy bis(acetyl acetonate) aluminum, tris(ethyl acetoacetate) aluminum, tris(acetyl acetonate) aluminum, and monoacetyl acetonate.bis(ethyl acetoacetate) aluminum.

Of these metal chelate compounds, tri-n-butoxyethyl acetoacetate zirconium, diisopropoxy.bis(acetyl acetate) titanium, diisopropoxyethyl acetoacetate aluminum, and tris(ethyl acetoacetate) aluminum are preferable. Such a metal chelate compound can be used singly or in admixture of two or more kinds thereof. A partial hydrolyzate of such a metal chelate compound can also be used.

The metal chelate compound is preferably used in a proportion of from 0.01 to 50% by weight, more preferably from 0.1 to 50% by weight, and further preferably from 0.5 to 10% by weight based on the foregoing organosilane compound. By using the metal chelate compound within the foregoing range, the condensation reaction of the organosilane compound is fast; the durability of a coating film is satisfactory; and the storage stability of a composition containing the hydrolyzate of an organosilane compound and its partial condensate and the metal chelate compound is satisfactory.

It is preferable that in addition to the composition containing the foregoing sol component and metal chelate compound, at least one of a β-diketone compound and a β-ketoester compound is added in the coating solution which is used in the invention. This will be further described below.

The β-diketone compound and the β-ketoester compound which are used in the invention are respectively a β-diketone compound and a β-ketoester compound represented by the formula: R4COCH₂COR5 and acts as a stability improving agent of the composition to be used in the invention. That is, it is thought that by coordinating in a metal atom in the foregoing metal chelate compound (any one compound of zirconium, titanium and aluminum compounds), an action to promote the condensation reaction of the hydrolyzate of an organosilane compound and its partial condensate due to such a metal chelating compound is suppressed, thereby acting to improve the storage stability of the resulting composition. R4 and R5 constituting the β-diketone compound or the β-ketoester compound are synonymous with R4 and R5 constituting the foregoing metal chelate compound.

Specific examples of the β-diketone compound and the β-ketoester compound include acetylacetone, methyl acetoacetate, ethyl acetoacetate, n-propyl acetoacetate, isopropyl acetoacetate, n-butyl acetoacetate, sec-butyl acetoacetate, t-butyl acetoacetate, 2,4-hexanedione, 2,4-heptanedione, 3,5-hetanedione, 2,4-octanedione, 2,4-nonanedione, and 5-methylhexanedione. Of these, ethyl acetoacetate and acetylacetone are preferable, with acetylacetone being especially preferable. Such a β-diketone compound or β-detoester compound can be used singly or in admixture of two or more kinds thereof. In the invention, the β-diketone compound or β-detoester compound is preferably used in an amount of 2 moles or more, and more preferably from 3 to 20 moles per mole of the metal chelate compound. When the amount of the β-diketone compound or β-detoester compound is less than 2 moles, the resulting composition may possibly be deteriorated in storage stability and therefore, such is not preferred.

It is preferable that the content of the hydrolyzate of an organosilane compound and its partial condensate is low in the case of an antireflection layer which is a relatively thin film, whereas it is high in the case of a hard coat layer or an antiglare layer which is a thick film. Taking into consideration revealment of the effects, refractive index, shape and surface properties of the film, and so on, the content of the hydrolyzate of an organosilane compound and its partial condensate is preferably from 0.1 to 50% by weight, more preferably from 0.5 to 30% by weight, and most preferably from 1 to 15% by weight based on the whole of solids in the layer in which the hydrolyzate of an organosilane compound and its partial condensate are contained (the layer in which the hydrolyzate of an organosilane compound and its partial condensate are added).

When the hydrolyzate of a vinyl polymerizable group-containing organosilane compound and/or its partial condensate is used, it is preferred to jointly use a photodecomposable initiator. With respect to a skeleton of the initiator, compounds enumerated in the paragraph of an initiator as described later can be referred to.

(Polymerization Initiator)

<Photo Initiator>

Examples of the photo radical polymerization initiator include acetophenones, benzoins, benzophenones, phosphine oxides, ketals, anthraquinones, thioxanthones, azo compounds, peroxides (for example, ones described in JP-A-2001-139663), 2,3-dialkyldione compounds, disulfide compounds, fluoroamine compounds, aromatic sulfoniums, lophine dimers, onium salts, borate salts, active esters, active halogens, inorganic complexes, and coumarins.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone, 4-phenoxydichloroacetophenone, and 4-t-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether, and benzoin isopropyl ether. Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), and 3,3′,4,4′-tetra(t-butyl peroxycarbonyl)benzophenone.

Examples of the borate salts include organic boric acid salt compounds as described in Japanese Patent No. 2764769, JP-A-2002-116539, and Kunz and Martin, Red Tech '98. Proceeding, April, pages 19 to 22 (1998), Chicago. For example, there are enumerated compounds as described in paragraphs [0022] to [0027] of the foregoing JP-A-2002-116539. Furthermore, specific examples of other organoboron compounds include organoboron transition metal-coordinated complexes as described in JP-A-6-3480 11, JP-A-7-128785, JP-A-7-140589, JP-A-7-306527, and JP-A-7-292014. Specific examples thereof also include ion complexes with a cationic dye.

Examples of the phosphine oxides include 2,4,6-trimethylbenzoyl diphenylphosphine oxide.

Examples of the active esters include 1,2-octanedione, 1-[4-(phenylthio)-2-(O-benzoyloxime)], sulfonic acid esters, and cyclic active ester compounds.

Concretely, Compounds 1 to 21 as described in the working examples of JP-A-2000-80068 are especially preferable.

Examples of the onium salts include aromatic diazonium salts, aromatic iodonium salts, and aromatic sulfonium salts.

As the active halogens, there are concretely enumerated compounds as described in Wakabayashi, et al., Bull Chem. Soc. Japan, Vol. 42, 2924 (1969), U.S. Pat. No. 3,905,815, JP-A-5-27830, and M. P. Hutt, Journal of Heterocyclic Chemistry, Vol. 1 (No. 3), 1970, and especially oxazole compounds and s-triazine compounds having a trihalomethyl group substituted thereon. More suitably, there are enumerated s-triazine derivatives in which at least one mono-, di- or trihalogen-substituted methyl group is bound to an s-triazine ring. As specific examples, there are known s-triazine or oxathiazole compounds including 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-bromo-4-di(ethyl acetate)amino)phenyl)-4,6-bis(trichloromethyl)-s-triazine, and a 2-trihalomethyl-5-(p-methoxyphenyl)-1,3,4-oxadiazole. Concretely, compounds as described in JP-A-58-15503, pages 14 to 30 and JP-A-55-77742, pages 6 to 10; and Compound Nos. 1 to 8 as described in JP-B-60-27673, page 287, Compound Nos. 1 to 17 as described in JP-A-60-239736, pages 443 to 444, and Compound Nos. 1 to 19 of U.S. Pat. No. 4,701,399.

Specific examples of the active halogens are as follows.

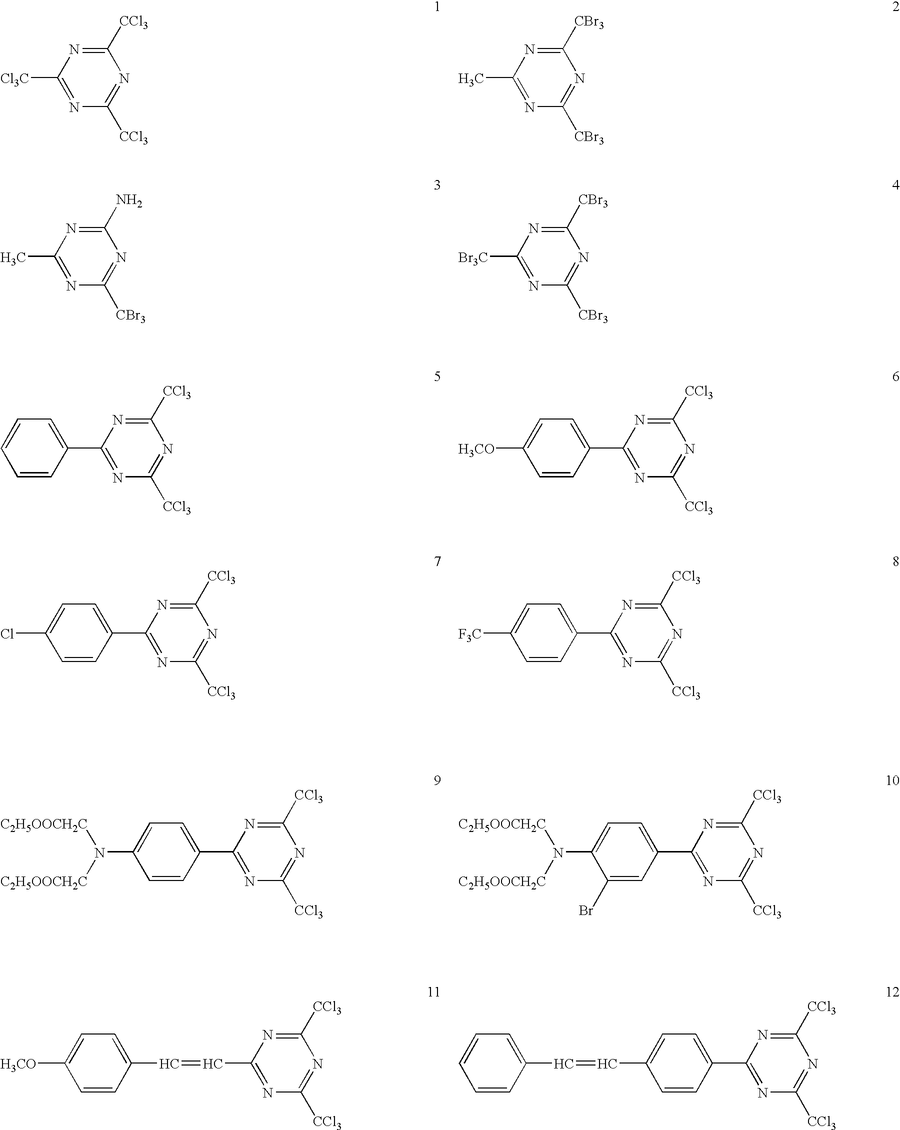

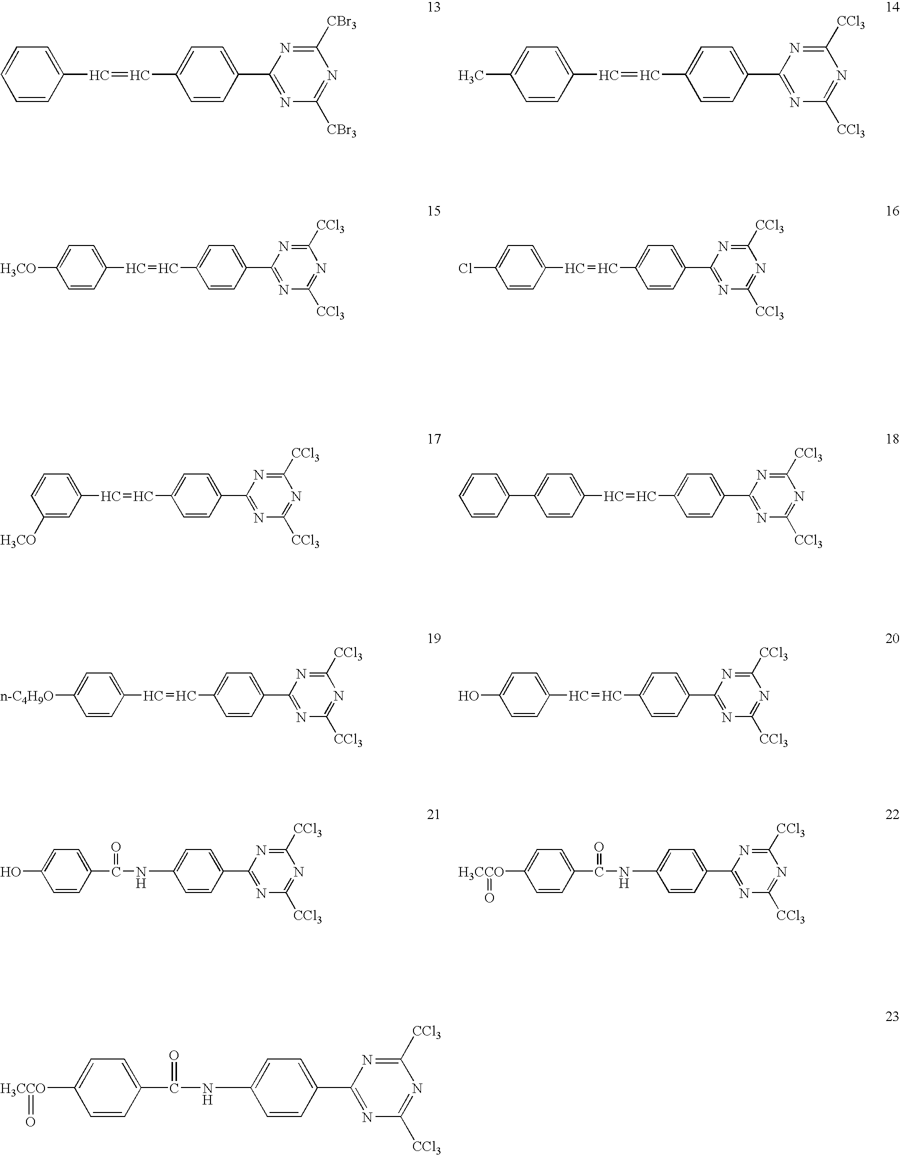

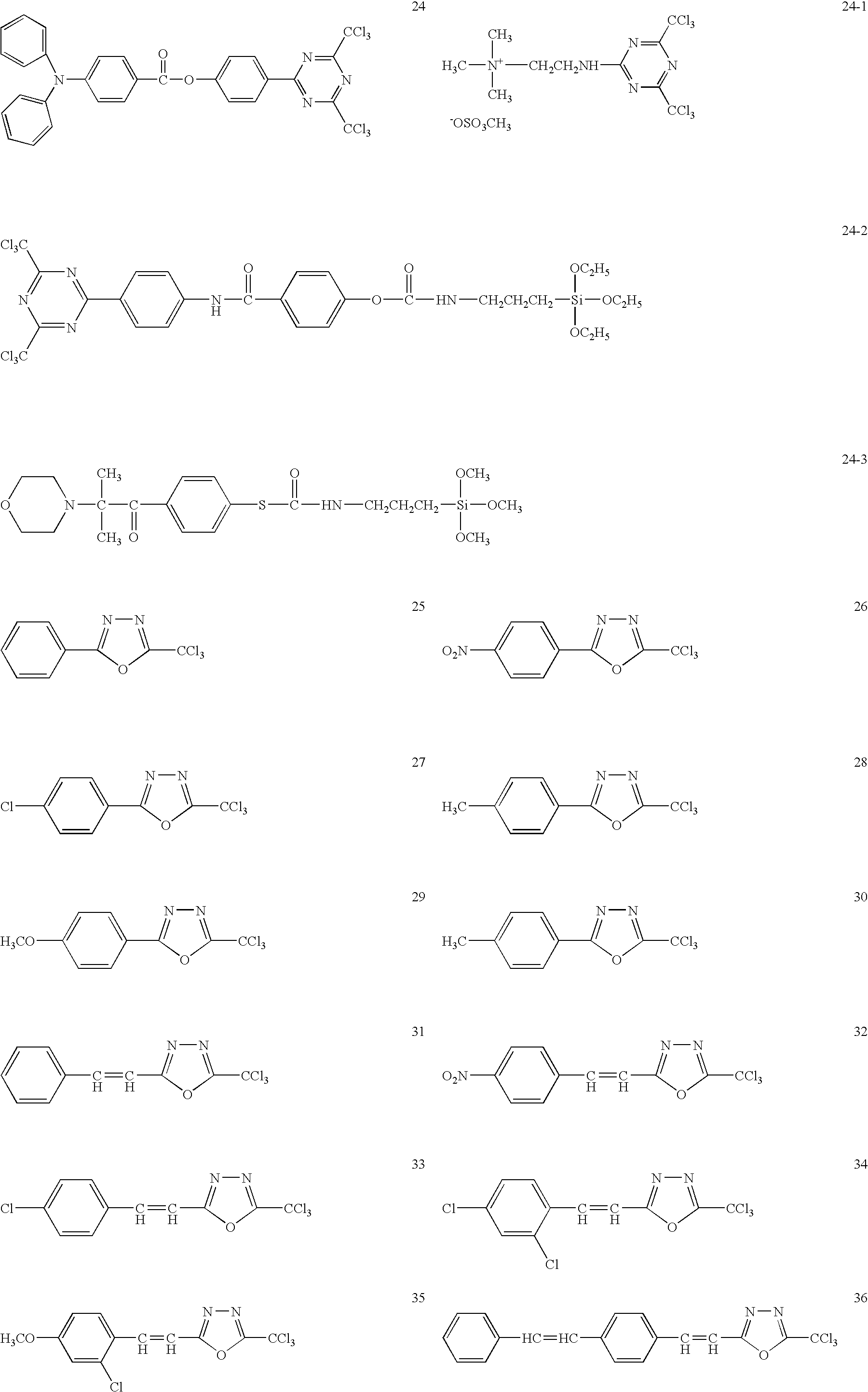

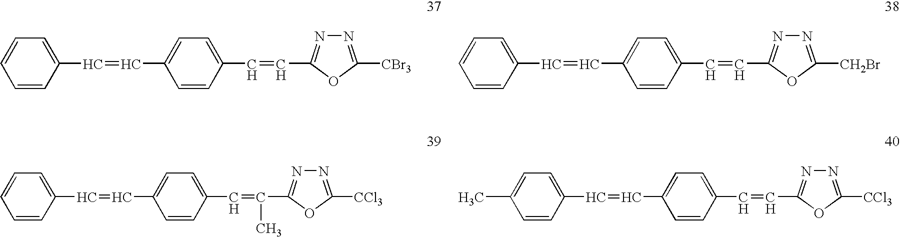

Examples of the inorganic complexes include bis(η⁵2,4-cyclopentadien-1-yl)-bis(2,6-difluoro-3-(1H-pyrrol-1-yl)phenyl)titanium.

Examples of the coumarins include 3-ketocoumarin.

Such an initiator may be used singly or in admixture.

A variety of examples are described in Saishin UV Koka Gijutsu (Latest UV Curing Technologies), published by Technical Information Institute Co., Ltd., page 159 (1991) and Kiyoshi Kato, Shigaisen Koka Shisutemu (Ultraviolet Ray Curing Systems), published by Sogo Gijutsu Center, pages 65 to 148 (1988) are useful in the invention.

With respect to commercially available photo radical polymerization initiators, KAYACURE Series as manufactured by Nippon Kayaku Co., Ltd. (for example, DETX-S, BP-100, BDMK, CTX, BMS, 2-FAQ, ABQ, CPTX, EPD, ITX, QTX, BTC, and MCA), IRGACURE Series as manufactured by Ciba Speciality Chemicals (for example, 651, 184, 500, 819, 907, 369, 1173, 1870, 2959, 4265, and 4263), ESACURE Series as manufactured by Sartmer Company Inc. (for example, KIP100F, KB1, EB3, BP, X33, KT046, KT37, KIP150, and TZT), and combinations thereof are enumerated as preferred examples.

The photopolymerization initiator is preferably used in an amount in the range of from 0.1 to 15 parts by weight, and more preferably from 1 to 10 parts by weight based on 100 parts by weight of the polyfunctional monomer.

<Photosensitizer>

In addition to the photopolymerization initiator, a photosensitizer may be used. Specific examples of the photosensitizer include n-butylamine, triethylamine, tri-n-butyl phosphine, Michler's ketone, and thioxanthone.

In addition, at least one auxiliary agent such as azide compounds, thiourea compounds, and mercapto compounds may be combined and used.

With respect to commercially available photosensitizers, there are enumerated KAYACURE Series as manufactured by Nippon Kayaku Co., Ltd. (for example, DMBI and EPA).

<Heat Initiator>

Examples of a heat initiator which can be used include organic or inorganic peroxides, and organic azo or diazo compounds.

Concretely, examples of the organic peroxides include benzoyl peroxide, halogen benzoyl peroxides, lauroyl peroxide, acetyl peroxide, dibutyl peroxide, cumene hydroperoxide, and butyl hydroperoxide; examples of the inorganic peroxides include hydrogen peroxide, ammonium persulfate, and potassium persulfate; examples of the azo compounds include 2,2′-azobis(isobutyronitrile), 2,2′-azobis(propionitrile), and 1,1′-azobis(cyclohexanecarbonitrile); and examples of the diazo compounds include diazoaminobenzene and p-nitrobenzene diazonium.

(Crosslinking Agent (Crosslinking Compound))

In the case where the monomer or polymer binder constituting the invention does not have hardening properties singly, required hardening properties can be imparted by blending a crosslinking compound. In particular, it is effective to contain the crosslinking compound in the low refractive index layer.

For example, in the case where the polymer main body contains a hydroxyl group, it is preferred to use various amino compounds as a hardening agent. The amino compound which is used as the crosslinking compound is, for example, a compound containing two or more in total of either one or both of a hydroxyalkylamino group and an alkoxyalkylamino group. Specific examples thereof include melamine based compounds, urea based compounds, benzoguanamine based compounds, and glycol uryl based compounds.

The melamine based compounds are generally known as a compound having a skeleton in which a nitrogen atom is bound to a triazine ring, and specific examples thereof include melamine, alkylated melamines, methylolmelamine, and alkoxylated methylmelamines. Above all, compounds containing two or more in total of either one or both of a methylol group and an alkoxylated methyl group in one molecule thereof are preferable. Concretely, methylolated melamine obtained by making melamine react with formaldehyde under a basic condition, alkoxylated methylmelamines, and derivatives thereof are preferable; and alkoxylated methylmelamines are especially preferable in view of the matter that in a hardenable resin composition, not only satisfactory storage stability is obtained, but also satisfactory reactivity is obtained. Furthermore, with respect to the methylolated melamine and alkoxylated methylmelamines, there are no particular limitations, and for example, a variety of resinous materials obtainable by a method as described in Plastic Material Course [8]: Urea.melamine Resins (published by Nikkan Kogyo Shimbun Ltd.) can be used.

Furthermore, as the urea compounds, in addition to urea, polymethylolated ureas and alkoxylated methylureas as a derivative thereof, and methylated urons and alkoxylated methylurons having an uron ring can be enumerated. With respect to the urea derivatives, a variety of resinous materials as described in the foregoing Urea.melamine Resins reference, etc. can also be used.

A proportion of the crosslinking agent to be used is preferably from 1 to 100 parts by weight, more preferably from 5 to 50 parts by weight, and further preferably from 10 to 40 parts by weight based on 100 parts by weight of the hardenable resin composition.

(Hardening Catalyst)

In the film of the invention, a hardening catalyst capable of generating a radical or an acid upon irradiation with ionizing radiations or heat can be used as the hardening catalyst for promoting hardening.

<Heat Acid Generator>

As one example of the optical film of the invention, the film can be hardened upon heating by a crosslinking reaction of a hydroxyl group of the fluorine-containing polymer and a hardening agent capable of crosslinking with this hydroxyl group. In this system, since the hardening is accelerated by an acid, it is desired to add an acidic substance in the hardenable resin composition. However, when a usual acid is added, the crosslinking reaction also proceeds in the coating solution, resulting in causing a fault (for example, unevenness and cissing). Accordingly, in order to make the storage stability and the hardening activity compatible with each other in the heat hardening system, it is more preferred to add a compound capable of generating an acid by heating as a hardening catalyst.

It is preferable that the hardening catalyst is a salt made of an acid and an organic base. Examples of the acid include organic acids such as sulfonic acids, phosphonic acids, and carboxylic acids; and inorganic acids such as sulfuric acid and phosphoric acid. From the viewpoint of compatibility with the polymer, organic acids are more preferable; sulfonic acids and phosphonic acids are further preferable; and sulfonic acids are the most preferable. Preferred examples of the sulfonic acids include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH), and nonafluorobutane-1-sulfonic acid (NFBS). All of these compounds can be preferably used. (Each of the expressions in the parentheses is an abbreviation.)

The hardening catalyst largely varies depending upon the basicity and boiling point of the organic base which is combined with the acid. The hardening catalyst which is preferably used in the invention will be described below from the respective viewpoints.

An organic base having a low basicity is high in acid generation efficiency at the time of heating and is preferable from the viewpoint of hardening activity. However, when the basicity is too low, the storage stability becomes insufficient. Accordingly, it is preferred to use an organic base having a proper basicity. When the basicity is expressed in terms of a pKa of a conjugated acid as an index, the pKa of the organic base which is used in the invention is required to be from 5.0 to 11.0, more preferably from 6.0 to 10.5, and further preferably from 6.5 to 10.0. With respect to the pKa value of the organic base, since values in an aqueous solution are described in The Chemical Handbook Basic Edition (Revised Version, 5th Edition, edited by The Chemical Society of Japan and published by Maruzen Co., Ltd.), Vol. 2, II, pages 334 to 340, it is possible to select an organic base having a proper pKa among them. Furthermore, it is possible to preferably use a compound having a proper pKa in view of the structure even when it is not described in the subject reference. Compounds having a proper pKa as described in the subject reference will be given in the following Table 1, but it should not be construed that the invention is limited thereto.

TABLE 1

| | | pKa |
|---|---|---|
| b-1 | N,N-Dimethylaniline | 5.1 |
| b-2 | Benzimidazole | 5.5 |
| b-3 | Pyridine | 5.7 |
| b-4 | 3-Methylpyridine | 5.8 |
| b-5 | 2,9-Dimethyl-1,10-phenanthroline | 5.9 |
| b-6 | 4,7-Dimethyl-1,10-phenanthroline | 5.9 |
| b-7 | 2-Methylpyridine | 6.1 |
| b-8 | 4-Methylpyridine | 6.1 |
| b-9 | 3-(N,N-Dimethylamino)pyridine | 6.5 |
| b-10 | 2,6-Dimethylpyridine | 7.0 |
| b-11 | Imidazole | 7.0 |
| b-12 | 2-Methyl imidazole | 7.6 |
| b-13 | N-Ethylmorpholine | 7.7 |
| b-14 | N-Methylmorpholine | 7.8 |
| b-15 | Bis(2-methoxyethyl)amine | 8.9 |
| b-16 | 2,2′-Iminodiethanol | 9.1 |
| b-17 | N,N-Dimethyl-2-aminoethanol | 9.5 |
| b-18 | Trimethylamine | 9.9 |
| b-19 | Triethylamine | 10.7 |

An organic base having a low boiling point is high in acid generation efficiency at the time of heating and is preferable from the viewpoint of hardening activity. Accordingly, it is preferred to use an organic base having a proper boiling point. The boiling point of the base is preferably not higher than 120° C., more preferably not higher than 80° C., and further preferably not higher than 70° C.

Examples of compounds which can be preferably used as the organic base in the invention will be given below, but it should not be construed that the invention is not limited thereto. Each of the expressions in the parentheses shows a boiling point.

b-3: pyridine (115° C.), b-14: 4-methylmorpholine (115° C.), b-20: diallylmethylamine (111° C.), b-19: triethylamine (88.8° C.), b-21: t-butylmethylamine (67 to 69° C.), b-22: dimethylisopropylamine (66° C.), b-23: diethylmethylamine (63 to 65° C.), b-24: dimethylethylamine (36 to 38° C.), b-18: trimethylamine (3 to 5° C.)

When used as the acid catalyst, the foregoing salt made of an acid and an organic salt may be isolated and provided for use. Alternatively, a solution obtained by mixing an acid and an organic salt to form a salt in the solution may be used. Furthermore, only one kind of each of an acid and an organic base may be used, and plural kinds of each of an acid and an organic base may be mixed and used. When an acid and an organic base are mixed and used, it is preferred to mix the acid and the organic base such that an equivalent ratio is preferably from 1/0.9 to 1/1.5, more preferably from 1/0.95 to 1/1.3, and further preferably from 1/1.0 to 1/1.1.

Examples of commercially available materials as the heat acid generator include CATALYST 4040, CATALYST 4050, CATALYST 600, CATALYST 602, CATALYST 500, and CATALYST 296-9, all of which are manufactured by Nihon Cytec Industries Inc.; and NACURE Series 155, 1051, 5076 and 4054J and block types thereof, for example, NACURE Series 2500, 5225, X49-110, 3525 and 4167, all of which are manufactured by King Industries, Inc.

A proportion of this heat acid generator to be used is preferably from 0.01 to 10 parts by weight, more preferably from 0.1 to 5 parts by weight, and further preferably from 0.2 to 3 parts by weight based on 100 parts by weight of the hardenable resin composition. When the addition amount falls within this range, not only the storage stability of the hardenable resin composition is satisfactory, but also the scar resistance of the coating film is satisfactory.

<Photosensitive Acid Generator and Photo Acid Generator>

In addition, the photo acid generator which can be used as the photopolymerization initiator will be hereunder described in detail.

Examples of the acid generator include known compounds such as photo initiators of photo cationic polymerization, photo decoloring agents of dyes, photo discoloring agents, and known acid generators which are used for microresists and the like, and mixtures thereof. Furthermore, examples of the acid generator include organic halogenated compounds, disulfone compounds, and onium compounds. Of these, specific examples of the organic halogenated compounds and disulfone compounds include compounds the same as those capable of generating a radical as described previously.

As the photosensitive acid generator, (1) a variety of onium salts such as iodonium salts, sulfonium salts, phosphonium salts, diazonium salts, ammonium salts, and pyridinium salts; (2) sulfone compounds such as β-ketoesters, β-sulfonylsulfone, and α-diazo compounds thereof; (3) sulfonic acid esters such as alkylsulfonic acid esters, haloalkylsulfonic acid esters, arylsulfonic acid esters, and iminosulfonates; (4) sulfonimide compounds; and (5) diazomethane compounds can be enumerated.

Examples of the onium compound include diazonium salts, ammonium salts, iminium salts, phosphonium salts, iodonium salts, sulfonium salts, arsonium salts, and selenonium salts. Above all, diazonium salts, iodonium salts, sulfonium salts, and iminium salts are preferable in view of photosensitivity to photopolymerization initiation, material stability of the compound, and so on. For example, compounds as described in paragraphs [0058] to [0059] of JP-A-2002-29162 are enumerated.

A proportion of the photosensitive acid generator to be used is preferably from 0.01 to 10 parts by weight, and more preferably from 0.1 to 5 parts by weight based on 100 parts by weight of the hardenable resin composition.

Besides, the contents as described in, for example, JP-A-2005-43876 can be employed as concrete compounds and method of use thereof.

In the optical film of the invention, it is preferable that the foregoing low refractive index layer can be formed by coating and that a coating solution for forming the low refractive index layer contains, as a film forming component, at least one translucent resin containing a functional group capable of undergoing hardening by ultraviolet rays (UV) and/or thermal hardening. The “translucent resin containing a functional group capable of undergoing hardening by ultraviolet rays (UV) and/or thermal hardening” as referred to herein is a translucent resin containing the foregoing photopolymerizable group, for example, a (meth)acryloyl group as the functional group capable of undergoing hardening by ultraviolet rays (UV) and a hydroxyl group capable of thermally reacting with the crosslinking agent as the functional group capable of undergoing thermal hardening. Suitable examples of such a translucent resin include the foregoing fluorine-containing copolymers and organosilane compounds.

Furthermore, in the optical film of the invention, it is more preferable that the foregoing coating solution for forming the low refractive index layer contains at least two kinds of translucent resins as the film forming component; that at least one translucent resin thereof contains a functional group capable of undergoing hardening by ultraviolet rays (UV); and that at least one translucent resin which is different from the former contains a functional group capable of undergoing thermal hardening. In addition thereto, it is further preferable that the foregoing coating solution for forming the low refractive index layer contains at least one polymerization initiator and at least one crosslinking agent capable of undergoing thermal hardening. Furthermore, in addition thereto, it is still further preferable that the low refractive index layer contains a hardening catalyst capable of promoting thermal hardening (as the polymerization initiator, the crosslinking agent capable of undergoing thermal hardening and the hardening catalyst for capable of promoting thermal hardening, those as described previously can be preferably used).

Moreover, in view of the scar resistance and costs, it is preferable that in the foregoing coating solution for forming the low refractive index layer, the a value obtained by dividing a total sum of a weight of the at least one translucent resin containing a functional capable being hardened by ultraviolet rays (UV) and a weight of the at least one polymerization initiator by a total sum of a weight of the at least one translucent resin capable of undergoing thermal hardening and a weight of the at least one crosslinking agent capable of undergoing thermal hardening is from 0.05 to 0.19. This value is more preferably from 0.10 to 0.19. What this value is less than 0.05 is not preferable in view of scar resistance. On the other hand, when this value exceeds 0.19, since the proportion of the UV hardening component becomes high, the addition of a process condition for enhancing the polymerization efficiency at the time of hardening with UV (for example, purge with nitrogen at the time of hardening with UV and an increase of the film surface temperature) becomes more necessary. An oxygen concentration at the time of hardening with UV due to purge with nitrogen is preferably not more than 1,000 ppm, more preferably not more than 500 ppm, further preferably not more than 100 ppm, and most preferably not more than 50 ppm. Furthermore, the film surface temperature at the time of hardening with UV is preferably 50° C. or higher, more preferably 70° C. or higher, and further preferably 90° C. or higher. When the temperature is excessively high, the support is softened, and handling (conveyance) deficiency is caused. Thus, the upper temperature is determined by this.

(Leveling Agent)

It is preferred to use a leveling agent in at least one hard coat layer of the invention for the purpose of improving surface properties (preventing unevenness). In addition, it is similarly preferred to use a leveling agent of every kind in the low refractive index layer of the invention for the purpose of preventing unevenness. Concretely, fluorine based leveling agents and silicone based leveling agents are preferable as the leveling agent. In particular, joint use of both a fluorine based leveling agent and a silicone based leveling agent is more preferable because an ability to prevent unevenness is high. Furthermore, it is more preferable that the leveling agent is used in all layers.

Furthermore, as the leveling agent, an oligomer or a polymer is more preferable than a low molecular weight compound. When the leveling agent is added, the leveling agent is quickly unevenly distributed on a surface of the coated liquid film and even after drying, is unevenly distributed on the surface as it stands. Thus, surface energy of the film of the hard coat layer or the low refractive index layer to which the leveling agent is added is lowered by the leveling agent.

Accordingly, from the viewpoint of preventing unevenness of the hard coat layer, it is preferable that the surface energy of the hard coat layer is low. The “surface energy” (γs^{v}, unit: mJ/m²; an “mN/m” unit is converted into an “mJ/m²” unit) of the hard coat layer as referred to herein is an energy reduced value of a surface tension of the antiglare hard coat layer as defined by a value γs^{v} (=γs^{d}+γs^{h}) which is the sum of γs^{d} and γs^{h} as determined from experimentally determined contact angles θ_{H2O} for pure water H₂O and θ_{CH2I2} for methylene iodide on the antiglare hard coat layer according to the following simultaneous equations (1) and (2) while referring to D. K. Owens, J. Appl. Polym. Sci., 13, 1741 (1969). A sample must be subjected to humidity control for a certain period of time under a prescribed temperature-humidity condition prior to the measurement. On this occasion, it is preferable that the temperature is in the range of from 20° C. to 27° C. and that the humidity is in the range of from 50 RH % to 65 RH %. The temperature-humidity time is preferably 2 hours or more.
(1+cos θH₂O)=2√ γ̅s^{d}(√ γ̅H₂O^{d}/γH₂O^{v})+2√ γ̅s^{d}(√ γ̅H₂O^{h}/γH₂O^{v}) (1)
(1+cos θCH₂I₂)=2√ γ̅s^{d}(√ γ̅CH₂I₂^{d}/γCH₂I₂^{v})+2√ γ̅s^{d}(√ γ̅CH₂I₂^{h}/γCH₂I₂^{v}) (2)

Here, γH₂O^{d}=21.8°, γH₂O^{h}=51.0°, γH₂O^{v}=72.8°, CH₂I₂^{d}=49.5°, γCH₂I₂^{h}=1.3°, CH₂I₂^{v}=50.8°

The surface energy of the hard coat layer is preferably in the range of not more than 45 mJ/m², more preferably from 20 to 45 mJ/m², and further preferably from 20 to 40 mJ/m². By regulating the surface energy of the hard coat layer at not more than 45 mJ/m², there is brought such an effect that unevenness of the hard coat layer is hardly generated.

However, in the case where an upper layer such as a low refractive index layer is further applied on the hard coat layer, it is preferable that the leveling agent is eluted into the upper layer. After dipping the hard coat layer in a solvent of a coating solution for the upper layer of the hard coat layer (for example, methyl ethyl ketone, methyl isobutyl ketone, toluene, and cyclohexanone) and washing away it, it is rather preferable that the surface energy of the hard coat layer is high. In this case, the surface energy is preferably from 35 to 70 mJ/m².

The fluorine based leveling agent which is preferable as the leveling agent of the hard coat layer will be hereunder described. The silicone based leveling agent will be described later.

As the fluorine based leveling agent, a polymer containing a fluoro aliphatic group is preferable. In addition, polymers containing a repeating unit (polymerization unit) corresponding to the following monomer (i); and acrylic resins or methacrylic resins containing a repeating unit (polymerization unit) corresponding to the following monomer (i) and a repeating unit (polymerization unit) corresponding to the following monomer (ii), or copolymers thereof with a vinyl based monomer copolymerizable therewith are useful. Such a monomer, monomers as described in Polymer Handbook, Second Edition, edited by J. Brandrup and published by Wiley Interscience (1975), Chapter 2, pages 1 to 483 can be used.

Specific examples thereof include compounds containing one addition polymerizable unsaturated bond, which are selected from acrylic acid, methacrylic acid, acrylic esters, methacrylic esters, acrylamides, methacrylamides, allyl compounds, vinyl ethers, and vinyl esters.
(i) Fluoro aliphatic group-containing monomer represented by the following formula (A):

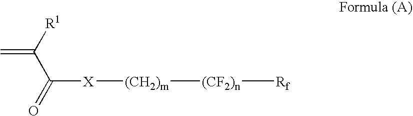

In the formula (A), R¹ represents a hydrogen atom, a halogen atom, or a methyl group; and preferably a hydrogen atom or a methyl group. X represents an oxygen atom, a sulfur atom, or —N(R¹²)—; preferably an oxygen atom or —N(R²)—; and more preferably an oxygen atom. R¹² represents a hydrogen atom or an optionally substituted alkyl group having from 1 to 8 carbon atoms; preferably a hydrogen atom or an alkyl group having from 1 to 4 carbon atoms; and more preferably a hydrogen atom or a methyl group. R_{f} represents —CF₃ or —CF₂H.

In the formula (A), m represents an integer of from 1 to 6, preferably from 1 to 3, and more preferably 1.

In the formula (A), n represents an integer of from 1 to 11, preferably from 1 to 9, and more preferably from 1 to 6. R_{f} is preferably —CF₂H.

Furthermore, two or more kinds of polymerization units derived from the fluoro aliphatic group-containing monomer represented by the formula (A) may be contained as a constitutional component in the fluorine based polymer.
(ii) Monomer represented the following formula (B) which is copolymerizable with (i):

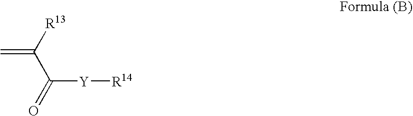

In the formula (B), R¹³ represents a hydrogen atom, a halogen atom, or a methyl group; and preferably a hydrogen atom or a methyl group. Y represents an oxygen atom, a sulfur atom, or —N(R¹⁵)—; preferably an oxygen atom or —N(R¹⁵)—; and more preferably an oxygen atom. R¹⁵ represents a hydrogen atom or an alkyl group having from 1 to 8 carbon atoms; preferably a hydrogen atom or an alkyl group having from 1 to 4 carbon atoms; and more preferably a hydrogen atom or a methyl group.

R¹⁴ represents an optionally substituted linear, branched or cyclic alkyl group having from 1 to 60 carbon atoms or an optionally substituted aromatic group (for example, a phenyl group and a naphthyl group). The alkyl group may contain a poly(alkylene oxy) group. In addition, the alkyl group is preferably a linear, branched or cyclic alkyl group having from 1 to 20 carbon atoms, and extremely preferably a linear or branched alkyl group having from 1 to 10 carbon atoms. An amount of the fluoro aliphatic group-containing monomer represented by the foregoing formula (A) which is used for the production of a preferred fluorine based polymer is in the range of 10% by weight or more, preferably 50% by weight or more, more preferably from 70 to 100% by weight, and further preferably from 80 to 100% by weight based on the whole amount of the monomers of the fluorine based polymer.

Examples of a specific structure of the preferred fluorine based polymer will be given below, but it should not be construed that the invention is limited thereto. Incidentally, the numeral means a molar fraction of each monomer component; and Mw represents a weight average molecular weight.

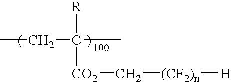

| | R | n | Mw |
|---|---|---|---|
| FP-1 | H | 4 | 8000 |
| FP-2 | H | 4 | 16000 |
| FP-3 | H | 4 | 33000 |
| FP-4 | CH₃ | 4 | 12000 |
| FP-5 | CH₃ | 4 | 28000 |
| FP-6 | H | 6 | 8000 |
| FP-7 | H | 6 | 14000 |
| FP-8 | H | 6 | 29000 |
| FP-9 | CH₃ | 6 | 10000 |
| FP-10 | CH₃ | 6 | 21000 |
| FP-11 | H | 8 | 4000 |
| FP-12 | H | 8 | 16000 |
| FP-13 | H | 8 | 31000 |
| FP-14 | CH₃ | 8 | 3000 |
| FP-15 | CH₃ | 8 | 10000 |
| FP-16 | CH₃ | 8 | 27000 |
| FP-17 | H | 10 | 5000 |
| FP-18 | H | 10 | 11000 |
| FP-19 | CH₃ | 10 | 4500 |
| FP-20 | CH₃ | 10 | 12000 |
| FP-21 | H | 12 | 5000 |
| FP-22 | H | 12 | 10000 |
| FP-23 | CH₃ | 12 | 5500 |
| FP-24 | CH₃ | 12 | 12000 |

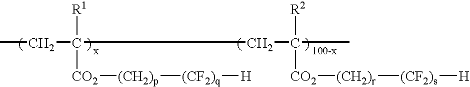

| | x | R¹ | p | q | R² | r | s | Mw |
|---|---|---|---|---|---|---|---|---|
| FP-25 | 50 | H | 1 | 4 | CH₃ | 1 | 4 | 10000 |
| FP-26 | 40 | H | 1 | 4 | H | 1 | 6 | 14000 |
| FP-27 | 60 | H | 1 | 4 | CH₃ | 1 | 6 | 21000 |
| FP-28 | 10 | H | 1 | 4 | H | 1 | 8 | 11000 |
| FP-29 | 40 | H | 1 | 4 | H | 1 | 8 | 16000 |
| FP-30 | 20 | H | 1 | 4 | CH₃ | 1 | 8 | 8000 |
| FP-31 | 10 | CH₃ | 1 | 4 | CH₃ | 1 | 8 | 7000 |
| FP-32 | 50 | H | 1 | 6 | CH₃ | 1 | 6 | 12000 |
| FP-33 | 50 | H | 1 | 6 | CH₃ | 1 | 6 | 22000 |
| FP-34 | 30 | H | 1 | 6 | CH₃ | 1 | 6 | 5000 |
| FP-35 | 40 | CH₃ | 1 | 6 | H | 3 | 6 | 8000 |
| FP-36 | 10 | H | 1 | 6 | H | 1 | 8 | 7000 |
| FP-37 | 30 | H | 1 | 6 | H | 1 | 8 | 17000 |
| FP-38 | 50 | H | 1 | 6 | H | 1 | 8 | 16000 |
| FP-39 | 50 | CH₃ | 1 | 6 | H | 3 | 8 | 19000 |
| FP-40 | 50 | H | 1 | 8 | CH₃ | 1 | 8 | 5000 |
| FP-41 | 80 | H | 1 | 8 | CH₃ | 1 | 8 | 10000 |
| FP-42 | 50 | CH₃ | 1 | 8 | H | 3 | 8 | 14000 |
| FP-43 | 90 | H | 1 | 8 | CH₃ | 3 | 8 | 9000 |
| FP-44 | 70 | H | 1 | 8 | H | 1 | 10 | 7000 |
| FP-45 | 90 | H | 1 | 8 | H | 3 | 10 | 12000 |
| FP-46 | 50 | H | 1 | 8 | H | 1 | 12 | 10000 |
| FP-47 | 70 | H | 1 | 8 | CH₃ | 3 | 12 | 8000 |

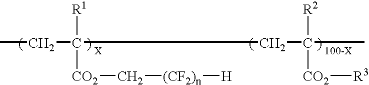

| | x | R¹ | n | R² | R³ | Mw |
|---|---|---|---|---|---|---|
| FP-48 | 90 | H | 6 | H | C₂H₅ | 9000 |
| FP-49 | 80 | H | 6 | H | C₂H₅ | 24000 |
| FP-50 | 60 | H | 6 | H | C₂H₅ | 36000 |
| FP-51 | 90 | H | 6 | H | C₄H₉(n) | 15000 |
| FP-52 | 80 | H | 6 | H | C₄H₉(n) | 17000 |
| FP-53 | 60 | H | 6 | H | C₄H₉(n) | 10000 |
| FP-54 | 90 | H | 6 | H | C₄H₉(iso) | 16000 |
| FP-55 | 80 | H | 6 | H | C₄H₉(iso) | 18000 |
| FP-56 | 60 | H | 6 | H | C₄H₉(iso) | 21000 |
| FP-57 | 90 | H | 6 | H | C₄H₉(t) | 14000 |
| FP-58 | 80 | H | 6 | H | C₄H₉(t) | 12000 |
| FP-59 | 60 | H | 6 | H | C₄H₉(t) | 13000 |
| FP-60 | 90 | H | 6 | H | C₆H₁₃(n) | 10000 |
| FP-61 | 80 | H | 6 | H | C₆H₁₃(n) | 8000 |
| FP-62 | 60 | H | 6 | H | C₆H₁₃(n) | 12000 |
| FP-63 | 80 | H | 4 | H | C₂H₅ | 25000 |
| FP-64 | 80 | H | 4 | H | C₄H₉(n) | 32000 |
| FP-65 | 80 | H | 4 | H | C₄H₉(iso) | 28000 |
| FP-66 | 80 | H | 4 | H | C₄H₉(t) | 25000 |
| FP-67 | 80 | H | 4 | H | C₆H₁₃(n) | 20000 |
| FP-68 | 80 | H | 8 | H | C₂H₅ | 5000 |
| FP-69 | 80 | H | 8 | H | C₄H₉(n) | 6000 |
| FP-70 | 80 | H | 8 | H | C₄H₉(iso) | 5000 |
| FP-71 | 80 | H | 8 | H | C₄H₉(t) | 7000 |
| FP-72 | 80 | H | 8 | H | C₆H₁₃(n) | 5000 |
| FP-78 | 80 | H | 4 | CH₃ | C₂H₅ | 12000 |
| FP-79 | 80 | H | 4 | CH₃ | C₄H₉(n) | 14000 |
| FP-80 | 80 | H | 4 | CH₃ | C₄H₉(iso) | 20000 |
| FP-81 | 80 | H | 4 | CH₃ | C₄H₉(t) | 22000 |
| FP-82 | 80 | H | 4 | CH₃ | C₆H₁₃(n) | 18000 |
| FP-83 | 80 | CH₃ | 4 | CH₃ | C₂H₅ | 6000 |
| FP-84 | 80 | CH₃ | 4 | CH₃ | C₄H₉(n) | 8000 |
| FP-85 | 80 | CH₃ | 4 | CH₃ | C₄H₉(iso) | 7000 |
| FP-86 | 80 | CH₃ | 4 | CH₃ | C₄H₉(t) | 12000 |
| FP-87 | 80 | CH₃ | 4 | CH₃ | C6H13(n) | 5000 |

An amount of the polymerization unit of the fluoro aliphatic group-containing monomer constituting the fluorine based polymer is preferably more than 10% by weight, and more preferably from 50 to 100% by weight. In the case of attaching importance to the viewpoint of preventing unevenness of the hard coat layer, the amount of the polymerization unit of the fluoro aliphatic group-containing monomer constituting the fluorine based polymer is most preferably from 75 to 100% by weight; and in the case of coating a low refractive index layer on the hard coat layer, it is most preferably from 50 to 75% by weight (as described in terms of the whole of polymerization units constituting the fluorine based polymer).

Next, the silicone based leveling agent will be described.

Examples of the silicone based leveling agent include polydimethylsiloxanes in which a side chain thereof or a terminal end of a principal chain thereof is modified with various substituents such as oligomers of ethylene glycol, propylene glycol, etc., and specific examples thereof include KF-96 and X-22-945, all of which are manufactured by Shin-Etsu Chemical Co., Ltd. Besides, nonionic surfactants in which a hydrophobic group thereof is constituted of a dimethyl polysiloxane and a hydrophilic group thereof is constituted of a polyoxyalkylene can be preferably used.

Specific examples of such a nonionic surfactant include silicone surfactants as manufactured by Nippon Unicar Company Limited, including SILWET L-77, SILWET L-720, SILWET L-7001, SILWET L-7002, SILWET L-7604, SILWET Y-7006, SILWET FZ-2101, SILWET FZ-2104, SILWET FZ-2105, SILWET 2110, SILWET FZ-2118, SILWET FZ-2120, SILWET F-2122, SILWET F-2123, SILWET FZ-2130, SILWET FZ-2154, SILWET FZ-2161, SILWET FZ-2162, SILWET FZ-2163, SILWET FZ-2164, SILWET FZ-2166, SILWET FZ-2191, SUPERSILWET SS-2801, SUPERSILWET SS-2802, SUPERSILWET SS-2803, SUPERSILWET SS-2804, and SUPERSILWET SS-2805.

Furthermore, as a preferred structure of the nonionic surfactant which is constituted of a dimethyl polysiloxane as a hydrophobic group and a polyoxyalkylene as a hydrophilic group, a linear block polymer in which the dimethyl polysiloxane structure segment and the polyoxyalkylene chain are alternately repeatedly bound to each other is preferable, and JP-A-6-49486 can be made for reference.

Specific examples thereof include ABN SILWET FZ-2203, ABN SILWET FZ-2207, and ABN SILWET FZ-2208, all of which are manufactured by Shin-Etsu Chemical Co., Ltd. The addition amount of the fluorine-containing leveling agent or silicone based leveling agent is preferably from 0.001% by weight to 1.0% by weight, and more preferably from 0.01% by weight to 0.2% by weight based on the coating solution.

(Solvent of Coating Solution of Low Refractive Index Layer)

In order to suppress drying unevenness of the low refractive index layer, a solvent of the coating solution of the low refractive index layer of the optical film of the invention contains a low boiling solvent having a boiling point of not higher than 120° C. in an amount of from 50% by weight to 100% by weight, preferably from 70% by weight to 100% by weight, and more preferably from 90% by weight to 100% by weight based on the total weight of solvents of the coating solution of the low refractive index layer. By changing the solvent composition of the low refractive index layer of a sample of the invention as described later, this effect could be confirmed by evaluation of surface properties of the low refractive index layer. As a concrete solvent of the coating solution, methyl ethyl ketone, methyl isobutyl ketone, and toluene, which are good in solubility against the fluorine-containing polymer in the low refractive index layer, are a representative example.

(Thickener of Hard Coat Layer)

In the hard coat layer, a thickener may be used for the purpose of adjusting the viscosity of the coating solution.

By thickening, the sedimentation of the particle to be contained can be suppressed, or an effect for preventing unevenness can be expected. The “thickener” as referred to herein means a substance capable of increasing the viscosity of the solution upon addition of the same. A degree of the increase of the viscosity of the coating solution by the addition of the thickener is preferably from 0.05 to 50 cP, more preferably from 1 to 50 cP, and most preferably from 2 to 50 cP.

It is preferable that a high molecular polymer which is used as the thickener does not substantially contain a fluorine atom and/or a silicon atom. The term “substantially” as referred to herein means that the content of the fluorine atom and/or the silicon atom in the high molecular polymer is not more than 0.1% by weight, and preferably not more than 0.01% by weight.

As such a thickener, a high molecular weight polymer is preferable. Specific examples thereof will be given below, but it should not be construed that the invention is limited thereto.

Polyacrylic esters

Polymethacrylic esters

Polyvinyl acetate

Polyvinyl propionate

Polyvinyl butyrate

Polyvinyl butyral

Polyvinyl formal

Polyvinyl acetal

Polyvinyl propanal

Polyvinyl hexanal

Polyvinylpyrrolidone

Cellulose acetate

Cellulose propionate

Cellulose acetate butyrate

Of these, polymethacrylic esters (specifically polymethyl methacrylate and polyethyl methacrylate), polyvinyl acetate, polyvinyl propionate, cellulose propionate, and cellulose acetate butyrate are especially preferable.

Furthermore, a weight average molecular weight thereof is preferably from 100,000 to 1,000,000.

Besides, there can also be used known viscosity adjusters and thixotropic agents such as smectite, fluorotetrasilicomica, bentonite, silica, montmorillonite, and poly(sodium acrylate) as described in JP-A-8-325491; and ethyl cellulose, polyacrylic acid, and organic clays as described in JP-A-10-219136.

[Transparent Support]

The support of the film of the invention is not particularly limited, and examples thereof include transparent resin films, transparent resin plates, transparent resin sheets, and transparent glasses. Examples of the transparent resin film include cellulose acylate films (for example, a cellulose triacetate film (refractive index: 1.48), a cellulose diacetate film, a cellulose acetate butyrate film, and a cellulose acetate propionate film), polyethylene terephthalate films, polyethersulfone films, polyacrylic resin films, polyurethane based resin films, polyester films, polycarbonate films, polysulfone films, polyether films, polymethyl pentene films, polyetherketone films, (meth)acrylonitrile films, polyolefins, and polymers having an alicyclic structure (for example, norbornene based resins (for example, “ARTON” which is a trade name of JSR Corporation) and amorphous polyolefins (for example, “ZEONEX” which is a trade name of Zeon Corporation)). Of these, triacetyl cellulose, polyethylene terephthalate, and polymers having an alicyclic structure are preferable; and triacetyl cellulose is especially preferable.

A thickness of the support which can be employed is usually from approximately 25 μm to 1,000 μm, preferably from 25 μm to 250 μm, and more preferably from 30 μm to 90 μm.

Though a width of the support is arbitrary, in view of handling, yield and productivity, it is usually from 100 to 5,000 mm, preferably from 800 to 3,000 mm, and more preferably from 1,000 to 2,000 mm. The support can be dealt in a longitudinal state of a rolled form, and a length thereof is usually from 100 m to 5,000 m, and preferably from 500 m to 3,000 m.

It is preferable that the surface of the support is smooth. A value of an average roughness Ra is preferably not more than 1 μm, more preferably from 0.0001 to 0.5 μm, and further preferably from 0.001 to 0.1 μm.

<Cellulose Acylate Film>

Among the foregoing various films, a cellulose acylate film which is high in transparency, optically small in birefringence and easy for manufacturing and which is generally used as a protective film of a polarizing plate is preferable.

With respect to the cellulose acylate film, for the purpose of improving the dynamic characteristic, transparency, flatness, and so on, various improvement technologies are known, and a technology as described in Journal of Technical Disclosure No. 2001-1745 can be employed as a known technology for the film of the invention.

In the invention, among the cellulose acylate films, a cellulose triacetate film is especially preferable, and it is preferred to use cellulose acetate having an acetylation degree of from 59.0 to 61.5% for the cellulose acylate film. The “acetylation degree” as referred to herein means the amount of bound acetic acid per unit weight of cellulose. The acetylation degree follows the measurement and calculation of the acetylation degree in ASTM D-817-91 (testing method for cellulose acetate, etc.).

A viscosity average polymerization degree (DP) of the cellulose acylate is preferably 250 or more, and more preferably 290 or more.

Furthermore, in the cellulose acylate which is used in the invention, it is preferable that a value of Mw/Mn by gel permeation chromatography (Mm: weight average molecular weight, Mn: number average molecular weight) is closed to 1.0, in other words, the molecular weight distribution is narrow. Concretely, the value of Mw/Mn is preferably from 1.0 to 1.7, more preferably from 1.3 to 1.65, and most preferably from 1.4 to 1.6.

In general, the hydroxyl groups at the 2-, 3- and 6-positions of the cellulose acylate are not evenly distributed every ⅓ of the degree of substitution of the whole, but the degree of substitution of the hydroxyl group at the 6-position tends to become small. In the invention, it is preferable that the degree of substitution of the hydroxyl group at the 6-position of the cellulose acylate is higher than that at the 2-position and 3-position.

The hydroxyl group at the 6-position is preferably substituted with an acyl group to an extent of 32% or more, more preferably 33% or more, and especially preferably 34% or more of the degree of substitution of the whole. In addition, it is preferable that the degree of substitution of the acyl group at the 6-position of the cellulose acylate is 0.88 or more. The hydroxyl group at the 6-position may be substituted with an acyl group having 3 or more carbon atoms, such as a propionyl group, a butyroyl group, a valeroyl group, a benzoyl group, and an acryloyl group, in addition to the acetyl group. The degree of substitution at each of the positions can be measured according to NMR.

In the invention, cellulose acetate obtained by methods as described in [Examples] [Synthesis Example 1] in paragraphs [0043] to [0044], [Synthesis Example 2] in paragraphs [0048] to [0049] and [Synthesis Example 3] in paragraphs [0051] to [0052] of JP-A-11-5851 can be used.

For the purpose of improving mechanical physical properties or improving a drying rate after casting in the film manufacturing, a plasticizer can be added in the cellulose acylate film. As the plasticizer, phosphoric acid esters or carboxylic acid esters are useful. Examples of the phosphoric acid ester include triphenyl phosphate (TPP), diphenylbiphenyl phosphate, and tricresyl phosphate (TCP). As the carboxylic acid ester, phthalic acid esters and citric acid esters are representative. Examples of the phthalic acid ester include dimethyl phthalate (DMP), diethyl phthalate (DEP), dibutyl phthalate (DBP), dioctyl phthalate (DOP), diphenyl phthalate (DPP), dicyclohexyl phthalate (DCyP), and diethylhexyl phthalate (DEHP). Examples of the citric acid ester include triethyl O-acetylcitrate (OACTE), tributyl O-acetylcitrate (OACTB), and tricyclohexyl O-acetylcitrate (OACTCy). Examples of other carboxylic acid esters include butyl oleate, methylacetyl licinolate, dibutyl sebacate, and various trimellitic acid esters. Above all, phthalic acid based plasticizers and citric acid ester based plasticizers are preferably used. DEP, DPP and OACTCy are especially preferable.

The addition amount of the plasticizer is preferably from 0.1 to 25% by weight, more preferably from 1 to 20% by weight, and most preferably from 3 to 15% by weight of the amount of the cellulose acylate.

[Characteristics of Optical Film]

In view of antifouling properties, a contact angle of the surface of the optical film of the invention against pure water as measured under an environment at 25° C. and 60% RH is preferably 90° or more, more preferably 95° or more, and especially preferably 100° or more. Furthermore, a change of the contact angle before and after a saponification treatment (as described later) which is required at the time of forming a polarizing plate is preferably not more than 5°, more preferably not more than 3°, and most preferably not more than 1°.

In view of dustproof properties, it is preferable that the optical film of the invention has a quantity of electric charges due to vertical detachment against polyethylene terephthalate as measured under an environment at 25° C. and 60% RH of from −500 (picocoulomb)/cm² to +500 pc (picocoulomb)/cm². The quantity of electric charges due to vertical detachment is preferably from −200 (picocoulomb)/cm² to +200 pc (picocoulomb)/cm², and more preferably from −100 (picocoulomb)/cm² to +100 pc (picocoulomb)/cm². Incidentally, the quantity of electric charges due to vertical detachment is as follows.

A measurement sample is previously allowed to stand under an environment at 25° C. and 60% RH for 2 hours. A measurement unit is composed of a table for placing the measurement sample thereon and a head capable of holding a counterpart film and repeating contact bonding of the measurement sample from the upper side and detachment, and polyethylene terephthalate is installed in this head. After destaticizing the measurement portion, contact bonding of the measurement sample to the head and detachment are repeated. A value of the quantity of electric charges at the time of the first detachment and a value of the quantity of electric charges at the time of the fifth detachment are read and averaged. The sample is changed, and the same operations are repeated with respect to three samples. A value as averaged with respect to all the samples is defined as the quantity of electric charges due to vertical detachment.

Furthermore, in the case of an optical film in which at least one of the constitutional materials of the low refractive index layer is made of a fluorine-containing material, in order to make the quantity of electric charges due to vertical detachment fall within the foregoing preferred range, a photoelectron spectral intensity ratio F/C is from 0.5 to 5, preferably from 0.5 to 3, and more preferably from 0.5 to 2. Furthermore, for adjusting the quantity of electric charges due to vertical detachment, it is preferred to contain silicon with high surface orientation properties likewise fluorine. As a result, the photoelectron spectral intensity ratio Si/C is from 0.05 to 0.5, preferably from 0.1 to 0.5, and more preferably from 0.2 to 0.5. Incidentally, F/C (=F₁ₛ/C₁ₛ) and Si/C (=Si₂ₚ/C₁ₛ) are values measured as follows.

Photoelectron spectra Si₂ₚ, F₁ₛ and C₁ₛ of the outermost surface of the optical film were measured by ESCA-3400, manufactured by Shimadzu Corporation (vacuum degree: 1×10⁻⁵ Pa, X-ray source: target Mg, voltage: 12 kV, current: 20 mA).

In addition, for the purpose of strengthening the dustproof properties, it is recommended to regulate the optical film of the invention so as to have a surface resistivity value of less than 1×10¹¹ Ω/□, preferably less than 1×10¹⁰ Ω/□, and more preferably less than 1×10⁹ Ω/□. Incidentally, a measurement method of the surface resistivity value will be described later. In order to impart conductivity to the optical film of the invention, a variety of conductive particles can be used. It is preferable that the conductive particle is formed of a metal oxide or nitride. Examples of the metal oxide or nitride include tin oxide, indium oxide, zinc oxide, and titanium nitride. Of these, tin oxide and indium oxide are especially preferable. The conductive inorganic particle contains, as the major component, such a metal oxide or nitride and can further contain other element. The “major component” as referred to herein means a component having the highest content (% by weight) among the components which constitute the particle. Examples of other element include Ti, Zr, Sn, Sb, Cu, Fe, Mn, Pb, Cd, As, Cr, Hg, Zn, Al, Mg, Si, P, S, B, Nb, In, V, and halogen atoms. For the purpose of enhancing the conductivity of tin oxide and indium oxide, it is preferred to use Sb, P, B, Nb, In, V, or a halogen atom. Tin oxide containing Sb (ATO) and indium oxide containing Sn (ITO) are especially preferable. A proportion of Sb in ATO is preferably from 3 to 20% by weight; and a proportion of Sn in ITO is preferably from 5 to 20% by weight.

A primary particle of the conductive inorganic particle which is used for an antistatic layer preferably has an average particle size of from 1 to 150 nm, more preferably from 5 to 100 nm, and most preferably from 5 to 70 nm. The conductive inorganic particle in the antistatic layer to be formed has an average particle size of from 1 to 200 nm, preferably from 5 to 150 nm, more preferably from 10 to 100 nm, and most preferably from 10 to 80 nm. The average particle size of the conductive inorganic particle is an average particle size expecting the weight of the particle as a weight and can be measured by a light scattering method or from an electron microscopic photograph.

The conductive inorganic particle preferably has a specific surface area of from 10 to 400 m²/g, more preferably from 20 to 200 m²/g, and most preferably from 30 to 150 m²/g.

The conductive inorganic particle may be subjected to a surface treatment. The surface treatment is carried out by using an inorganic compound or an organic compound. Examples of the inorganic compound which is used for the surface treatment include alumina and silica. A silica treatment is especially preferable. Examples of the organic compound which is used for the surface treatment include polyols, alkanolamines, stearic acid, silane coupling agents, and titanate coupling agents. Of these, silane coupling agents are the most preferable. The surface treatment may be carried out by combining two or more kinds of surface treatments.

It is preferable that the shape of the conductive inorganic particle is a rice grain form, a spherical form, a cubic form, a spindle-like shape, or an amorphous form.

Two or more kinds of conductive particles may be used together within a specific layer or as a film. A proportion of the conductive inorganic particle in the antistatic layer is preferably from 20 to 90% by weight, more preferably from 25 to 85% by weight, and further preferably from 30 to 80% by weight. Furthermore, the conductive inorganic particle can be used in a state of a dispersion for the formation of an antistatic layer.

With respect to the measurement method of the surface resistivity value, a sample film is previously allowed to stand under an environment at 25° C. and 60% RH for 2 hours or more. Thereafter, a surface resistivity of the side of the coating layer was measured by using a megger/micro ammeter “TR8601” (manufactured by Advantest Corporation).

In view of improving the scar resistance (preventing stress concentration), the optical film of the invention preferably has a dynamic friction coefficient of not more than 0.3, more preferably not more than 0.2, and further preferably not more than 0.1. A measurement method of the dynamic friction coefficient is as follows.

A measurement sample is previously allowed to stand under an environment at 25° C. and 60% RH for 2 hours or more. Thereafter, a value measured by using a 5 mmφ stainless steel ball under a load of 100 g at a rate of 60 cm/min by a dynamic friction analyzer, HEIDON-14 was used.

In the optical film of the invention, in view of firmness of black color at the time of black display under a bright room environment and improvement of contrast in a bright room, it is preferable that when an average value of a 5° regular reflectance and an average value of an integrated reflectance in a wavelength region of from 450 nm and 650 nm are defined as A and B, respectively, B is not more than 3% and that (B−A) is not more than 1.5%. B is more preferably not more than 2%, and further preferably not more than 1%. Furthermore, (B−A) is more preferably not more than 1%, and further preferably not more than 0.5%. The average values of the 5° regular reflectance and the integrated reflectance are measured as follows.

With respect to the measurement of mirror reflectance, by using a spectrophotometer “V-550” (manufactured by JASCO Corporation) having an adaptor “ARV-474” installed therein, a mirror reflectance of an outgoing angle of −5° at an incident angle of 5° was measured in a wavelength region of from 380 to 780 nm, and an average mirror reflectance at from 450 to 650 nm was calculated. With respect to the measurement of integrated reflectance, by using a spectrophotometer “V-550” (manufactured by JASCO Corporation) having an adaptor “ARV-471” installed therein, an integrated reflectance at an incident angle of 5° was measured in a wavelength region of from 380 to 780 nm, and an average integrated reflectance at from 450 to 650 nm was calculated.

[Preparation Method of Optical Film]

Though the optical film of the invention can be formed by the following method, it should not be construed that the invention is limited thereto.

(Preparation of Coating Solution)

First of all, a coating solution containing components for forming each layer is prepared. On that occasion, by minimizing the amount of volatilization of a solvent, it is possible to suppress an increase of the water content in the coating solution. The water content in the coating solution is preferably not more than 5%, and more preferably not more than 2%. Suppression of the amount of volatilization of the solvent is achieved by, for example, improving tightness at the time of stirring after charging the respective raw materials in a tank and minimizing an air contact area of the coating solution at the time of liquid transfer works. Furthermore, a measure for lowering the water content in the coating solution during coating or before or after coating may be provided.

(Filtration)

It is preferable that the coating solution which is used for coating is filtered prior to coating. With respect to a filter for the filtration, it is preferred to use a filter having a pore size as small as possible within the range in which the components in the coating solution are not removed. For the filtration, a filter having an absolute filtration accuracy of from 0.1 to 50 μm is used, and a filter having an absolute filtration accuracy of from 0.1 to 40 μm is preferably used. The filter preferably has a thickness of from 0.1 to 10 mm, and more preferably from 0.2 to 2 mm. In that case, the filtration is preferably carried out under a filtration pressure of not more than 1.5 MPa, more preferably not more than 1.0 MPa, and further preferably not more than 0.2 MPa.

A filtration filter member is not particularly limited so far as it does not influence the coating solution.

Furthermore, it is also preferable that the filtered coating solution is ultrasonically dispersed just before coating, thereby assisting defoaming and dispersing and holding of the dispersion.

(Treatment Before Coating)

It is preferable that the support which is used in the invention is subjected to a heating treatment for correcting the base deformation prior to coating, or a surface treatment for improving the coating properties or improving the adhesion to an applied layer. Specific examples of the surface treatment include a corona discharge treatment, a glow discharge treatment, a flame treatment, an acid treatment, an alkaline treatment, and an ultraviolet ray irradiation treatment. Furthermore, it is also preferably utilized to provide an undercoat layer as described in JP-A-7-333433.

In addition, examples of a dust removal method which is employed in a dust removal process as a process prior to coating include dry dust removal methods such as a method of pressing a non-woven fabric, a blade, etc, onto the film surface as described in JP-A-59-150571; a method of blowing air with high cleanliness at a high speed to separate deposits from the film surface and sucking the separated deposits by an adjacent suction opening as described in JP-A-10-309553; and a method of blowing ultrasonically vibrating compressed air to separate deposits and sucking the deposits (for example, NEW ULTRASONIC CLEANER, manufactured by Shinko Co., Ltd.) as described in JP-A-7-333613.

Furthermore, there are also employable wet dust removal methods such as a method of introducing a film into a cleaning tank and separating deposits by an ultrasonic vibrator; a method of feeding a cleaning solution into a film, blowing high-speed air and performing suction as described in JP-B-49-13020; and a method of continuously rubbing a web by a liquid-wetted roll and then spraying a liquid onto the rubbed surface to achieve cleaning as described in JP-A-2001-38306. Of these dust removal methods, a method by ultrasonic dust removal and a method by wet dust removal are especially preferable in view of the dust removal effect.

Furthermore, destaticization of static electricity on the film support prior to the dust removal process is especially preferable in view of increasing an efficiency of dust removal and suppressing attachment of dusts. For achieving such a destaticization method, it is possible to use an ionizer of a corona discharge system, an ionizer of an irradiation system with light such as UV and soft X-rays, etc. The film support before and after dust removal and coating desirably has a charging voltage of not more than 1,000 V, preferably not more than 300 V, and especially preferably not more than 100 V.

From the viewpoint of holding the flatness of the film, it is preferable that the temperature of the cellulose acylate film is controlled at not higher than Tg, specifically not higher than 150° C. in these treatments.

In the case where the cellulose acylate film is made to adhere to a polarizing film as in the case of using the film of the invention as a protective film for polarizing plate, it is especially preferable from the viewpoint of adhesion properties to the polarizing film that an acid treatment or an alkaline treatment, namely a saponification treatment with respect to the cellulose acylate is carried out.

From the viewpoint of adhesion properties or the like, the cellulose acylate film preferably has surface energy of 55 mN/m or more, and more preferably 60 mN/m or more and not more than 75 mN/m. The surface energy can be adjusted by the foregoing surface treatment.

(Coating)

The respective layers of the film of the invention can be formed by the following coating methods, but it should not be construed that the invention is limited to these methods.

There are employed known methods such as a dip coating method, an air knife coating method, a curtain coating method, a roll coating method, a wire bar coating method, a gravure coating method, and an extrusion coating method (die coating method) (see U.S. Pat. No. 2,681,294), and a microgravure coating method. Of these, a microgravure coating method and a die coating method are preferable.

The “microgravure coating method” as referred to herein, which is employed in the invention, is a coating method which is characterized by disposing a gravure roll having a diameter of from about 10 to 100 mm, and preferably from about 20 to 50 mm and engraved with a gravure pattern over the entire periphery thereof beneath the support and simultaneously revolving the gravure roll in an inverse direction to the conveyance direction of the support and scraping away the excessive coating solution from the surface of the subject gravure roll by a doctor blade and transferring a fixed amount of the coating solution onto a lower surface of the support in a position at which the upper surface of the support is in a free state, thereby achieving coating. The transparent support in a roll state is continuously wound out, and at least one layer of a hard coat layer and a fluorine-coating olefin based polymer-containing low refractive index layer can be coated in one side of the wound-out support by the microgravure coating method.

With respect to the coating condition by the microgravure method, the number of lines of the gravure pattern as engraved on the gravure roll is preferably from 50 to 800 lines per inch, and more preferably from 100 to 300 lines per inch; a depth of the gravure pattern is preferably from 1 to 600 μm, and more preferably from 5 to 200 μm; the revolution number of the gravure roll is preferably from 3 to 800 rpm, and more preferably from 5 to 200 rpm; and a conveyance speed of the support is preferably from 0.5 to 100 m/min, and more preferably from 1 to 50 m/min.

In order to feed the film of the invention with high productivity, an extrusion coating method (die coating method) is preferably employed. In particular, a die coater which can be preferably employed in a region with a small wet coating amount (not more than 20 mL/m²) such as the hard coat layer and the antireflection layer will be described below.

<Configuration of Die Coater>

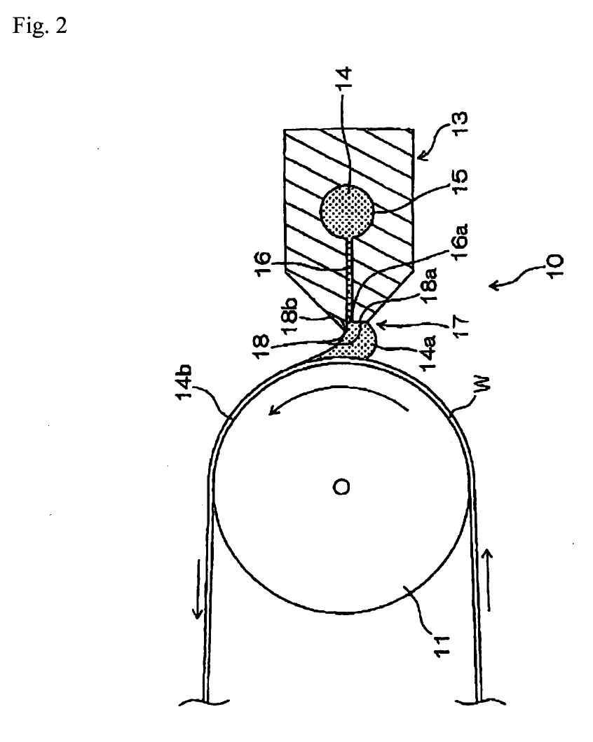

FIG. 2 is a cross-sectional view of a coater using a slot die for carrying out the invention. In a coater 10, a coating solution 14 in a form of a bead 14a is coated on a web W which is supported by a backup roll 11 and continuously runs from a slot die 13, thereby forming a coating film 14b on the web W.

A pocket 15 and a slot 16 are formed inside a slot die 13. In the pocket 15, its cross-section is constructed of a curved line and a straight line, and as illustrated in FIG. 6, it may be substantially circular or semicircular. In the pocket 15, in general, a space for collecting a coating solution as extended while having its cross-sectional shape in a width direction of the slot die 13 is formed such that an effective extended length thereof is equal to or slightly longer than a coating width. Feed of the coating solution 14 into the pocket 15 is carried out from the side face of the slot die 13 or from the center of the face in the opposite side to a slot opening 16a. Furthermore, the pocket 15 is provided with a plug for preventing the leakage of the coating solution 14 from occurring.

The slot 16 is a passage of the coating solution 14 from the pocket 15 to the web W and has its cross-sectional shape in the width direction of the slot die 13 likewise the pocket 15; and the opening 16a positioned in the web side is generally adjusted so as to have a width substantially equal to the coating width by using a non-illustrated width regulating plate. In the slot tip of this slot 16, an angle of the backup roll 11 in the web running direction to the tangential line is preferably 30° or more and not more than 90°.

A tip lip 17 of the slot die 13 at which the opening 16a of the slot 16 is positioned is formed in a tapered form, and its tip forms a flat part 18 called a land. In this land 18, an upstream side in the direction of movement of the web W against the slot 18 is named as an upstream side lip land 18a, and a downstream side thereof is named as a downstream side lip land 18b.

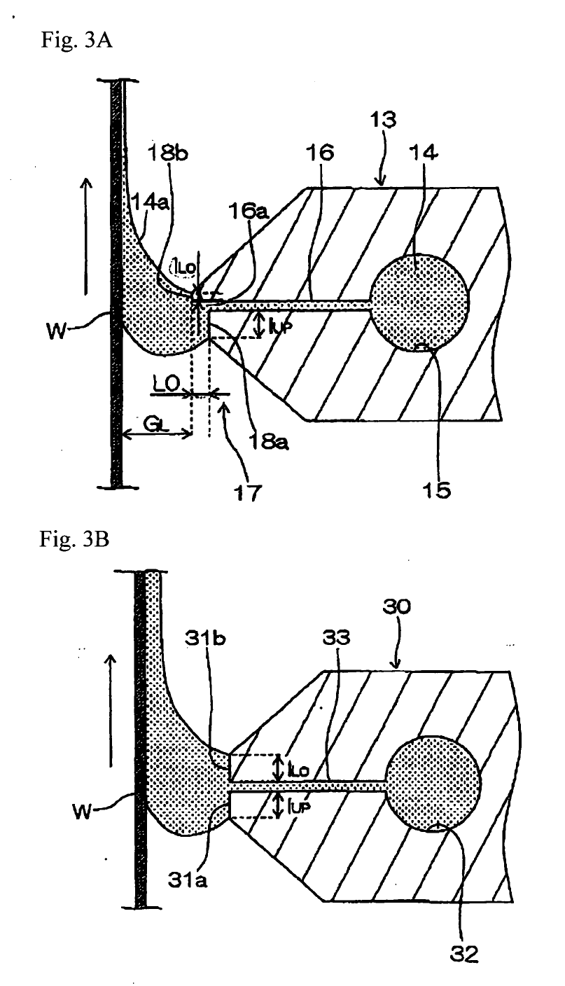

FIG. 3 shows a cross-sectional shape of the slot die 13 in comparison with a conventional slot die, in which FIG. 3A shows the slot die 13, and FIG. 3B shows a conventional slot die 30. In the conventional slot die 30, a distance between an upstream side lip land 31a and a web W is equal to that between a downstream side lip land 31b and the web W. Incidentally, a symbol 32 shows a pocket, and a symbol 33 shows a slot. On the other hand, in the slot die 13 of the invention, a length I_{LO} of the downstream side lip land 18b is made short, whereby coating with a wet film thickness of not more than 20 μm can be carried out with good accuracy.

Though a land length I_{UP} of the upstream side lip land 18a is not particularly limited, it is preferably in the range of from 500 μm to 1 mm. The land length I_{LO} of the downstream side lip land 18b is 30 μm or more and not more than 100 μm, preferably 30 μm or more and not more than 80 μm, and more preferably 30 μm or more and not more than 60 μm. When the land length I_{LO} of the downstream side lip land 18b is shorter than 30 μm, an edge or a land of the tip lip is liable to be broken and a stripe is liable to be generated in the coating film, resulting in making it unable to perform coating. Furthermore, it becomes difficult to set up the position of a wet line in the downstream side so that a problem that the coating solution is likely spread in the downstream side is caused. It has hitherto been known that this wet spreading of the coating solution in the downstream side means heterogeneity of the wet line, leading to a problem that a defective shape such as a stripe on the coating surface is brought. On the other hand, when the land length I_{LO} of the downstream side lip land 18b is longer than 100 μm, since a bead itself cannot be formed, it is impossible to perform thin layer coating.

In addition, since the downstream side lip land 18b is in an overbite shape close to the web W as compared with the upstream side lip land 18a, a degree of vacuum can be increased so that it becomes possible to form a bead suitable for thin film coating. A difference in distance between the downstream side lip land 18b and the upstream side lip land 18b from the web W (hereinafter referred to as “overbite length LO”) is preferably 30 μm or more and not more than 120 μm, more preferably 30 μm or more and not more than 100 μm, and most preferably 30 μm or more and not more than 80 μm. When the slot die 13 is in an overbite shape, a gap G_{L} between the tip lip 17 and the web W shows a gap between the downstream side lip land 18b and the web W.

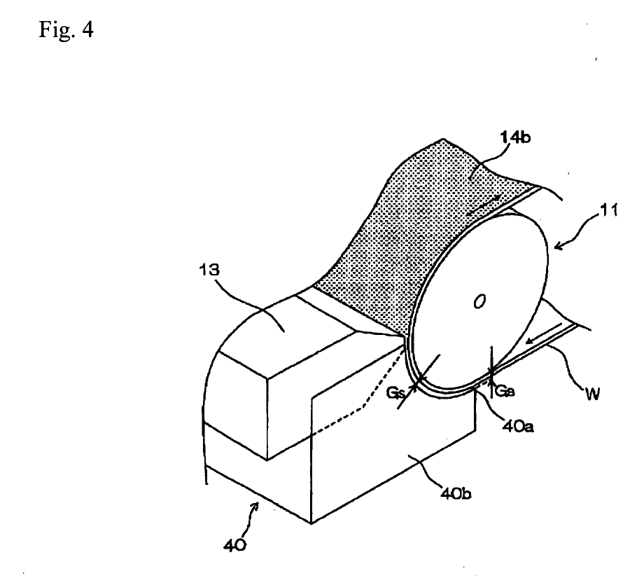

FIG. 4 is an oblique view to show a slot die in the coating step for carrying out the invention and its surroundings. In an opposite side to the side of the direction of movement of the web W, a vacuum chamber 40 is placed at a position not coming into contact with the web W such that the vacuum adjustment can be thoroughly achieved against the bead 14a. The vacuum chamber 40 is provided with a back plate 40a and a side plate 40b for keeping its working efficiency; and gaps G_{B} and G_{S} are present between the back plate 40a and the web W and between the side plate 40b and the web W, respectively.

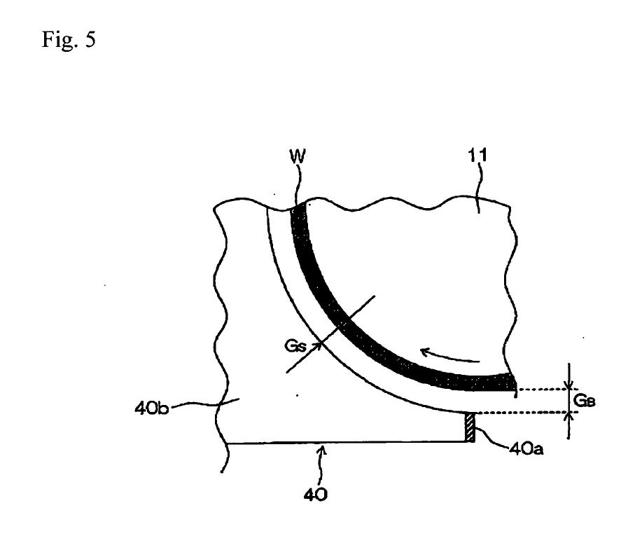

FIG. 5 is each a cross-sectional view to show the vacuum chamber 40 and the web W adjacent to each other. The side plate and the back plate may be integrated with the chamber main body as illustrated in FIG. 5, or may have a structure in which the side plate and the back plate are engaged with the chamber by a screw or the like so as to properly change the gap. In all of these structures, actually opened portions between the back plate 40a and the web W and between the side plate 40b and the web W are defined as gap G_{B} and G_{S}, respectively. In the case where the vacuum chamber 40 is placed beneath the web W and the slot die 13 as illustrated in FIG. 4, the gap G_{B} between the back plate 40a of the vacuum chamber 40 and the web W exhibits a gap from the uppermost end of the back plate 40a to the web W.

It is preferable that the gap G_{B} between the back plate 40a and the web W is made larger than the gap G_{L} between the tip lip 17 of the slot die 13 and the web W. In this way, it is possible to suppress a change of vacuum degree in the vicinity of the bead as caused due to eccentricity of the backup roll 11. For example, when the gap G_{L} between the tip lip 17 of the slot die 13 and the web W is 30 μm or more and not more than 100 μm, the gap G_{B} between the backup plate 40a and the web W is preferably from 100 μm or more and not more than 500 μm.

<Material and Precision>

With respect to the length of the tip lip in a side of the direction of movement of the web in a running direction of the web, the longer this length, the more disadvantageous for bead formation is. When this length is scattered between arbitrary places in the width direction of the slot die, the bead becomes instable due to slight disturbance. Accordingly, it is preferable that a fluctuation width of this length in the width direction of the slot die falls within 20 μm.

Furthermore, with respect to the material of the tip lip of the slot die, when a material such as stainless steel is used, sagging occurs in a stage of die processing so that even when the length of the tip lip of the slot die in the running direction of the web is in the range of from 30 to 100 μm as described previously, the precision of the tip lip cannot be satisfied. Accordingly, in order to keep a high processing precision, it is important to use a super hard material quality as described in Japanese Patent No. 2817053. Concretely, it is preferable that at least the tip lip of the slot die is made of a cemented carbide in which a carbide crystal having an average particle size of not more than 5 μm is bound therein. Examples of the cemented carbide include those in which a carbide crystal particle such as tungsten carbide (hereinafter referred to as “WC”) is bound by a binder metal such as cobalt. In addition to cobalt, examples of the binder metal which can be used include titanium, tantalum, niobium, and mixed metals thereof. The average particle size of the WC crystal is more preferably not more than 3 μm.

In order to realize coating with a high precision, scattering in the gap in the width direction of the slot die between the foregoing length of the land of the tip lip in the side of the direction of movement of the web and the web is an important factor, too. It is desired to achieve a combination of these two factors, namely a straightness falling within the range where a fluctuation width of the gap is suppressed to some extent. Preferably, a straightness of the tip lip and the backup roll is brought such that the fluctuation width of the gap in the width direction of the slot die is not more than 5 μm.

(Coating Speed)

By achieving the foregoing precision of the backup roll and the tip lip, a coating system which is preferably employed in the invention is high in stability at the time of high-speed coating. In addition, since the foregoing coating system is a pre-metering system, it is easy to ensure a stable film thickness even at the time of high-speed coating. For a coating solution of low coating amount as in the antireflection film of the invention, the foregoing coating system can achieve coating at a high speed with good stability in film thickness. Though coating can be achieved by other coating system, according to a dip coating method, vibration of the coating solution in a liquid receiver tank is unavoidable so that unevenness in a step-like form is likely caused. According to a reverse roll coating method, unevenness in a step-like form is likely caused due to eccentricity or bending of a roll related to coating. Furthermore, since these coating systems are a post-metering system, it is difficult to ensure a stable film thickness. From the standpoint of productivity, it is preferable that coating is carried out at 50 m/min or more by employing the foregoing die coating method.

(Drying)

It is preferable that after coating on the support directly or via other layer, the film of the invention is conveyed into a zone heated for drying the solvent by means of a web.

As a method of drying the solvent, a variety of knowledge can be utilized. Specific examples of the knowledge include methods as described in JP-A-2001-286817, JP-A-2001-314798, JP-A-2003-126768, JP-A-2003-315505, and JP-A-2004-34002.

The temperature of the drying zone is preferably from 25° C. to 140° C.; and it is preferable that the temperature of the first half of the drying zone is relatively low, whereas the temperature of the second half of the drying zone is relatively high. However, it is preferable that the temperature is not higher than the temperature at which volatilization of the components other than the solvent to be contained in the coating composition of each layer starts. For example, among commercially available photo radical generators which are used together with an ultraviolet ray hardenable resin, there are ones in which a several tens % portion thereof is volatilized within several minutes in warm air of 120° C. Furthermore, among monofunctional or bifunctional acrylate monomers, there are ones in which volatilization proceeds in warm air of 100° C. In such case, it is preferable that the temperature of the drying zone is not higher than the temperature at which volatilization of the components other than the solvent to be contained in the coating composition of each layer starts.

Furthermore, it is preferable that with respect to the dry air after coating the coating composition of each layer on the support, when the solids content of the coating composition is from 1 to 50%, for the purpose of preventing drying unevenness from occurring, it is preferable that the air velocity on the surface of the coating film is in the range of from 0.1 to 2 m/sec.

Moreover, after coating the coating composition of each layer on the support, when a difference in temperature between a conveyance roll coming into contact with an opposite surface of the support to a coating surface is made to fall within the range of from 0° C. to 20° C. in the drying zone, drying unevenness due to heat transmission unevenness on the conveyance roll can be prevented from occurring, and therefore, such is preferable.

(Hardening)

After drying the solvent, the film of the invention is passed through a zone capable of hardening each coating film by ionizing radiations and/or heat by the web, whereby the coating film can be hardened. In the invention, the species of the ionizing radiations is not particularly limited and can be properly selected among ultraviolet rays, electron beams, near ultraviolet rays, visible light, near infrared rays, infrared rays, and X-rays depending upon the kind of the hardenable composition from which a film is formed. Above all, ultraviolet rays and electron beams are preferable; and ultraviolet rays are especially preferable from the standpoints that handling is simple and easy and that high energy is easily obtained.

As a light source of ultraviolet rays for photopolymerizing an ultraviolet ray reactive compound, any light source can be used so far as it is able to emit ultraviolet rays. For example, a low pressure mercury vapor lamp, a middle pressure mercury vapor lamp, a high pressure mercury vapor lamp, an extra-high pressure mercury vapor lamp, a carbon arc lamp, a metal halide lamp, a xenon lamp, and so on can be used. Furthermore, an ArF excimer laser, a KrF excimer laser, an excimer lamp, a synchrotron radiation, and so on can be used, too. Above all, an extra-high pressure mercury vapor lamp, a high pressure mercury vapor lamp, a low pressure mercury vapor lamp, a carbon arc lamp, a xenon arc lamp, and a metal halide lamp can be preferably used.

Further, electron beams can be similarly used. As the electron beams, there can be enumerated electron beams having energy of from 50 to 1,000 keV, and preferably from 100 to 300 keV, which are emitted from a variety of electron beam accelerators such as a Cockcroft-Walton type electron beam accelerator, a van de Graaff type electron beam accelerator, a resonant transformation type electron beam accelerator, an insulating core transformer type electron beam accelerator, a linear type electron beam accelerator, a dynamitron type electron beam accelerator, and a high frequency type electron beam accelerator.

The irradiation condition varies depending upon the respective lamp. An irradiation dose is preferably 10 mJ/cm² or more, more preferably from 50 mJ/cm² to 10,000 mJ/cm², and especially preferably from 50 mJ/cm² to 2,000 mJ/cm². On that occasion, the irradiation dose distribution in a width direction of the web including the both ends is preferably from 50 to 100%, and more preferably from 80 to 100% on the basis of a maximum irradiation dose in the center.

In the invention, it is preferred to harden at least one layer stacked on the support by a step for irradiating ionizing radiations in an atmosphere having an oxygen concentration of not more than 10% by volume in a state of irradiating ionizing radiation and heating at a film surface temperature of 60° C. or higher for a period of time of 0.5 seconds or more after starting the irradiation with ionizing radiations.

It is also preferable that heating is carried out in an atmosphere having a low oxygen concentration simultaneously with and/or subsequently to the irradiation with ionizing radiations.

In particular, it is preferable that the low refractive index layer which is the outermost layer and has a thin thickness is hardened by this method. The hardening reaction is accelerated by heat, whereby a film having excellent physical strength and chemical resistance can be formed.

The time for irradiating ionizing radiations is preferably 0.7 seconds or more and not more than 60 seconds, and more preferably 0.7 seconds or more and not more than 10 seconds. When the time for irradiating ionizing radiations is not more than 0.5 seconds, the hardening reaction cannot be completed so that hardening cannot be thoroughly achieved. Furthermore, what the low oxygen condition is kept for a long period of time is not preferable because the equipment becomes large in size and a large amount of an inert gas is required.

As a measure for controlling the oxygen concentration to not more than 1,000 ppm, it is preferred to substitute the air with other gas. It is especially preferable that the air is substituted (purged) with nitrogen.

By feeding an inert gas into an ionizing radiation irradiation chamber where the hardening reaction by ionizing radiations is carried out (sometimes referred to as “reaction chamber”) and setting up a condition so as to slightly blow out the inert gas into a web inlet side of the reaction chamber, not only it is possible to exclude entrained air following the conveyance and to effectively decrease an oxygen concentration of the reaction chamber, but also it is possible to effectively decrease a substantial oxygen concentration on the polar surface having large hardening hindrance due to oxygen. The direction of the inert gas flow in the web inlet side of the reaction chamber can be controlled by adjusting a balance between air supply and exhaustion of the reaction chamber.

With respect to a method for excluding the entrained air, it is preferably employed to blow the inert gas directly on the web surface.

Furthermore, by providing a front chamber before the foregoing reaction chamber to exclude oxygen on the web surface in advance, it is possible to make the hardening proceed more efficiently. Moreover, for the purpose of efficiently using the inert gas, a gap between the side face constructing the web inlet side of the ionizing radiation reaction chamber or front chamber and the web surface is preferably from 0.2 to 15 mm, more preferably from 0.2 to 10 mm, and most preferably from 0.2 to 5 mm. However, in order to continuously produce a web, it is necessary to join and connect the web. For joining, there is widely used a method of sticking it with a joining tape, etc. For that reason, when the gap between the inlet face of the ionizing radiation reaction chamber or front chamber and the web is excessively narrow, there is caused a problem such that a joining member such as a joining tape is stuck. For that reason, in order to make the gap narrow, it is preferable that at least a part of the inlet face of the ionizing radiation reaction chamber or front chamber is made movable such that when a joining part enters, the gap is widened in a proportion corresponding to the joining thickness. In order to realize this, there are employable a method in which the inlet face of the ionizing radiation reaction chamber or front chamber is made movable back and forth in the direction of movement and when the joining part passes therethrough, moves back and forth, thereby widening the gap; and a method in which the inlet face of the ionizing radiation reaction chamber or front chamber is made movable in a direction vertical to the web surface and when the joining part passes therethrough, moves up and down, thereby widening the gap.

The irradiation with ultraviolet rays may be carried out every time of providing one layer for the respective constitutional plural layers or after stacking. Alternatively, the irradiation may be carried out by combining them. It is preferable from the standpoint of productivity that ultraviolet rays are irradiated after stacking multiple layers.

In the invention, it is possible to harden at least one layer as stacked on the support by irradiation with ionizing radiations plural times. In this case, it is preferable that the irradiation with ionizing radiations is carried out at least two times in continuous reactions chambers where the oxygen concentration does not exceed 1,000 ppm. By carrying out the irradiation with ionizing radiations plural times in reaction chambers having the same low oxygen concentration, it is possible to effectively ensure the reaction time necessary for hardening.

In particular, in the case of increasing the production speed for high productivity, in order to ensure energy of ionizing radiations necessary for the hardening reaction, it is necessary to carry out the irradiation with ionizing radiations plural times.

Furthermore, in the case where a hardening rate [100−(residual functional group content)] is a value less than 100%, in providing a layer thereon and hardening by ionizing radiations and/or heat, when the hardening rate of a lower layer is higher than that before providing an upper layer, the adhesiveness between the lower layer and the upper layer is improved, and therefore, such is preferable.

(Handling)

For the purpose of continuously producing the film of the invention, a step for continuously delivering a support film in a rolled state; a step for coating and drying a coating solution; a step for hardening a coating film; and a step for winding up the support film having a hardened layer are carried out.

A film support is continuously delivered from the film support in a rolled state into a clean chamber; static electricity as charged on the film support is destaticized by a destaticization unit within the clean chamber; and a foreign substance as attached on the film support is subsequently removed by a dust removing unit. Subsequently, the coating solution is coated on the film support in a coating part as placed within the clean chamber, and the coated film support is sent into a drying chamber and dried.

The film support having a dried coating layer is delivered from the drying chamber into a hardening chamber, and a monomer as contained in the coating layer is polymerized and hardened. In addition, the film support having a hardened layer is sent into a hardening part, thereby completing hardening; and the film support having a completely hardened layer is wound up and becomes in a rolled state.

The foregoing steps may be carried out every time of forming each layer. By providing a plural number of coating part/drying chamber/hardening part, it is also possible to carry out the formation of each layer.

In order to prepare the film of the invention, it is preferable that at the same time of the foregoing microfiltration operation of the coating solution, the coating step in the coating part and the drying step to be carried out in the drying chamber are carried out in an air atmosphere with high cleanliness and that prior to carrying out coating, contaminants and dusts on the film are thoroughly removed. The air cleanliness in the coating step and the drying step is desirably class 10 (the number of particles of 0.5 μm or larger is not more than 353/m³) or more, and more desirably class I (the number of particles of 0.5 μm or larger is not more than 35.5/m³) or more on the basis of the air cleanliness according to the Federal Standard No. 209E. Furthermore, it is also preferable that the air cleanliness is high, too in other steps than the coating and drying step such as delivery and winding up.

(Saponification Treatment)

In preparing a polarizing plate by using the film of the invention as one of two surface protective films of polarizing film, it is preferred to improve the adhesion on the adhesive surface by hydrophilizing the surface in a side at which the polarizing film is stuck.

(a) Method of Dipping in an Alkaline Solution:

This method is a measure in which the film is dipped in an alkaline solution, thereby saponifying all of the surfaces having reactivity with an alkali on the entire surface of the film. Since this method does not require special equipment, it is preferable from the viewpoint of costs. A sodium hydroxide aqueous solution is preferable as the alkaline solution. A concentration of the alkaline solution is preferably from 0.5 to 3 moles/L, and especially preferably from 1 to 2 moles/L; and a liquid temperature of the alkaline solution is preferably from 30 to 75° C., and especially preferably from 40 to 60° C.

Though the foregoing combination of the saponification condition is a combination of relatively mild conditions, it can be set up by the raw material and configuration of the film and a desired contact angle.

After dipping in the alkaline solution, it is preferable that the film is thoroughly washed with water or that the film is dipped in a dilute acid, thereby neutralizing an alkaline component such that the alkaline component does not remain in the film.

By the saponification treatment, the surface opposite to the surface on which the coating layer is present is hydrophilized. The protective film for polarizing plate is provided for use after making the hydrophilized surface of the transparent support adhere to the polarizing film.

The hydrophilized surface is effective for improving the adhesion to the adhesive surface made of, as the major component, polyvinyl alcohol.

With respect to the saponification treatment, it is preferable from the viewpoint of adhesion to the polarizing film that the contact angle of the surface of the transparent support in the opposite side to the side at which the coating layer is present against water is low as far as possible. On the other hand, in the dipping method, since the film is damaged by the alkali at the same time over from the surface at which the coating layer is present to the inside of the film, it is important to employ a necessary and minimum condition. In the case where the contact angle of the transparent support on the surface in the opposite side against water is employed as an index of the damage which each layer receives by the alkali, especially when the transparent support is triacetyl cellulose, the contact angle is preferably from 100 to 50°, more preferably from 30° to 50°, and further preferably from 40° to 50°. When the contact angle exceeds 50°, a problem is caused in the adhesion to the polarizing film, and therefore, such is not preferable. On the other hand, when it is less than 10°, the damage which the film receives becomes too large, the physical strength is hindered, and therefore, such is not preferable.

(b) Method of Coating an Alkaline Solution:

As a measure for avoiding the damage against each film in the foregoing dipping method, there is preferably employed a method of coating an alkaline solution by coating an alkaline solution only on the surface in the opposite side to the surface on which the coating layer is present, followed by heating, washing with water and drying. Incidentally, in this case, the “coating” as referred to herein means that the alkaline solution or the like is brought into contact with only the surface on which the saponification is carried out. In addition to the coating, spraying, contacting with a liquid-containing belt, or other means is also included. By employing such a method, since equipment and step for coating the alkaline solution are separately required, this method is inferior to the dipping method (a) from the viewpoint of costs. On the other hand, since the alkaline solution comes into contact with only the surface to which the saponification treatment is applied, a layer using a raw material which is weak against the alkaline solution can be provided on the surface in the opposite side. For example, in a vapor deposited film or a sol-gel film, a variety of influences such as corrosion, dissolution and peeling are caused due to the alkaline solution. Accordingly, though it is not desired to provide such vapor deposited film or sol-gel film by the dipping method, since the film does not come into contact with the solution in this coating method, it is possible to use such a vapor deposited film or a sol-gel film without any problem.

In all of the foregoing saponification methods (a) and (b), since the saponification can be carried out after winding out the film from the support in a rolled state and forming the respective layers, it may be added after the film production step and achieved in a series of operations. In addition, by continuously carrying out a sticking step to a polarizing plate made of a similarly wound out support collectively, it is possible to prepare a polarizing plate with good efficiency as compared with the case of carrying out the same operations sheet by sheet.

(c) Method of Achieving Saponification by Protecting by a Laminate Film:

Likewise the foregoing method (b), in the case where the coating layer is insufficient in resistance to an alkaline solution, after forming an ultimate layer, by sticking a laminate film onto the surface on which the ultimate layer has been formed and then dipping in an alkaline solution, it is possible to hydrophilize only the triacetyl cellulose surface in an opposite side to the surface on which the ultimate layer has been formed and then peeling away the laminate film. According to this method, it is also possible to apply a hydrophilization treatment enough as a protective film for polarizing plate to only the surface of the triacetyl cellulose film in an opposite side to the surface on which the ultimate layer has been formed without damaging the coating layer. In comparison with the foregoing method (b), this method involves an advantage such that though the laminate film is generated as a waste, a special device for coating an alkaline solution is not required.

(d) Method of Dipping in an Alkaline Solution After Forming a Middle Layer:

In the case where though a lower layer has resistance to an alkaline solution, an upper layer is insufficient in resistance to an alkaline solution, after forming the lower layer, it is possible to dip the film in an alkaline solution, thereby hydrophilizing the both surfaces thereof and then forming an upper layer. The production process becomes complicated. However, for example, in a film composed of a hard coat layer and a low refractive index layer made of a fluorine-containing sol-gel film, in the case where a hydrophilic layer is present, there is brought an advantage that interlaminar adhesiveness between the hard coat layer and the low refractive index layer is improved.

(e) Method of Forming a Coating Layer on a Previously Saponified Triacetyl Cellulose Film:

A coating layer may be formed on either one surface of a triacetyl cellulose film which has been previously saponified by dipping in an alkaline solution or other means directly or via other layer. In the case where the triacetyl cellulose film is saponified by dipping in an alkaline solution, interlaminar adhesiveness to the triacetyl cellulose surface which has been hydrophilized by the saponification may possibly be deteriorated. In such case, it is possible to deal with this problem by subjecting only the surface on which a coating layer is formed after the saponification to a corona discharge or glow discharge treatment or other means, thereby removing the hydrophilized surface. Furthermore, in the case where the coating layer contains a hydrophilic group, the interlaminar adhesiveness may possibly become good.

[Preparation of Polarizing Film]

The film of the invention can be used as a polarizing film by using it as a polarizing film and a protective film as disposed in one side or both sides thereof.

The film of the invention may be used as one protective film, while using a usual cellulose acetate film as the other protective film. However, it is preferred to use a cellulose acetate film which is produced by the foregoing solution film formation method and stretched in a width direction in a rolled film state in a stretching ratio of from 10 to 100%.

In addition, in the polarizing plate of the invention, it is preferable that one surface thereof is made of an antireflection film, whereas the other protective film is an optical compensating film made of a liquid crystalline compound.

Examples of the polarizing film include an iodine based polarizing film, a dye based polarizing film using a dichroic dye, and a polyene based polarizing film. The iodine based polarizing film and the dye based polarizing film are in general produced by using a polyvinyl alcohol based film.

A slow axis of the transparent support of the antireflection film or the cellulose acetate film and a transmission axis of the polarizing film are disposed substantially parallel to each other.

For the productivity of the polarizing plate, moisture permeability of the protective film is important. The polarizing film and the protective film are stuck to each other by an aqueous adhesive, and a solvent of this adhesive is diffused into the protective film, thereby achieving drying. When the moisture permeability of the protective film is high, the drying becomes fast, and the productivity is improved. However, when the moisture permeability is excessively high, the moisture enters the polarizing film by the use circumstance (under high humidity) of a liquid crystal display device, whereby a polarizing ability is lowered.

The moisture permeability of the protective film is determined by thickness, free volume, hydrophilicity or hydrophobicity, and so on of the transparent support or polymer film (and polymerizable liquid crystal compound).

In the case where the film of the invention is used as a protective film for polarizing plate, the moisture permeability is preferably from 100 to 1,000 g/m²·24 hrs, and more preferably from 300 to 700 g/m²·24 hrs.

In the case of film formation, the thickness of the transparent support can be adjusted by a lip flow rate and a line speed, or stretching or compression. Since the moisture permeability varies depending upon the major raw material to be used, it is possible to set up the moisture permeability in a preferred range by adjusting the thickness.

In the case of film formation, the free volume of the transparent support can be adjusted by drying temperature and time.

In this case, since the moisture permeability also varies depending upon the major raw material to be used, it is possible to set up the moisture permeability in a preferred range by adjusting the free volume.

The hydrophilicity or hydrophobicity of the transparent support can be adjusted by an additive. By adding a hydrophilic additive in the foregoing free volume, the moisture permeability becomes high, whereas by adding a hydrophobic additive, the moisture permeability can be made low.

By independently controlling the foregoing moisture permeability, it is possible to produce a polarizing plate having an optical compensating ability cheaply with high productivity.

As the polarizing film, known polarizing films and polarizing films which are cut out from a longitudinal polarizing film whose absorption axis is neither parallel nor vertical to the longitudinal direction may be used. The longitudinal polarizing film whose absorption axis is neither parallel nor vertical to the longitudinal direction is prepared by the following method.

That is, this polarizing film is a polarizing film as prepared by stretching a continuously fed polymer film by imparting a tension while holding the both ends thereof by holding units. The polarizing film can be produced in a stretching method in which the film is stretched in a ratio of from 1.1 to 20.0 times in at least a film width direction; a difference in movement speed in a longitudinal direction between the holding units in the both film ends is within 3%; and the direction of movement of the film is bent in a state of holding the both film ends such that an angle between the direction of movement of the film in an outlet of the step for holding the both film ends and the substantial stretching direction of the film is inclined at from 20° to 70°. In particular, a polarizing film in which the subject angle is inclined at 45° is preferably used from the viewpoint of productivity.

The stretching method of the polymer film is described in detail in JP-A-2002-86554, paragraphs [0020] to [0030].

It is also preferable that of two protective films of a polarizer, a film other than the antireflection film is an optical compensating film having an optical compensating layer containing an optically anisotropic layer. The optical compensating film (retardation film) is able to improve a viewing angle characteristic of a liquid crystal display screen.

Known optical compensating films can be used as the optical compensating film. An optical compensating film as described in JP-A-2001-100042 is preferable from the standpoint of widening a viewing angle.

[Use embodiment of the Invention]

The optical film of the invention is used for image display devices such as a liquid crystal display device (LCD), a plasma display panel (PDP), an electroluminescence display device (ELD), and a cathode ray tube display device (CRT). An optical filter according to the invention can be used on a known display such as a plasma display panel (PDP) and a.

[Liquid Crystal Display Device]

The optical film of the invention can be advantageously used for image display devices such as a liquid crystal display device. It is preferred to use the film of the invention in the outermost layer of a display.

In general, the liquid crystal display device has a liquid crystal cell and two polarizing plates as disposed in the both sides thereof, and the liquid crystal cell supports a liquid crystal between two electrode substrates. In addition, one optically anisotropic layer may be disposed between the liquid crystal cell and one of the polarizing plates, or two optically anisotropic layers may be disposed between the liquid crystal cell and each of the both polarizing plates.

It is preferred to use a TN mode, a VA mode, an OCB mode, an IPS mode, or an ECB mode as the liquid crystal cell in combination with the optical film and the polarizing plate containing the same according to the invention. In particular, from the viewpoint that high contrast in a bright room due to realization of high grade of black display in a bright room, a combination with a VA mode or an IPS mode is more preferable. Above all, a combination with an IPS mode in which light leakage is liable to occur at the time of black display is the most preferable.

(TN Mode)

In a liquid crystal cell of a TN mode, a rod-like liquid crystalline molecule is substantially horizontally aligned and further aligned in a twisted state at from 60° to 120° at the time of applying no voltage.

The liquid crystal cell of a TN mode is most frequently utilized as a color TFT liquid crystal display device and described in many references.

(VA Mode)

In a liquid crystal cell of a VA mode, a rod-like liquid crystalline molecule is substantially vertically aligned at the time of applying no voltage.

The liquid crystal cell of a VA mode includes, in addition to (1) a liquid crystal cell of a VA mode in a narrow sense in which a rod-like liquid crystalline molecule is substantially vertically aligned at the time of applying no voltage, whereas it is substantially horizontally aligned at the time of applying a voltage (as described in JP-A-2-176625), (2) a liquid crystal cell of a multi-domained VA mode (MVA mode) for enlarging a viewing angle (as described in SID 97, Digest of Tech. Papers, 28 (1997), page 845), (3) a liquid crystal cell of a mode (n-ASM mode) in which a rod-like liquid crystalline molecule is substantially vertically aligned at the time of applying no voltage and is subjected to twisted multi-domain alignment at the time of applying a voltage (as described in Preprints of Forum on Liquid Crystal, pages 58 to 59 (1998), and (4) a liquid crystal cell of a SURVIVAL mode (as announced in LCD International 98).

(OCB Mode)

A liquid crystal cell of an OCB mode is a liquid crystal cell of a bend alignment mode in which a rod-like liquid crystalline molecule is aligned in a substantially reverse direction (in a symmetric manner) in the upper and lower parts of a liquid crystal cell and is disclosed in U.S. Pat. Nos. 4,583,825 and 5,410,422. Since the rod-like liquid crystalline molecule is symmetrically aligned in the upper and lower parts of a liquid crystal cell, the liquid crystal cell of a bend alignment mode has a self optical compensating ability. For that reason, this liquid crystal mode is named as an OCB (optically compensatory bend) liquid crystal mode. A liquid crystal display device of a bend alignment mode involves an advantage such that the response speed is fast.

(IPS Mode)

A liquid crystal cell of an IPS mode is of a system of switching by applying a lateral electric field to a nematic liquid crystal and is described in detail in Proc. IDRC (Asia Display '95), pages 577 to 580 and pages 707 to 710.

(ECB Mode)

In a liquid crystal cell of an ECB mode, a rod-like liquid crystalline molecule is substantially horizontally aligned at the time of applying no voltage. The ECB mode is one of liquid crystal display modes having the simplest structure and is described in detail in, for example, JP-A-5-203946.

[Displays Other than Liquid Crystal Display Device]

(PDP)

A plasma display panel (PDP) is in general constituted of a gas, a glass substrate, an electrode, an electrode lead material, a thick film printing material, and a fluorescent material. The glass substrate is constituted of two sheets of a front glass substrate and a rear glass substrate. In each of the two glass substrates, an electrode and an insulating layer are formed. In the rear glass substrate, a fluorescent material layer is further formed. The two glass substrates are assembled, and a gas is sealed therebetween.

The plasma display panel (PDP) is already marketed. The plasma display panel is described in JP-A-5-205643 and JP-A-9-306366.

There may be the case where a front plate is disposed in front of the plasma display panel. It is preferable that the front plate has a sufficient strength for protecting the plasma display panel. The front plate can be used at an interval from the plasma display panel or can be used by sticking directly on the plasma display panel main body. In image display devices such as a plasma display panel, an optical film can be stuck directly on the display surface. Furthermore, in the case where a front plate is provided in front of the display, it is also possible to stick an optical film in the front side (external side) or rear side (display side) of the front plate.

(Touch Panel)

The film of the invention can be applied to touch panels as described in JP-A-5-127822 and JP-A-2002-48913, and so on.

(Organic EL Element)

The film of the invention can be used as a substrate (substrate film) or a protective film of an organic EL element and so on.

In the case where the film of the invention is used in an organic EL element or the like, the contents as described in JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617, and JP-A-2002-056976 can be applied. Furthermore, it is preferred to use the contents as described in JP-A-2001-148291, JP-A-2001-221916, and JP-A-2001-231443 in combination.

### EXAMPLES

Examples of the invention will be hereunder described, but it should not be construed that the invention is limited thereto.

TABLE 2
[Preparation of coating solution for hard coat layer]

| | | Coating solution name | | |
|---|---|---|---|---|
| Raw material name | | HC-1 | HC-2 | HC-3 |
| Binder | PET-30 | 40.1 | 34.9 | 34.9 |
| | DPHA | 4.45 | 3.90 | 3.90 |
| Particle | Monodispersed silica | — | 5.67 | — |
| | (monodispersed: 1.5 μm) | | | |
| | Coagulating silica (Secondarily | — | — | 5.67 |
| | coagulated particle size: 1.5 μm) | | | |
| Initiator | IRGACURE 184 | 1.34 | 1.17 | 1.17 |
| | IRGACURE 907 | 0.24 | 0.21 | 0.21 |
| Leveling | FP-7 | 0.08 | 0.08 | 0.08 |
| agent | | | | |
| Solvent | Methyl isobutyl ketone | 38.0 | 38.0 | 38.0 |
| | Cyclohexanone | 16.1 | 16.1 | 16.1 |

| | | | |
|---|---|---|---|
| Total | 100 | 100 | 100 |

The coating solutions HC-1 to HC-3 for hard coat layer were prepared according to the foregoing table. The numerals in the table are “% by weight”. Incidentally, PET-30 is a mixture of pentaerythritol triacrylate and pentaerythritol tetraacrylate (manufactured by Nippon Kayaku Co., Ltd.); DPHA is a mixture of dipentaerythritol hexaacrylate and dipentaerythritol pentaacrylate (manufactured by Nippon Kayaku Co., Ltd.); the monodispersed silica is SEAHOSTAR KE-P150 with a particle size of 1.5 μm (manufactured by Nippon Shokubai Co., Ltd.); the coagulating silica has a secondarily coagulated particle size of 1.5 μm (primary particle size: several tens nm) (manufactured by Nihon Silica); IRGACURE 184 is a polymerization initiator (manufactured by Ciba Speciality Chemicals); and IRGACURE 907 is a polymerization initiator (manufactured by Ciba Speciality Chemicals). Each of the solutions resulting from thoroughly mixing the foregoing components was filtered through a polypropylene-made filter having a pore size of 30 μm, thereby completing the coating solutions HC-1 to HC-3 for hard coat layer.

(Application of Hard Coat Layer)

By using a slot die coated as described in FIG. 1 of JP-A-2003-211052, an 80 μm-thick triacetyl cellulose film (TAC-TD80U, manufactured by Fuji Photo Film Co., Ltd.) was wound out in a rolled state; each of the coating solutions HC-1 to HC-3 for hard coat layer was coated thereon; after drying at 30° C. for 15 seconds and 90° C. for 20 seconds, the coating layer was hardened upon irradiation with ultraviolet rays at an irradiation dose of 50 mJ/cm² by using an air-cooled metal halide lamp (manufactured by Eyegraphics Co., Ltd.) of 160 W/cm under purging with nitrogen, thereby preparing optical films each having a hard coat layer with a thickness of 2.5 μm, followed by winding up.

Furthermore, hard coat layer-provided optical films were prepared in the same manner as in the preparation of the foregoing HC-2 or HC-3, except for changing the addition amount of silica in the hard coated layer of the monodispersed silica of HC-2 or the coagulating silica of HC-3.

In HC-2-(1), the addition amount of the monodispersed silica of HC-2 was increased twice.

Furthermore, in HC-3-(1) to (8), the addition amount of the coagulating silica of HC-3 was changed and adjusted within the range of from 0.1 times to 5 times.

These samples are designated as Example Samples or Comparative Samples 1 to 14. Furthermore, samples as prepared in exactly the same manner, except for changing the coagulating silica in Example Sample 6 and Example Sample 8 to coagulating alumina having a secondarily coagulated particle size of 1.5 μm (primary particle size: several tens nm) (manufactured by Sumitomo Chemical Co., Ltd.), are designated as Example Sample 13 (coating solution HC-4-(1)) and Example Sample 14 (coating solution HC-4-(2)), respectively. The details are shown in Table 3.

(Firmness of Black Color at the Time of Black Display <Display Performance>)

A surface film in a visible side as provided in a viewing side of a liquid crystal display device using liquid crystal cells of an IPS system (32″ TV: W32-L7000, manufactured by Hitachi, Ltd.) was peeled away, and instead thereof, a back surface of the optical film of the invention was stuck thereonto via an adhesive while facing its coating surface in the viewing side. The liquid crystal display device was black displayed in a bright room of 1,000 lux and visually evaluated, thereby achieving the following judgments.

The evaluation was made on a maximum of 20 points. A “point 20” means that a whitish feeling due to external light is not brought at all, is low in luminance for black display and leaves no room with respect to the contrast in a bright room. On the other hand, when the point is less than 5, a whitish feeling due to external light is too strong, is not tolerable for black display (NG) and is low with respect to the contrast in a bright room.

(Pencil Hardness <Scar Resistance (i)>)

The optical film of the invention was evaluated by a pencil hardness test according to JIS-K5400.

(Surface Haze)

[1] A total haze (H) of the obtained optical film is measured according to JIS-K7136.

[2] A few drops of silicone oil were added on a front surface and a back surface of the optical film; the optical film was sandwiched from the both sides thereof by using two glass plates having a thickness of 1 mm (micro slide glass Product No. S9111, manufactured by Matsunami Glass Ind., Ltd.); the two glass plates and the resulting optical film were brought into completely intimate contact with each other; a haze was measured in a state that the surface haze was eliminated; and a value obtained by subtracting a haze as separately measured by putting only silicone oil between two glass plates was calculated as an internal haze (Hi).

[3] A value obtained by subtracting the internal haze (Hi) as calculated in the foregoing [2] from the total haze [H] as measured in the foregoing [1] is calculated as a surface haze (Hs) of the film.

TABLE 3

| | | | | | Firmness of | |
|---|---|---|---|---|---|---|
| | | | | | black color at | |
| | | Surface haze | Internal haze | Sm | the time of | Pencil |
| Sample name | Coating solution name | (%) | (%) | (μm) | black display | hardness |
| Comparative Sample 1 | HC-1 (no particle) | 0 | 0 | ∞ | Point 11 | 2H |
| Comparative Sample 2 | HC-2 (monodispersed silica) | 4 | 2.8 | 137 | Point 7 | 3H |
| Comparative Sample 3 | HC-2-(1) (monodispersed | 8 | 4.5 | 83 | Point 5 | 3H |
| | silica) | | | | | |
| Example Sample 4 | HC-3-(1) (coagulating silica) | 1 | 0 | 190 | Point 11 | 2H |
| Example Sample 5 | HC-3 (coagulating silica) | 4 | 1 | 120 | Point 10 | 3H |
| Example Sample 6 | HC-3-(2) (coagulating silica) | 5 | 1 | 103 | Point 10 | 3H |
| Example Sample 7 | HC-3-(3) (coagulating silica) | 6 | 1 | 88 | Point 9 | 3H |
| Example Sample 8 | HC-3-(4) (coagulating silica) | 8 | 1 | 70 | Point 9 | 3H |
| Example Sample 9 | HC-3-(5) (coagulating silica) | 9 | 1 | 62 | Point 8 | 3H |
| Example Sample 10 | HC-3-(6) (coagulating silica) | 12 | 1 | 53 | Point 8 | 3H |
| Comparative Sample | HC-3-(7) (coagulating silica) | 16 | 2 | 40 | Point 7 | 3H |
| 11 | | | | | | |
| Comparative Sample | HC-3-(8) (coagulating silica) | 20 | 2 | 33 | Point 5 | 3H |
| 12 | | | | | | |
| Example Sample 13 | HC-4-(1) (coagulating | 5 | 1 | 95 | Point 9 | 3H |
| | alumina) | | | | | |
| Example Sample 14 | HC-4-(2) (coagulating | 8 | 1 | 63 | Point 8 | 3H |
| | alumina) | | | | | |

As is clear from Table 3, [1] with respect to the firmness of black color at the time of black display, the surface haze was required to be from 0 to 12%, preferably from 0 to 8%, and more preferably from 0 to 5%. Furthermore, with respect to the firmness of black color, the coagulating alumina and the coagulating silica brought satisfactory results as compared with the monodispersed silica, and in particular, the coagulating silica particle brought the best results. In addition, [2] by using the metal oxide particle (the monodispersed silica, coagulating silica and coagulating alumina in Table 3), the pencil hardness could be enhanced, and such was more preferable as a surface film.

Next, samples as prepared in the same manner as in the preparation of Example Sample 6, except for applying the HC-1 solution in a thickness as shown in Table 4 as a first layer of hard coat layer and further applying the HC-3-(2) solution as a second layer of hard coat layer as it was, were designated as Example Samples 15 to 19. The details are shown in the following Table 4.

TABLE 4

| | First hard | | | | Whole | | | | | |
|---|---|---|---|---|---|---|---|---|---|---|
| | coat layer | | Second hard coat layer | | film | Surface | Internal | | Firmness | |
| Sample | Coating | | Coating | | thickness | haze | haze | Sm | of black | Pencil |
| name | solution | Thickness | solution | Thickness | (μm) | (%) | (%) | (μm) | color | hardness |
| Example | HC-1 | 10 μm | HC-3-(2) | 2.5 μm | 12.5 | 5 | 1 | 103 | Point 10 | 4H |
| Sample | | | | | | | | | | |
| 15 | | | | | | | | | | |
| Example | HC-1 | 15 μm | HC-3-(2) | 2.5 μm | 17.5 | 5 | 1 | 103 | Point 10 | 5H |
| Sample | | | | | | | | | | |
| 16 | | | | | | | | | | |
| Example | HC-1 | 25 μm | HC-3-(2) | 2.5 μm | 27.5 | 5 | 1 | 103 | Point 10 | 6H |
| Sample | | | | | | | | | | |
| 17 | | | | | | | | | | |
| Example | HC-1 | 35 μm | HC-3-(2) | 2.5 μm | 37.5 | 5 | 1 | 103 | Point 10 | 7H |
| Sample | | | | | | | | | | |
| 18 | | | | | | | | | | |
| Example | HC-1 | 40 μm | HC-3-(2) | 2.5 μm | 42.5 | 5 | 1 | 103 | Point 10 | 7H |
| Sample | | | | | | | | | | |
| 19 | | | | | | | | | | |

As is clear from Table 4, in the embodiment of the invention, what the thickness of the hard coat layer is made thick in view of enhancing the pencil hardness and is able to provide an optical film (image display device) which is not only satisfactory in scar resistance but also satisfactory in firmness of black color. In Example Sample 19 in which the whole film thickness exceeds 40 μm, the curl is somewhat large because the film thickness is thick. Taking into consideration handling in the manufacturing line, the film thickness is preferably not more than 40 μm.

Next, samples as prepared in the same as in the preparation of Example Sample 16, except for containing a particle as shown in Table 5 in an amount as shown in Table 5 in Example Sample 16, are designated as Example Samples 20 to 28. Incidentally, in Table 5, the particle (1) is MX-800 (crosslinked polymethyl methacrylate particle) with a particle size of 8 μm, manufactured by Soken Chemical & Engineering Co., Ltd.; the particle (2) is SX-500 (crosslinked polystyrene particle) with a particle size of 5 μm, manufactured by Soken Chemical & Engineering Co., Ltd.; and the particle (3) is SBX-8 (highly crosslinked polystyrene particle) with a particle size of 8 μm, manufactured by Sekisui Plastics Co., Ltd. Each of these particles was measured for compression strength under the foregoing measurement condition. As a result, the particle (1) had a compression strength of 1.5 kgf/mm²; the particle (2) had a compression strength of 2.1 kgf/mm²; and the particle (3) had a compression strength of 5.8 kgf/mm². The details are shown in the following Table 5.

TABLE 5

| | | | | | Second layer of | | |
|---|---|---|---|---|---|---|---|
| | First layer of hard coat layer | | | | hard coat layer | | |
| | Coating | | | Coating amount | Coating | | Pencil |
| Sample name | solution | Thickness | Particle | (mg/m²) | solution | Thickness | hardness |
| Example | HC-1 | 15 μm | (1) | 1.5 | HC-3-(2) | 2.5 μm | 5H |
| Sample 20 | | | | | | | |
| Example | HC-1 | 15 μm | (1) | 3 | HC-3-(2) | 2.5 μm | 5H |
| Sample 21 | | | | | | | |
| Example | HC-1 | 15 μm | (1) | 6 | HC-3-(2) | 2.5 μm | 5H |
| Sample 22 | | | | | | | |
| Example | HC-1 | 15 μm | (2) | 1.6 | HC-3-(2) | 2.5 μm | 5H |
| Sample 23 | | | | | | | |
| Example | HC-1 | 15 μm | (2) | 3 | HC-3-(2) | 2.5 μm | 6H |
| Sample 24 | | | | | | | |
| Example | HC-1 | 15 μm | (2) | 6 | HC-3-(2) | 2.5 μm | 7H |
| Sample 25 | | | | | | | |
| Example | HC-1 | 15 μm | (3) | 1.5 | HC-3-(2) | 2.5 μm | 6H |
| Sample 26 | | | | | | | |
| Example | HC-1 | 15 μm | (3) | 3 | HC-3-(2) | 2.5 μm | 7H |
| Sample 27 | | | | | | | |
| Example | HC-1 | 15 μm | (3) | 6 | HC-3-(2) | 2.5 μm | 8H |
| Sample 28 | | | | | | | |

As is clear from Table 5, when a particle having a compression strength of less than 2 kgf/mm² (the particle (1) in Table 5) is used, it is impossible to design to further improve the pencil hardness; however, when a particle having a compression strength exceeding 2 kgf/mm² (the particle (2) and particle (3) in Table 5) is used, the pencil hardness can be further improved so that such is preferable in view of providing an optical film having a high hardness.

(Surface Roughness)

The measurement of an average value Sm of a gap of the mountain and valley cycle as determined from a point of intersection at which a roughness curve and a center line intersect each other was carried out according to JIS-B0601.

Samples as prepared in the same manner as in the preparation of Example Sample 8, except for preparing a sample having a varied Sm by coating the HC-3-(4) coating solution in a coating thickness as shown in Table 6, are designated as Example Samples 29 to 42. The details are shown in Table 6. Incidentally, a rough feeling of the optical film surface was evaluated in the following manner.

(Evaluation of Rough Feeling)

A polarizing plate prepared from TAC-TD80U made of triacetyl cellulose (manufactured by Fuji Photo Film Co., Ltd., thickness of 80 μm) and a polarizing plate prepared from the optical film of the invention were stuck to each other with cross-Nicols, thereby preparing an examination sample. A rough feeling (roughness and fineness feeling of projections) on a surface in the side of the optical film was subjected to visual evaluation (reflecting examination) in a bright room of 1,000 lux. The details are shown in the following Table 6.

A: The rough feeling is every satisfactory (very smooth).

B: The rough feeling is satisfactory.

BC: The rough feeling is moderate.

C: The rough feeling is slightly poor.

D: The rough feeling is problematic.

TABLE 6

| | Coating | | | | | Firmness of | |
|---|---|---|---|---|---|---|---|
| | solution for | Film | | | | black color at | |
| | hard coat | thickness | Surface haze | Internal haze | Sm | the time of | |
| Sample name | layer | (μm) | (%) | (%) | (μm) | black display | Rough feeling |
| Example Sample 8 | HC-3-(4) | 2.5 | 8 | 1 | 70 | Point 9 | A |
| Example Sample 29 | HC-3-(4) | 5.1 | 5 | 2 | 36 | Point 7 | A |
| Example Sample 30 | HC-3-(4) | 4.4 | 5 | 2 | 44 | Point 7 | A |
| Example Sample 31 | HC-3-(4) | 3.0 | 6 | 1 | 51 | Point 8 | A |
| Example Sample 32 | HC-3-(4) | 2.4 | 8 | 1 | 75 | Point 9 | A |
| Example Sample 33 | HC-3-(4) | 2.3 | 8 | 1 | 81 | Point 9 | A |
| Example Sample 34 | HC-3-(4) | 2.2 | 9 | 1 | 94 | Point 10 | A |
| Example Sample 35 | HC-3-(4) | 2.1 | 10 | 1 | 124 | Point 10 | A |
| Example Sample 36 | HC-3-(4) | 2.0 | 11 | 1 | 130 | Point 10 | A |
| Example Sample 37 | HC-3-(4) | 1.9 | 12 | 1 | 134 | Point 10 | B |
| Example Sample 38 | HC-3-(4) | 1.7 | 14 | 1 | 152 | Point 10 | B |
| Example Sample 39 | HC-3-(4) | 1.6 | 15 | 1 | 160 | Point 10 | B |
| Example Sample 40 | HC-3-(4) | 1.5 | 16 | 1 | 167 | Point 10 | BC |
| Example Sample 41 | HC-3-(4) | 1.3 | 18 | 0 | 202 | Point 10 | C |
| Example Sample 42 | HC-3-(4) | 1.2 | 19 | 0 | 220 | Point 10 | C |

As is clear from Table 6, in order to make the firmness of black color and the rough feeling of the appearance satisfactory, the Sm value is preferably from 50 to 200 μm, more preferably from 70 to 160 μm, and most preferably from 90 to 130 μm.

Next, with respect to Example Samples 5, 6, 13, 16 and 27, optical films as prepared in exactly the same manner, except for changing the formulation of the fluorine based leveling agent FP-7 used in each hard coat layer to four kinds of (1) a formulation from which FP-7 is eliminated, (2) a formulation from which FP-7 is eliminated and in which a fluorine based leveling agent FP-86 is used in the same amount in place of FP-7, (3) a formulation from which FP-7 is eliminated and in which a silicone based leveling agent X-22-945 (manufactured by Shin-Etsu Chemical Co., Ltd.) is used in the same amount in place of FP-7, and (4) a formulation in which the amount of FP-7 is reduced to a half and a silicone based leveling agent X-22-945 is additionally added in an amount corresponding to the half of FP-7, were evaluated with respect to surface properties of appearance. Incidentally, the surface properties of appearance are as follows.

(Evaluation of Surface Properties of Appearance)

A polarizing plate prepared from TAC-TD80U made of triacetyl cellulose (manufactured by Fuji Photo Film Co., Ltd., thickness of 80 μm) and a polarizing plate prepared from the optical film of the invention were stuck to each other with cross-Nicols, thereby preparing an examination sample. Thereafter, a room was turned to a dark room. Surface properties of appearance on a surface in the side of the optical film were subjected to visual evaluation (reflecting examination) by using a stand type three band fluorescent lamp.

The Example Samples 5, 6, 13, 16 and 27 exhibited very satisfactory surface properties, whereas a group of the samples to which the formulation (1) had been applied was inferior in surface properties and was not preferable. On the other hand, a group of the samples to which the formulation (2) or (3) had been applied exhibited satisfactory surface properties the same as in the Example Samples 5, 6, 13, 16 and 27 and was an excellent optical film. Furthermore, a group of the samples to which the formulation (4) using both the fluorine based leveling agent and the silicone based leveling agent had been applied exhibited an improvement in surface properties with a notch and was a very excellent optical film.

Furthermore, with respect to Example Samples 16 and 27 having two hard coat layers, optical films as prepared in exactly the same manner as in the preparation of the Example Samples 16 and 27, except for changing the formulation to (5) a formulation in which the fluorine based leveling agent FP-7 in only the first layer of hard coat layer was eliminated and (6) a formulation in which the fluorine based leveling agent FP-7 in only the second layer of hard coat layer was eliminated, respectively, were evaluated with respect to surface properties of appearance. As a result, the Example Samples 16 and 27 using the leveling agent in both the first layer of hard coat layer and the second layer of hard coat layer exhibited the most satisfactory surface properties of appearance, and it was understood that it is preferred to use a leveling agent in all layers of an optical film.

(Application of Low Refractive Index Layer)

[Preparation of Sol Solution (a)]

In a reactor equipped with a stirrer and a reflux condenser, 119 parts of methyl ethyl ketone, 101 parts of 3-acryloyloxypropyl trimethoxysilane “KBM-5103” (manufactured by Shin-Etsu Chemical Co., Ltd.) and 3 parts of diisopropoxyaluminum ethyl acetoacetate were added and mixed. After adding 30 parts of ion exchanged water, the mixture was allowed to react at 60° C. for 4 hours, followed by cooling to room temperature to obtain a sol solution (a). The sol solution (a) had a weight average molecular weight of 1,600, and among components including oligomer or polymer components, components having a molecular weight of from 1,000 to 20,000 accounted for 100%. Furthermore, the gas chromatographic analysis revealed that the starting acryloyloxypropyl trimethoxysilane did not remain at all. The sol solution (a) was finally adjusted with a methyl ethyl ketone solution so as to have a solids content of 29% by weight.

[Preparation of Coating Solution for Low Refractive Index Layer]

Coating solutions LN-1 to LN-9 for low refractive index layer were prepared according to the following table. The numerals in the table are “part by weight”.

TABLE 7

| | | Coating solution name | | | | | | | | |
|---|---|---|---|---|---|---|---|---|---|---|
| Raw material name | | LN-1 | LN-2 | LN-3 | LN-4 | LN-5 | LN-6 | LN-7 | LN-8 | LN-9 |
| Fluorine-containing | JTA-113 | 53.0 | 53.0 | 53.0 | 53.0 | 52.1 | 55.6 | 56.5 | 55.6 | — |
| binder | P-3 | — | — | — | — | — | — | — | — | 7.51 |
| Binder | Sol solution (a) | — | 2.58 | 2.58 | 2.58 | 2.58 | 1.92 | 1.88 | 1.92 | 0.95 |
| Particle | MEK-SI | — | — | 5.57 | — | — | — | — | — | — |
| | MEK-ST-L | | | | 5.57 | 5.57 | 5.57 | 5.57 | 5.57 | 6.12 |
| Initiator | Solution of Illustrative | — | — | — | — | 2.82 | 2.08 | 1.73 | 2.08 | 0.05 |
| | Compound 21 | | | | | | | | | |
| | MP-triazine | — | — | — | — | — | — | — | — | 0.09 |
| Additive | RMS-033 | — | — | — | — | — | — | — | — | 2.75 |
| | Illustrative Compound | — | — | — | — | — | — | — | 0.07 | — |
| | b-13 | | | | | | | | | |
| Solvent | Methyl ethyl ketone | 44.2 | 41.6 | 36.0 | 36.0 | 34.1 | 32.0 | 31.5 | 32.0 | 75.1 |
| | Cyclohexanone | 2.83 | 2.83 | 2.83 | 2.83 | 2.83 | 2.83 | 2.83 | 2.83 | 7.51 |

| | | | | | | | | | |
|---|---|---|---|---|---|---|---|---|---|
| Total | 100 | 100 | 100 | 100 | 100 | 100 | 100 | 100 | 100 |

Each of the foregoing coating solutions was filtered through a polypropylene-made film having a pore size of 1 μm, thereby completing coating solutions (LN-1 to LN-9) for low refractive index layer.

The compounds which are used in the preparation of each of the foregoing coating solutions are shown below.

“JTA-113” (manufactured by JSR Corporation): Heat crosslinking silicone site-containing fluorine-containing polymer solution, refractive index: 1.44, solids concentration: 6% by weight (by using methyl ethyl ketone as a solvent); among the solids, heat crosslinking silicone site-containing fluorine-containing polymer: 78% by weight, melamine based crosslinking agent: 20% by weight, and p-tolunesulfonic acid salt: 2% by weight

“P-3”: Fluorine-containing copolymer (P-3) as described in JP-A-2004-45462, weight average molecular weight: about 50,000, solids concentration: 23.8% by weight (by using methyl ethyl ketone as a solvent)

“MEK-ST” (manufactured by Nissan Chemical Industries, Ltd.): Silica particle dispersion, average particle size: 15 nm, solids concentration: 30% by weight (by using methyl ethyl ketone as a dispersing solvent)

“MEK-ST-L” (manufactured by Nissan Chemical Industries, Ltd.): Silica particle dispersion, average particle size: 45 nm, solids concentration: 30% by weight (by using methyl ethyl ketone as a dispersing solvent)

“Solution of Illustrative Compound 21”: Solids concentration: 2% by weight (by using methyl ethyl ketone as a solvent)

“MP-triazine” (manufactured by Sanwa Chemical Co., Ltd.): Photopolymerization initiator

“RMS-033” (manufactured by Gelest): Reactive silicone resin, solids concentration: 6% by weight (by diluting with methyl ethyl ketone)

In addition, a hollow silica dispersion as described later is “Hollow particle dispersion”, which is a hollow particle dispersion resulting from subjecting a hollow silica particle (CS-60 (dispersing solvent: isopropyl alcohol, manufactured by Catalysts & Chemicals Ind. Co., Ltd., refractive index: 1.31, average particle size: 60 nm, shell thickness 10 nm)) to surface modification with KBM-5103 (a silane coupling agent, manufactured by Shin-Etsu Chemical Co., Ltd.) (surface modification rate: 30% by weight with respect to the hollow silica) and having a solids concentration of 18.2% by weight.

(Application (1) of low Refractive Index Layer)

After applying each of the hard coat layers of the invention, each of the foregoing coating solutions LN-1 to LN-8 for low refractive index layer was further wet coated in a dry thickness of the low refractive index layer of 95 nm by a bar coater. Subsequently, after drying at 120° C. for 150 seconds, the coating layer was further dried at 100° C. for 8 minutes and irradiated with ultraviolet rays at an irradiation dose of 110 mJ/cm² by using an air-cooled metal halide lamp (manufactured by Eyegraphics Co., Ltd.) of 240 W/cm while purging with nitrogen under an environment having an oxygen concentration of 100 ppm, thereby forming a low refractive index layer, followed by winding up.

(Application (2) of Low Refractive Index Layer)

After applying each of the hard coat layers of the invention, the foregoing coating solution LN-9 for low refractive index layer was further wet coated in a dry thickness of the low refractive index layer of 95 nm by a die coater. Subsequently, after drying at 120° C. for 70 seconds, the coating layer was further irradiated with ultraviolet rays at an irradiation dose of 400 mJ/cm² by using an air-cooled metal halide lamp (manufactured by Eyegraphics Co., Ltd.) of 240 W/cm while purging with nitrogen under an environment having an oxygen concentration of 100 ppm, thereby forming a low refractive index layer, followed by winding up.

Samples were prepared in exactly the same manner as in the preparation of Example Samples 4 to 10 and 13 to 19 and Example Samples 29 to 42, except for applying the foregoing coating solution LN-6 on each of the hard coat layers of Example Samples 4 to 10 and 13 to 19 and Example Samples 29 to 42. These samples were designated as Example Samples 104 to 110 and 113 to 119 and Example Samples 129 to 142, respectively. The results of firmness of black color are shown in the following Tables 8 to 10.

TABLE 8

| | Firmness of black color |
|---|---|
| Sample name | at the time of black display |
| Example Sample 104 | Point 16 |
| Example Sample 105 | Point 15 |
| Example Sample 106 | Point 15 |
| Example Sample 107 | Point 14 |
| Example Sample 108 | Point 14 |
| Example Sample 109 | Point 13 |
| Example Sample 110 | Point 13 |
| Example Sample 113 | Point 14 |
| Example Sample 114 | Point 13 |

TABLE 9

| | Firmness of black color |
|---|---|
| Sample name | at the time of black display |
| Example Sample 115 | Point 15 |
| Example Sample 116 | Point 15 |
| Example Sample 117 | Point 15 |
| Example Sample 118 | Point 15 |
| Example Sample 119 | Point 15 |

TABLE 10

| | Firmness of black color |
|---|---|
| Sample name | at the time of black display |
| Example Sample 129 | Point 12 |
| Example Sample 130 | Point 12 |
| Example Sample 131 | Point 13 |
| Example Sample 132 | Point 14 |
| Example Sample 133 | Point 14 |
| Example Sample 134 | Point 15 |
| Example Sample 135 | Point 15 |
| Example Sample 136 | Point 15 |
| Example Sample 137 | Point 15 |
| Example Sample 138 | Point 15 |
| Example Sample 139 | Point 15 |
| Example Sample 140 | Point 15 |
| Example Sample 141 | Point 15 |
| Example Sample 142 | Point 15 |

As is clear from Tables 8 to 10, by further providing a low refractive index layer on the hard coat layer of the invention, the firmness of black color is further improved, whereby an optical film with a very high display grade and high contrast in a bright room can be provided.

Samples as prepared in exactly the same manner as in the preparation of Example Sample 106, except for (1) changing the amount of the coagulating silica in the hard coat layer (adjusting the surface haze), (2) adding a titanium dioxide fine particle as described below in the hard coat layer, thereby increasing a refractive index of the hard coat layer (adjusting the refractive index of the hard coat layer by the coating amount of titanium dioxide), and (3) substituting the amount of the silica fine particle in the low refractive index layer with the foregoing hollow silica fine particle (adjusting the refractive index of the low refractive index layer), respectively, are designated as Example Samples 201 to 214. Values of each coating amount and an integrated reflectance and a mirror reflectance thereof are shown in the following Table 11.

Incidentally, all of the surface internal haze value, the internal haze value and the Sm value of each of the Example Samples fell with the ranges as set forth in claim 1.

A titanium dioxide fine particle containing cobalt and having been subjected to a surface treatment with aluminum hydroxide and zirconium hydroxide (MPT-129C, manufactured by Ishihara Sangyo Kaisha, Ltd., TiO₂/Co₃O₄/Al₂O₃/ZrO₃=90.5/3.0/4.0/0.5 (weight ratio)) was used as the titanium dioxide fine particle. To 257.1 parts by weight of this titanium dioxide fine particle, 41.1 parts by weight of the following dispersant and 701.8 parts by weight of cyclohexanone were added, and the mixture was dispersed by a Dyno-Mill, thereby preparing a titanium dioxide dispersion having a weight average particle size of 70 nm. This titanium dioxide dispersion was added in the coating solution for hard coat layer of the invention, thereby adjusting the formulation amount. 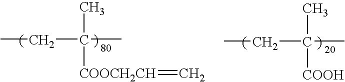
(Reflectance)

With respect to the measurement of mirror reflectance, by using a spectrophotometer “V-550” (manufactured by JASCO Corporation) having an adaptor “ARV-474” installed therein, a mirror reflectance of an outgoing angle of −5° at an incident angle of 5° was measured in a wavelength region of from 380 to 780 nm, and an average mirror reflectance at from 450 to 650 nm was calculated. With respect to the measurement of integrated reflectance, by using a spectrophotometer “V-550” (manufactured by JASCO Corporation) having an adaptor “ARV-471” installed therein, an integrated reflectance at an incident angle of 5° was measured in a wavelength region of from 380 to 780 nm, and an average integrated reflectance at from 450 to 650 nm was calculated.

TABLE 11

| | Coating | Coating | | | | | |
|---|---|---|---|---|---|---|---|
| | amount of | amount of | Degree of | | | | Firmness of |
| | coagulating | titanium | substitution of | Integrated | Mirror | | black color at |
| | silica | dioxide | hollow silica | reflectance | reflectance | (B − A) | the time of |
| Sample name | (g/m²) | (g/m²) | (% by weight) | B (%) | A (%) | (%) | black display |
| Example | 0.8 | 0 | 0 | 2.7 | 2.0 | 0.7 | Point 15 |
| Sample 106 | | | | | | | |
| Example | 0.8 | 0 | 50 | 2.5 | 1.9 | 0.6 | Point 16 |
| Sample 201 | | | | | | | |
| Example | 0.8 | 0 | 100 | 2.3 | 1.8 | 0.5 | Point 17 |
| Sample 202 | | | | | | | |
| Example | 0.4 | 0.5 | 0 | 2.5 | 2.0 | 0.5 | Point 16 |
| Sample 203 | | | | | | | |
| Example | 0.4 | 0.5 | 50 | 2.3 | 1.9 | 0.4 | Point 17 |
| Sample 204 | | | | | | | |
| Example | 0.4 | 0.5 | 100 | 2.1 | 1.8 | 0.3 | Point 18 |
| Sample 205 | | | | | | | |
| Example | 1.5 | 0.5 | 0 | 2.9 | 1.3 | 1.6 | Point 7 |
| Sample 206 | | | | | | | |
| Example | 1.5 | 0.5 | 50 | 2.7 | 1.2 | 1.5 | Point 10 |
| Sample 207 | | | | | | | |
| Example | 1.5 | 0.5 | 100 | 2.5 | 1.1 | 1.4 | Point 11 |
| Sample 208 | | | | | | | |
| Example | 1.2 | 0 | 0 | 2.9 | 1.7 | 1.2 | Point 10 |
| Sample 209 | | | | | | | |
| Example | 1.6 | 0 | 0 | 3.1 | 1.5 | 1.6 | Point 7 |
| Sample 210 | | | | | | | |
| Example | 2.0 | 0 | 0 | 3.2 | 1.3 | 1.9 | Point 5 |
| Sample 211 | | | | | | | |
| Example | 0.3 | 1.2 | 0 | 2.3 | 1.9 | 0.4 | Point 18 |
| Sample 212 | | | | | | | |
| Example | 0.3 | 1.2 | 50 | 2.1 | 1.7 | 0.4 | Point 18 |
| Sample 213 | | | | | | | |
| Example | 0.3 | 1.2 | 100 | 1.8 | 1.5 | 0.4 | Point 19 |
| Sample 214 | | | | | | | |

As is clear from Table 11, in the samples of the invention, when B is not more than 3% and (B−A) is not more than 1.5%, the resulting optical film is satisfactory with respect to the firmness of black color at the time of black display under a bright room environment. In addition, B is more preferably not more than 2.5%, and further preferably not more than 2%. Furthermore, (B−A) is more preferably not more than 1%, and further preferably not more than 0.5%.

Samples as prepared in exactly the same manner as in the preparation of Example Sample 106, except for changing the coating solution LN-6 to the coating solutions LN-1 to LN-5 and LN-7 to LN-9, respectively, followed by application according to the foregoing application method of low refractive index layer, were designated as Example Samples 301 to 305 and Example Samples 307 to 309, respectively. Furthermore, samples as prepared in exactly the same manner as in the preparation of Example Sample 106, except for changing the size of the silica fine particle to be contained in the low refractive index layer in the coating solution LN-6 from 45 nm to 95 nm (100% of the thickness of the low refractive index layer), 145 nm (150% of the thickness of the low refractive index layer) and 160 nm (160% of the thickness of the low refractive index layer), respectively (coating solution names: LN-61, LN-62 and LN-63), were designated as Example Samples 310 to 312, respectively. The details are shown in the following Table 12.

Incidentally, all of the surface internal haze value, the internal haze value and the Sm value of each of the Example Samples fell with the ranges as set forth in claim 1 and were substantially the same as those in Example Sample 106.

(Rubbing Resistance by Steel Wool <Scar Resistance (ii)>)

By carrying out a rubbing test under the following condition by using a rubbing tester, it is possible to evaluate a scar resistance of the optical film.

Evaluation circumstance condition: 25° C., 60% RH

Rubbing material: steel wool (manufactured by Nippon Steel Wool Co., Ltd., Grade No. 0000). The steel wool is wound around a tip part (1 cm×1 cm) of the tester coming into contact with a sample and fixed by a band.

Movement distance (one way): 13 cm

Rubbing rate: 13 cm/sec

Load: 500 g/cm² and 200 g/cm²

Contact area of tip part: 1 cm×1 cm

Number of rubbing: 10 reciprocations

An oily black ink was applied in the rear side of the rubbed sample, and a rubbed portion (a scar thereof) and a non-rubbed portion were visually compared and evaluated (on a maximum of 10 points) by reflected light. A “point 10” means that a scar is not observed at all; and when the point is not more than 2, the test sample is not preferable with respect to the scar resistance.

TABLE 12

| | Coating | Coating solution for | Rubbing |
|---|---|---|---|
| | solution for | low refractive index | resistance |
| Sample name | hard coat layer | layer | by steel wool |
| Example Sample | HC-3-(2) | LN-6 | Point 9 |
| 106 | | | |
| Example Sample | HC-3-(2) | LN-1 | Point 3 |
| 301 | | | |
| Example Sample | HC-3-(2) | LN-2 | Point 4 |
| 302 | | | |
| Example Sample | HC-3-(2) | LN-3 | Point 6 |
| 303 | | | |
| Example Sample | HC-3-(2) | LN-4 | Point 7 |
| 304 | | | |
| Example Sample | HC-3-(2) | LN-5 | Point 8 |
| 305 | | | |
| Example Sample | HC-3-(2) | LN-7 | Point 9 |
| 307 | | | |
| Example Sample | HC-3-(2) | LN-8 | Point 10 |
| 308 | | | |
| Example Sample | HC-3-(2) | LN-9 | Point 10 |
| 309 | | | |
| Example Sample | HC-3-(2) | LN-61 | Point 8 |
| 310 | | | |
| Example Sample | HC-3-(2) | LN-62 | Point 6 |
| 311 | | | |
| Example Sample | HC-3-(2) | LN-63 | Point 4 |
| 312 | | | |

The rubbing resistance by steel wool of Example Sample 312 tends to be slightly lowered. It is thought that this was caused by the matter that since the particle size of the silica fine particle became 160% of the thickness of the low refractive index layer, the silica fine particle was hardly held within the low refractive index layer.

Table 12 reveals the following. In the optical film of the invention, when (1) a fine particle having an average particle size of 15% or more and not more than 150% of the layer thickness of the low refractive index layer is contained in the low refractive index layer; (2) at least translucent resin constituting the low refractive index layer contains a functional group capable of undergoing hardening by ultraviolet rays (UV) and/or thermal hardening; (3) the low refractive index layer is made of at least two translucent resins, at least one translucent resin thereof contains a functional group capable of undergoing hardening by ultraviolet rays (UV), and at least one translucent resin which is different from the former contains a functional group capable of undergoing thermal hardening; (4) the low refractive index layer contains at least one polymerization initiator and at least one crosslinking agent capable of undergoing thermal hardening; or (5) the low refractive index layer further contains a hardening catalyst capable of promoting thermal hardening, it is possible to provide an optical film having more excellent scar resistance. With respect to the effect of (5), the same effect could be confirmed even by changing the Illustrative Compound (b-13) as shown in Table 1 which is contained in the coating solution LN-8 to Illustrative Compound (b-19) as shown in Table 1.

Furthermore, a value (X) obtained by dividing a total sum of a weight of the at least one translucent resin containing a functional capable being hardened by ultraviolet rays (UV) and a weight of the at least one polymerization initiator by a total sum of a weight of the at least one translucent resin capable of undergoing thermal hardening and a weight of the at least one crosslinking agent capable of undergoing thermal hardening is 0.26 for LN-5 (Example Sample 305) and 0.18 for LN-6 (Example Sample 106), respectively. Samples (Example Samples 401 to 410) were prepared in exactly the same manner as in the preparation of Example Sample 106, except for varying the value (X) within the range of from 0 to 0.3 according to the foregoing adjustment method to prepare each coating solution for low refractive index layer, and evaluated. As a result, the results as shown in the following Table 13 were obtained. It was understood that the value (X) in the optical film of the invention is preferably from 0.05 to 0.30, more preferably from 0.10 to 0.19, and further preferably from 0.12 to 0.16.

TABLE 13

| | Sol (a) (g) (UV | Initiator (g) (UV | JTA-113 (g) | | |
|---|---|---|---|---|---|
| | hardening) | hardening) | (thermal hardening) | | Rubbing resistance |
| Sample name | Concentration: 29% | Concentration: 2% | Concentration: 6% | (X) | by steel wool |
| Example Sample | 0.24 | 0.26 | 63.0 | 0.02 | Point 3 |
| 401 | | | | | |
| Example Sample | 0.48 | 0.52 | 32.0 | 0.04 | Point 5 |
| 402 | | | | | |
| Example Sample | 0.70 | 0.77 | 61.0 | 0.06 | Point 7 |
| 403 | | | | | |
| Example Sample | 0.92 | 1.01 | 60.0 | 0.08 | Point 8 |
| 404 | | | | | |
| Example Sample | 1.14 | 1.24 | 59.0 | 0.10 | Point 8.5 |
| 405 | | | | | |
| Example Sample | 1.34 | 1.46 | 58.0 | 0.12 | Point 9 |
| 406 | | | | | |
| Example Sample | 1.54 | 1.68 | 57.0 | 0.14 | Point 9 |
| 407 | | | | | |
| Example Sample | 1.72 | 1.88 | 56.0 | 0.16 | Point 9 |
| 408 | | | | | |
| Example Sample | 1.92 | 2.08 | 55.6 | 0.18 | Point 8.5 |
| 106 | | | | | |
| Example Sample | 2.18 | 2.38 | 54.0 | 0.21 | Point 7.5 |
| 409 | | | | | |
| Example Sample | 2.58 | 2.82 | 52.1 | 0.26 | Point 7.5 |
| 305 | | | | | |
| Example Sample | 2.89 | 3.15 | 50.0 | 0.30 | Point 7.5 |
| 410 | | | | | |

Samples as prepared in exactly the same manner as in Example Sample 309, except for adjusting the amount of RMS-033 in the coating solution LN-9 for low refractive index layer within the range of from 0 to 125%, are designated as Example Samples 501 to 508. The details are shown in the following Table 14.

Incidentally, all of the surface internal haze value, the internal haze value and the Sm value of each of the Example Samples fell with the ranges as set forth in claim 1.

(Evaluation of Antifouling Properties)

As an index on whether the antifouling properties are good or bad, the resulting optical film was evaluated with respect to removal properties of (1) stains by a marker pen and (2) fingerprint stains ((1) removal properties of stains by a marking pen: a figure is drawn on the optical film by using a black marker pen “McKee-Care Ultra-fine” (manufactured by Zebra Co., Ltd.), allowed to stand for a whole day and then wiped off by a tissue paper, thereby evaluating the removal properties; and (2) removal properties of fingerprint stains: a finger is pressed on the optical film to attach a fingerprint thereto, allowed to stand for a whole day and then wiped off by a tissue paper, thereby evaluating the removal properties). The evaluation was made on a maximum of 6 points. A “point 6” was defined as a maximum level for easily wiping off the stains by a marking pen or the fingerprint prints by only lightly wiping.

Furthermore, pure water was dropped on a surface of each of the optical films, and its contact angle was measured, thereby examining correspondence to the antifouling properties.

TABLE 14

| | Relative | Contact | | |
|---|---|---|---|---|
| | amount of | angle | | |
| | RMS-033 | (against pure | Antifouling properties | |
| Sample name | (%) | water) | Marker pen | Fingerprint |
| Example Sample | 100 | 105° | Point 6 | Point 6 |
| 106 | (Standard) | | | |
| Example Sample | 125 | 108° | Point 6 | Point 6 |
| 309 | | | | |
| Example Sample | 95 | 104° | Point 5.5 | Point 5.5 |
| 501 | | | | |
| Example Sample | 80 | 100° | Point 5.5 | Point 5.5 |
| 502 | | | | |
| Example Sample | 78 | 98° | Point 5 | Point 5 |
| 503 | | | | |
| Example Sample | 75 | 95° | Point 5 | Point 5 |
| 504 | | | | |
| Example Sample | 60 | 93° | Point 4.5 | Point 4.5 |
| 505 | | | | |
| Example Sample | 50 | 90° | Point 4.5 | Point 4.5 |
| 506 | | | | |
| Example Sample | 40 | 85° | Point 3 | Point 3 |
| 507 | | | | |
| Example Sample | 30 | 83° | Point 3 | Point 3 |
| 508 | | | | |

As is clear from Table 14, what the contact angle of the optical film of the invention against pure water is 90° or more is preferable in view of antifouling properties. The contact angle was more preferably 95° or more, further preferably 100° or more, and most preferably 95° or more. By adjusting the contact angle of the optical film of the invention within a desired range, it is possible to provide an optical film having very satisfactory antifouling properties.

Next, samples as prepared in exactly the same manner as in the preparation of Example Sample 305, except for further adding KF-96 (10 cs) (silicone oil, manufactured by Shin-Etsu Chemical Co., Ltd.) in the coating solution LN-5 for low refractive index layer, are designated as Example Samples 601 to 606. Furthermore, samples as prepared in exactly the same manner as in the preparation of Example Sample 106, except for further adding KF-96 (10 cs) (silicone oil, manufactured by Shin-Etsu Chemical Co., Ltd.) in the coating solution LN-6 for low refractive index layer, are designated as Example Samples 607 to 608. The addition amount of KF-96 is expressed by % by weight based on the whole of solids of the low refractive index layer and is shown in Table 5. Furthermore, the foregoing Example Sample 309 and the foregoing Example Samples 502, 504, 506, 507 and 508 were prepared. These optical films were evaluated with respect to rubbing resistance by steel wool. The details are shown in the following Table 15.

Incidentally, all of the surface internal haze value, the internal haze value and the Sm value of each of the Example Samples fell with the ranges as set forth in claim 1.

(Measurement of Dynamic Friction Coefficient)

The optical film of the invention is previously allowed to stand under an environment at 25° C. and 60% RH for 2 hours or more. Thereafter, a value measured by using a 5 mmφ stainless steel ball under a load of 100 g at a rate of 60 cm/min by a dynamic friction analyzer, HEIDON-14 was used.

TABLE 15

| | Addition amount | | Rubbing |
|---|---|---|---|
| | of KF-96 | Dynamic friction | resistance |
| Sample name | (%) | coefficient | by steel wool |
| Example Sample | 0 | 0.24 | Point 8 |
| 305 | | | |
| Example Sample | 0.4 | 0.21 | Point 8 |
| 601 | | | |
| Example Sample | 0.8 | 0.20 | Point 9 |
| 602 | | | |
| Example Sample | 1.0 | 0.15 | Point 9 |
| 603 | | | |
| Example Sample | 1.3 | 0.12 | Point 9 |
| 604 | | | |
| Example Sample | 1.7 | 0.10 | Point 10 |
| 605 | | | |
| Example Sample | 2.0 | 0.08 | Point 10 |
| 606 | | | |
| Example Sample | 0 | 0.23 | Point 9 |
| 106 | | | |
| Example Sample | 0.8 | 0.19 | Point 10 |
| 607 | | | |
| Example Sample | 1.0 | 0.15 | Point 10 |
| 608 | | | |
| Example Sample | 0 | 0.22 | Point 10 |
| 309 | | | |
| Example Sample | 0 | 0.24 | Point 10 |
| 502 | | | |
| Example Sample | 0 | 0.27 | Point 10 |
| 504 | | | |
| Example Sample | 0 | 0.30 | Point 10 |
| 506 | | | |
| Example Sample | 0 | 0.36 | Point 7 |
| 507 | | | |
| Example Sample | 0 | 0.39 | Point 7 |
| 508 | | | |

As is clear from Table 15, the dynamic friction coefficient of the optical film of the invention is preferably not more than 0.3, more preferably not more than 0.2, and most preferably not more than 0.1. By adjusting the dynamic friction coefficient of the optical film of the invention, it is possible to provide an optical film having very satisfactory scar resistance.

Next, the optical film of the invention was evaluated with respect to dustproof properties. The evaluation of dustproof properties is as follows.

(Evaluation of Dustproof Properties)

After subjecting the optical film of the invention to humidity control at 25° C. and 60% RH for 2 hours, the optical film was subjected to destaticization (zero cancellation) by a destaticization unit under an environment as it was. Thereafter, the optical film was strongly rubbed 20 times in a certain force by a dry tissue paper, and subsequently, separately prepared tissue paper dusts were sprayed on the optical film. Thereafter, the optical film face was made to stand up vertically on a desk, and the end face of the optical film was stricken three times on the desk, thereby evaluating a dropping behavior (dustproof properties) of the tissue paper dusts. The evaluation was made on a maximum of 10 points. A “point 10” was defined as a maximum level at which the tissue paper dusts did not attach at all.

(Preparation of Coating Solution for Antistatic Layer)

A commercially available transparent antistatic coating material “PELTRON C-4456S-7” (solids concentration: 45%, manufactured by Nippon Pelnox Corporation) was used as a coating solution for antistatic layer of the invention (however, it should not be construed that the antistatic layer of the invention is limited thereto). “C-4456S-7” is a coating material for transparent antistatic layer containing a conductive fine particle ATO as dispersed by using a dispersant. A coating film made of this coating material had a refractive index of 1.55.

(Application of Antistatic Layer)

The foregoing transparent antistatic layer was applied between a hard coat layer and a low refractive index layer of the optical film of the invention as described later. The application method was carried out by coating the foregoing coating solution for antistatic layer by a microgravure coating system, drying at 30° C. for 15 seconds and 90° C. for 20 seconds, hardening the coating layer upon irradiation with ultraviolet rays at an irradiation dose of 50 mJ/cm² by using an air-cooled metal halide lamp (manufactured by Eyegraphics Co., Ltd.) of 160 W/cm under purging with nitrogen and then adjusting the thickness of the coating layer as shown in Table 16, thereby providing a transparent antistatic layer.

(Measurement of Surface Resistivity Value)

A surface resistivity of the side of the coating layer of the optical film of the invention was measured by using a megger/micro ammeter “TR8601” (manufactured by Advantest Corporation). A measurement sample is previously allowed to stand under an environment at 25° C. and 60% RH for 2 hours or more. The value is expressed by an order of “Ω/□”.

(Measurement of Quantity of Electric Charges Due to Vertical Detachment)

Likewise the foregoing measurement of the surface resistivity value, a measurement sample is previously allowed to stand under an environment at 25° C. and 60% RH for 2 hours or more. A measurement unit is composed of a table for placing the measurement sample thereon and a head capable of holding a counterpart film and repeating contact bonding of the measurement sample from the upper side and detachment, and polyethylene terephthalate is installed in this head. After destaticizing the measurement portion, contact bonding of the measurement sample to the head and detachment are repeated. A value of the quantity of electric charges at the time of the first detachment and a value of the quantity of electric charges at the time of the fifth detachment are read and averaged. The sample is changed, and the same operations are repeated with respect to three samples. A value as averaged with respect to all the sample is defined as the quantity of electric charges due to vertical detachment.

Samples as prepared in exactly the same manner as in the preparation of Example Sample 106, except for applying the foregoing antistatic layer between the hard coat layer and the low refractive index layer of Example Sample 106, were designated as Example Samples 701 to 705; and the surface resistivity value was changed. Furthermore, the foregoing Example Samples 309 and the foregoing Example Samples 501, 502, 504, 505, 506, 507 and 508 were prepared and evaluated with respect to surface resistivity value, quantity of electric charges due to vertical detachment and dustproof properties of the optical film. The details are shown in the following Table 16.

Incidentally, all of the surface internal haze value, the internal haze value and the Sm value of each of the Example Samples fell with the ranges as set forth in claim 1.

TABLE 16

| | | | Quantity of | |
|---|---|---|---|---|
| | | Surface | electric charges | |
| | Thickness of | resistivity | due to vertical | |
| | antistatic layer | value | detachment | Dustproof |
| Sample name | (μm) | (Ω/□) | (pc/cm²) | properties |
| Example | — | 10¹⁵ | −30 | Point 7.5 |
| Sample 106 | | | | |
| Example | — | 10¹⁵ | −40 | Point 7.5 |
| Sample 309 | | | | |
| Example | — | 10¹⁵ | −70 | Point 7 |
| Sample 501 | | | | |
| Example | — | 10¹⁵ | −95 | Point 7 |
| Sample 502 | | | | |
| Example | — | 10¹⁵ | −130 | Point 6 |
| Sample 504 | | | | |
| Example | — | 10¹⁵ | −180 | Point 6 |
| Sample 505 | | | | |
| Example | — | 10¹⁵ | −200 | Point 6 |
| Sample 506 | | | | |
| Example | — | 10¹⁵ | −500 | Point 5 |
| Sample 507 | | | | |
| Example | — | 10¹⁵ | −890 | Point 3 |
| Sample 508 | | | | |
| Example | 0.4 | 10¹² | −30 | Point 7.5 |
| Sample 701 | | | | |
| Example | 0.6 | 10¹¹ | −30 | Point 7.5 |
| Sample 702 | | | | |
| Example | 0.8 | 10¹⁰ | −30 | Point 9 |
| Sample 703 | | | | |
| Example | 1.0 | 10⁹ | −30 | Point 9.5 |
| Sample 704 | | | | |
| Example | 1.2 | 10⁸ | −30 | Point 10 |
| Sample 705 | | | | |

As is clear from Table 16, in order to obtain an optical film having excellent dustproof properties, in the optical film of the invention, an absolute value of the quantity of electric charges due to vertical detachment at 25° C. and 60% RH is preferably not more than 500 pc (picocoulomb)/cm², more preferably not more than 200 pc (picocoulomb)/cm², and further preferably not more than 100 pc (picocoulomb)/cm². In order to much more strengthen the dustproof properties, the surface resistivity value of the optical film of the invention is preferably less than 1×10¹¹ Ω/□, more preferably less than 1×10¹⁰ Ω/□, and further preferably less than 1×10⁹ Ω/□.

Next, samples as prepared in exactly the same manner as in the preparation of Example Sample 106, except for changing the solvent composition of the low refractive index layer of Example Sample 106 to one as shown in the following Table 17, are designated as Example Samples 801 to 831.

Incidentally, all of the surface internal haze value, the internal haze value and the Sm value of each of the Example Samples fell with the ranges as set forth in claim 1.

(Evaluation of Drying Unevenness of Low Refractive Index Layer)

A polarizing plate prepared from TAC-TD80U made of triacetyl cellulose (manufactured by Fuji Photo Film Co., Ltd., thickness of 80 μm) and a polarizing plate prepared from the optical film of the invention were stuck to each other with cross-Nicols, thereby preparing an examination sample. Thereafter, a room was turned to a dark room. Surface properties of appearance on a surface in the side of the optical film were subjected to visual evaluation (reflecting examination) by using a stand type three band fluorescent lamp. The evaluation was made on a maximum of 15 points. A “point 15” was defined as a maximum level at which drying unevenness was not observed at all.

TABLE 17

| | Solvent composition of coating solution for | | |
|---|---|---|---|
| | low refractive index layer | | Evaluation result of |
| | Solvent having a | Solvent having a | drying unevenness |
| | boiling point of | boiling point | of low refractive |
| Sample name | not higher than 120° C. | exceeding 120° C. | index layer |
| Example Sample | Methyl ethyl ketone | Cyclohexanone (3) | Point 15 |
| 106 | (97) | | |
| Example Sample | Methyl ethyl ketone | Cyclohexanone (10) | Point 15 |
| 801 | (90) | | |
| Example Sample | Methyl ethyl ketone | Cyclohexanone (15) | Point 14 |
| 802 | (85) | | |
| Example Sample | Methyl ethyl ketone | Cyclohexanone (25) | Point 14 |
| 803 | (75) | | |
| Example Sample | Methyl ethyl ketone | Cyclohexanone (30) | Point 14 |
| 804 | (70) | | |
| Example Sample | Methyl ethyl ketone | Cyclohexanone (40) | Point 13 |
| 805 | (60) | | |
| Example Sample | Methyl ethyl ketone | Cyclohexanone (50) | Point 13 |
| 806 | (50) | | |
| Example Sample | Methyl ethyl ketone | Cyclohexanone (60) | Point 10 |
| 807 | (40) | | |
| Example Sample | Methyl isobutyl | Cyclohexanone (3) | Point 14 |
| 808 | ketone (97) | | |
| Example Sample | Methyl isobutyl | Cyclohexanone (10) | Point 14 |
| 809 | ketone (90) | | |
| Example Sample | Methyl isobutyl | Cyclohexanone (15) | Point 13 |
| 810 | ketone (85) | | |
| Example Sample | Methyl isobutyl | Cyclohexanone (25) | Point 13 |
| 811 | ketone (75) | | |
| Example Sample | Methyl isobutyl | Cyclohexanone (30) | Point 13 |
| 812 | ketone (70) | | |
| Example Sample | Methyl isobutyl | Cyclohexanone (40) | Point 12 |
| 812 | ketone (60) | | |
| Example Sample | Methyl isobutyl | Cyclohexanone (50) | Point 12 |
| 814 | ketone (50) | | |
| Example Sample | Methyl isobutyl | Cyclohexanone (60) | Point 9 |
| 815 | ketone (40) | | |
| Example Sample | Toluene (97) | Cyclohexanone (3) | Point 14 |
| 816 | | | |
| Example Sample | Toluene (90) | Cyclohexanone (10) | Point 14 |
| 817 | | | |
| Example Sample | Toluene (85) | Cyclohexanone (15) | Point 13 |
| 818 | | | |
| Example Sample | Toluene (75) | Cyclohexanone (25) | Point 13 |
| 819 | | | |
| Example Sample | Toluene (70) | Cyclohexanone (30) | Point 13 |
| 820 | | | |
| Example Sample | Toluene (60) | Cyclohexanone (40) | Point 12 |
| 821 | | | |
| Example Sample | Toluene (50) | Cyclohexanone (50) | Point 12 |
| 822 | | | |
| Example Sample | Toluene (40) | Cyclohexanone (60) | Point 9 |
| 823 | | | |
| Example Sample | Nil | Butyl methyl ketone | Point 11 |
| 824 | | (97) and | |
| | | Cyclohexanone (3) | |
| Example Sample | Nil | Butyl methyl ketone | Point 11 |
| 825 | | (90) and | |
| | | Cyclohexanone (10) | |
| Example Sample | Nil | Butyl methyl ketone | Point 10 |
| 826 | | (85) and | |
| | | Cyclohexanone (15) | |
| Example Sample | Nil | Butyl methyl ketone | Point 10 |
| 827 | | (75) and | |
| | | Cyclohexanone (25) | |
| Example Sample | Nil | Butyl methyl ketone | Point 10 |
| 828 | | (70) and | |
| | | Cyclohexanone (30) | |
| Example Sample | Nil | Butyl methyl ketone | Point 9 |
| 829 | | (60) and | |
| | | Cyclohexanone (40) | |
| Example Sample | Nil | Butyl methyl ketone | Point 9 |
| 830 | | (50) and | |
| | | Cyclohexanone (50) | |
| Example Sample | Nil | Butyl methyl ketone | Point 6 |
| 831 | | (40) and | |
| | | Cyclohexanone (60) | |

The numerals in the parentheses in the table express a composition ratio (% by weight).

Boiling point: methyl ethyl ketone (80° C.), methyl isobutyl ketone (113° C.), toluene (111° C.), butyl methyl ketone (127° C.), cyclohexanone (156° C.)

As is clear from Table 17, in the optical film of the invention, with respect to the solvents to be contained in the coating solution for low refractive index layer, when a solvent having a boiling point of not higher than 120° C. is contained in an amount of from 50% by weight to 100% by weight of the total weight of the solvent of the coating solution for low refractive index layer, it is possible to improve the drying unevenness (surface properties) of the low refractive index layer. The amount of such a solvent is more preferably from 70% by weight to 100% by weight of the total weight, and most preferably from 90% by weight to 100% by weight of the total weight. In this way, an optical film having very excellent surface properties of appearance could be provided.

Example Samples 901 and 902 were prepared in the following manner.

Preparation of Support (1):

In the cellulose acylate film (CA1-1) of Example 1 of JP-A-2005-156642, a cellulose acylate solution (A-1) of the same composition was used, and a casting band having a width of 4 m was used, thereby preparing a cellulose acylate film (CA1-1W) having a length of 3,500 m, a width of 2,200 mm and a thickness of 40 μm.

Example Sample 901 was obtained in exactly the same manner as in the preparation of Example Sample 106, except for changing the support to be used to the foregoing CA1-1W. This was prepared in a coating length of 3,400 m and a coating width of 2,150 mm.

Preparation of Support (2):

In the cellulose acylate film (CA2) of Example 2 of JP-A-2005-156642, the plasticizer as used in the cellulose acylate solution (A-2) was changed to the same amount of a mixture of ethylhexyl phthalate (EHP) and tricyclohexyl O-acetylcitrate (OACTCy) (1/1), and a rotary drum casting machine was used, thereby preparing a cellulose acylate film (CA2-2W) having a length of 2,500 m, a width of 2,200 mm and a thickness of 78 μm.

Example Sample 902 was obtained in exactly the same manner as in the preparation of Example Sample 106, except for changing the support to be used to the foregoing CA2-2W. This was prepared in a coating length of 2,400 m and a coating width of 2,150 mm.

All of Example Samples 901 and 902 were excellent in black display in a bright room.

This application is based on Japanese Patent application JP 2005-320992, filed Nov. 4, 2005, and Japanese Patent application JP 2006-12979, filed Jan. 20, 2006, the entire contents of which are hereby incorporated by reference, the same as if set forth at length.

What is claimed is:

1. An optical film comprising: a transparent support; and at least one hard coat layer containing a translucent resin and a coagulating metal oxide particle, and having a surface haze value of from 0 to 12%, an internal haze value of from 0 to 35% and an Sm value of from 50 to 200 μm.

2. The optical film according to claim 1, wherein the coagulating metal oxide particle is a coagulating silica particle.

3. The optical film according to claim 1, wherein at least one of the hard coat layer contains at least one resin particle having a compression strength of from 2.0 to 10.0 kgf/mm and an average size of from 0.5 to 10 μm.

4. The optical film according to claim 1, wherein at least one of the hard coat layer contains at least one of: a fluorine based leveling agent; and a silicone based leveling agent.

5. The optical film according to claim 1, wherein an outermost layer of the optical film in a side at which the hard coat layer is provided is a low refractive index layer having a refractive index lower than that of an adjacent layer to the low refractive index layer.

6. The optical film according to claim 5, wherein when an average value of a 5° regular reflectance and an average value of an integrated reflectance in a wavelength region of from 450 nm and 650 nm are defined as A and B, respectively, B is not more than 3%, and (B−A) is not more than 1.5%.

7. The optical film according to claim 5, wherein the low refractive index layer contains at least one particle having an average particle size of 15% or more and not more than 150% of a thickness of the low refractive index layer.

8. The optical film according to claim 7, wherein at least of the particle contained in the low refractive index layer is a hollow particle.

9. The optical film according to claim 5, wherein the low refractive index layer is formed by coating, and a coating solution for forming the low refractive index layer contains at least one translucent resin containing a functional group capable of undergoing hardening by at least one of: ultraviolet rays; and thermal hardening.

10. The optical film according to claim 5, wherein the low refractive index layer is formed by coating; a coating solution for forming the low refractive index layer contains at least two translucent resins; one of the translucent resins contains a functional group capable of undergoing hardening by ultraviolet rays; and other of the translucent resins contains a functional group capable of undergoing thermal hardening.

11. The optical film according to claim 10, wherein the coating solution for forming the low refractive index layer further contains at least one polymerization initiator and at least one crosslinking agent capable of undergoing thermal hardening.

12. The optical film according to claim 11, wherein the coating solution for forming the refractive index layer further contains at least one hardening catalyst capable of promoting thermal hardening.

13. The optical film according to claim 11, wherein in the coating solution for forming the low refractive index layer, a value obtained by dividing a total sum of a weight of the at least one translucent resin containing a functional capable of undergoing hardening by ultraviolet rays and a weight of the at least one polymerization initiator by a total sum of a weight of the at least one translucent resin capable of undergoing thermal hardening and a weight of the at least one crosslinking agent capable of undergoing thermal hardening is from 0.05 to 0.19.

14. The optical film according to any one of claim 5, wherein the low refractive index layer contains at least one of: a fluorine based leveling agent; and a silicone based leveling agent.

15. The optical film according to claim 5, wherein among solvents contained in the coating solution for forming the low refractive index layer, a solvent having a boiling point of not higher than 120° C. accounts for from 50% by weight to 100% by weight of the total weight of the solvents in the coating solution.

16. The optical film according to claim 1, wherein all of the layers contain a metal oxide particle.

17. The optical film according to claim 1, wherein a contact angle of a surface of the optical film with respect to pure water as measured under an environment at 25° C. and 60% RH is 90° or more.

18. The optical film according to claim 1, wherein a dynamic friction coefficient of a surface of the optical film as measured under an environment at 25° C. and 60% RH is not more than 0.3.

19. The optical film according to claim 1, wherein a quantity of electric charges due to vertical detachment against polyethylene terephthalate as measured under an environment at 25° C. and 60% RH is from −500 pc/cm to +500 pc/cm².

20. The optical film according to claim 1, wherein a surface resistivity value as measured under an environment at 25° C. and 60% RH is less than 1×10¹¹ Ω/□.

21. A polarizing plate comprising two protective films and a polarizer provided between the protective films, wherein one of the protective films is the optical film according to claim 1.

22. An image display device comprising the optical film according to claim 1.

23. The image display device according to claim 22, wherein the image display device is a TFT liquid crystal display device of an in-plane-switching system.

24. An image display device comprising the polarizing plate according to claim 21.

25. The image display device according to claim 24, wherein the image display device is a TFT liquid crystal display device of an in-plane-switching system.
